(19) United States
(12) Patent Application Publication
(10) Pub. No.: US 2006/0232726 A1
(43) Pub. Date: Oct. 19, 2006

(54) Cellulose acylate film, optical compensation film, method of producing cellulose acylate film, polarizing plate and liquid crystal display

(75) Inventors: Tadashi Omatsu, Minami-Ashigara-shi (JP); Takeshi Senga, Minami-Ashigara-shi (JP); Yutaka Nozoe, Minami-Ashigara-shi (JP); Nobutaka Fukagawa, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/402,792

(22) Filed: Apr. 13, 2006

(30) Foreign Application Priority Data
Apr. 13, 2005 (JP) 2005-115984

(51) Int. Cl. G02F 1/1335; C09K 19/00

(52) U.S. Cl. 349/96; 428/1.31

(57) ABSTRACT

A cellulose acylate film, which has small environment dependency, particularly humidity dependency, of optical performance and simultaneously has excellent polarizing plate processability, is provided. The cellulose acylate film has a an equilibrium water content and a humidity dependency of a retardation Rth in a thickness direction of the cellulose acylate film, in which a relationship between the equilibrium water content and the humidity dependency satisfies a condition specified in the specification.

### FIELD OF THE INVENTION

The present invention relates to a cellulose acylate film, which is useful for liquid crystal displays, an optical compensation film using the cellulose acylate film, methods of producing these films, optical materials such as a polarizing plate and the like, and a liquid crystal display.

### BACKGROUNG OF THE INVENTION

Because of the toughness and flame retardancy, cellulose acylate films have been traditionally used for photographic supports and various optical materials. Particularly, in recent years, cellulose acylate films are frequently used as optical transparent films for liquid crystal displays. Cellulose acylate films exhibit high optical transparency and high optical isotropy and thus, are excellent as the optical materials for devices dealing with polarization, such as liquid crystal displays. Therefore, cellulose acylate films have been used heretofore as polarizer-protective films, or as supports for optical compensation films whereby display viewed from a tilted direction can be compensated (viewing angle compensation).

A polarizing plate, which is one of the elements constituting a liquid crystal display, is constructed by bonding a protective film for polarizing film to at least one side of a polarizing film. The polarizing film in general can be obtained by staining a stretched polyvinyl alcohol (PVA) film with iodine or a dichromatic dye. Such a protective film for polarizing film should be excellent in optical isotropy, and the characteristics of a polarizing plate greatly depend on the optical characteristics of the protective film for polarizing film. Therefore, in many cases, cellulose acylate films, in particular, triacetylcellulose films, which can be directly bonded to PVA are used as the protective film for polarizing film.

Due to recent spread of liquid crystal displays, the use environment of liquid crystal displays is diversified, and thus a demand on liquid crystal displays having less environment dependency of the display quality such as viewing angle characteristics and also on liquid crystal displays having good durability, are ever increasing. As a result, with respect to optically transparent films which are used for the protective films of the polarizing plate or the support of the optical compensation film, films which have less environment dependency for optical performance and are capable of maintaining the performance of the polarizing plate with good durability when used as the protective film for polarizing plate, are demanded. In particular, triacetylcellulose films which have been frequently used as the protective film for polarizing plate now have sufficiently small humidity dependency for the optical performance, and thus it is demanded to further decrease the humidity dependency.

For the means to decrease the humidity dependency for optical performance of these cellulose acylate films, a technique of lowering the water content of a film to consequently decrease the humidity dependency for the optical performance can be envisaged. However, on the other hand, when the water content is lowered through hydrophobization of the additives used, there is a risk that the decreased bondability of the cellulose acylate film to PVA, which is the main component of polarizer, causes lowering of the polarizing plate processability. Also, there have been some cases where as an additive having high hydrophobicity is used to lower the water content, the film retardation increases so that the optical performance exceeds the desired scope; or where insufficient compatibility with cellulose acylate causes bleeding or clouding of the film. Thus, solutions sufficient to improve such cases could not be obtained.

Meanwhile, with respect to recent liquid crystal displays, there is a strong demand for improvements in viewing angle characteristics. Thus, optical transparent films such as protective films for polarizing film or supports of optical compensation films are required to be more optically isotropic. Optical isotropy is meant by that the retardation value of an optical film, which is represented by the product of the birefringence and thickness of the film, is small. Especially, in order to improve the visibility of displayed image from a tilted direction, it is necessary to reduce the in-plane retardation (Re) as well as the retardation in the thickness direction (Rth).

To the present, there have been suggested cellulose esters having excellent optical isotropy, for example, as described in JP-2002-249599 and JP-2001-247717, as cellulose acylate films having reduced Re and Rth. However, these suggested films still have problems that the humidity dependency for optical performance is still large, and that the insufficient interaction between the additives used and cellulose acylate is related to the humidity dependency.

### SUMMARY OF THE INVENTION

An object of an illustrative, non-limiting embodiment of the present invention is to provide a cellulose acylate film having small environment dependency for optical performance, particularly humidity dependency, and also having excellent polarizing plate processability by maintaining the equilibrium water content of the film to a certain level. Also, an object of an illustrative, non-limiting embodiment of the present invention is to provide a cellulose acylate film further having optical isotropy in addition to the above-described performance.

Another object of an illustrative, non-limiting embodiment of the present invention is to provide an optical compensation film or polarizing plate using the above-described cellulose acylate film, which has excellent viewing angle characteristics as well as excellent durability or environment dependency, and a liquid crystal display using the above-described polarizing plate.

The present inventors have devotedly conducted researches, and as a result, they found that the humidity dependency for optical performance is reduced when the retardation characteristics are controlled to specific scopes by setting the conditions for film production to specific scopes, and that when a compound having an interaction with cellulose acylate within a defined scope is used as additives, the humidity dependency for optical performance can be reduced without excessively decreasing the equilibrium water content of the film. Furthermore, a cellulose acylate film which constitutes a support of an optical compensation film having good viewing angle characteristics and environment dependency, particularly humidity dependency, can be provided by using a compound which has interaction with cellulose acylate within a defined scope and simultaneously decreases optical anisotropy of the film, thus finding that the above-described problems can be solved.

Thus, the invention is as follows:

(1) A cellulose acylate film having an equilibrium water content and a humidity dependency of a retardation Rth in a thickness direction of the cellulose acylate film, wherein a relationship between the equilibrium water content and the humidity dependency satisfies conditional expression (1):
0≦A≦12
wherein A represents a value indicated by {−(Rth(80%)−Rth(10%))/(equilibrium water content (80%)−equilibrium water content (10%))}; Rth(X %) is a Rth value under an ambience of 25° C. and X % RH, the Rth value being normalized to a Rth value of a cellulose acylate film having a thickness of 80 μm; and the equilibrium water content (X %) is a equilibrium water content under an ambience of 25° C. and X % RH.

(2) The cellulose acylate film according to (1) above, which comprises cellulose acylate having an acyl group, wherein the acyl group is an acetyl group, or the cellulose acylate film according to (1) above, which comprises cellulose acylater having an acyl group comprising an aromatic acyl group.

(3) The cellulose acylate film according to (1) or (2) above, which has retardations satisfying conditional expressions (2) and (3):
0 nm≦Re(λ)≦10 nm Conditional Expression (2)
−25 nm≦Rth(λ)≦25 μm Conditional Expression (3)
wherein Re(λ) represents an in-plane retardation Re at wavelength λ nm; Rth(λ) represents a retardation Rth in a thickness direction of the cellulose acylate film at wavelength λ nm; and λ is a wavelength of 400 nm to 700 nm.

(4) A method of producing a cellulose acylate film, comprising:

casting a cellulose acylate solution on a support at a temperature of −10° C. to 39° C., the cellulose acylate solution comprising: a compound satisfying conditional expression (4); and cellulose acylate;

drying the cellulose acylate solution on the support by blowing dry air at a temperature of 55° C. to 180° C. to provide a flow cast film;

peeling off the flow cast film from the support; and

drying the flow cast film to produce a cellulose acylate film:
0≦R≦0.9 Conditional Expression (4)
wherein R represents an index for a degree of influence of the cellulose acylate on a self-diffusion coefficient of the compound satisfying conditional expression (4) in the cellulose acylate solution, and R is expressed as RD (subject compound)/RD (comparison compound), wherein RD is Db/Da; Da represents a ratio of a self-diffusion coefficient of one of the subject compound and the comparison compound as a single solute when only the single solute is dissolved in a solution; Db represents a self-diffusion coefficient of the single solute when cellulose acylate is co-present in the solution; the subject compound is the compound satisfying conditional expression (4); and the comparison compound is adamantine.

(5) The method of producing a cellulose acylate film according to (4) above, wherein the compound satisfying formula (4) is represented by one of formulae (1) to (6a): 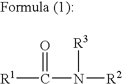
wherein R¹ is an aryl group; R² and R³ each independently are an alkyl group or an aryl group, each of which may be substituted; and at least one of R² and R³ is an aryl group, 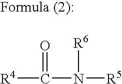
wherein R⁴, R⁵ and R⁶ each independently are an alkyl group, which may be substituted, 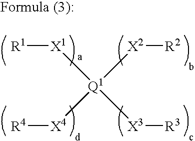
wherein R¹, R², R³ and R⁴ each independently are a hydrogen atom, a substituted or unsubstituted aliphatic group, or a substituted or unsubstituted aromatic group; X¹, X², X³ and X⁴ each independently are a divalent linking group comprising at least one group selected from the group consisting of a single bond, —CO— and —NR⁵—, wherein R⁵ is a substituted or unsubstituted aliphatic group, or a substituted or unsubstituted aromatic group; a, b, c and d each independently are an integer of 0 or greater; a+b+c+d is 2 or greater; and Q¹ is an organic group having a valency of (a+b+c+d), 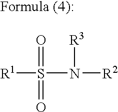
wherein R¹ is an alkyl group or an aryl group; R² and R³ each independently are a hydrogen atom, an alkyl group or an aryl group; and the total sum of carbon numbers of R¹, R² and R³ is 10 or greater, 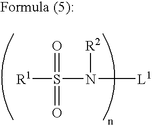
wherein R¹ is a substituted or unsubstituted aliphatic group, or a substituted or unsubstituted aromatic group; R² is a hydrogen atom, a substituted or unsubstituted aliphatic group, or a substituted or unsubstituted aromatic group; L¹ is a divalent to hexavalent linking group; and n is an integer of 2 to 6 in accordance with the valency of L¹, and 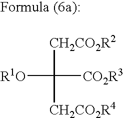
wherein R¹ is a hydrogen atom, an aliphatic acyl group or an aromatic acyl group; and R², R³ and R⁴ each independently are a hydrogen atom, an aliphatic group or an aromatic group.

(6) The method of producing a cellulose acylate film according to (4) or (5) above, further comprising heating the cellulose acylate solution at a heating temperature satisfying conditional expression (5) during preparing of the cellulose acylate solution or during the time after the preparing and before the casting:
BP(° C.)+5 (° C.)≦heating temperature (° C.)≦BP(° C.)+70 (° C.) Conditional Expression (5)
wherein BP (° C.) is a boiling point of a solvent having the lowest boiling point among solvents in the cellulose acylate solution.

(7) The cellulose acylate film according to any one of (1) to (3) above, which is produced by a method according to any one of (4) to (6) above.

(8) An optical compensation film comprising:
a cellulose acylate film according to any one of (1) to (3) and (7) above; and
an optically anisotropic layer having retardations satisfying conditional expressions (6) and (7):
   0≦Re₍₆₃₀₎≦200 nm Conditional Expression (6)
   0≦|Rth₍₆₃₀₎|≦400 nm Conditional Expression (7)
   wherein Re_{(λ)} represents an in-plane retardation at a wavelength of λ nm; and Rth_{(λ)} represent a retardation in a thickness direction of the optically anisotropic layer at a wavelength of λ nm.

(9) The optical compensation film according to (8) above, wherein the optically anisotropic layer comprises a polymer film.

(10) The optical compensation film according to (9) above, which is produced by:
dissolving a polymer in a solvent to obtain a liquid phase;
spreading and drying the liquid phase on a cellulose acylate film according to any one of (1) to (3) and (7) to provide a dried film; and
subjecting the dried film to at least one of stretch treatment and shrinking treatment so as to align molecules of the polymer in plane.

(11) The optical compensation film according to (9) or (10), wherein the polymer film comprises at least one polymer selected from the group consisting of polyamide, polyimide, polyester, polyether ketone, polyarylether ketone, polyamideimide and polyester imide.

(12) A polarizing plate comprising: a polarizer; and a protective film, wherein the protective film is at least one of a cellulose acylate film according to any one of (1) to (3) and (7) above and an optical compensation film according to any one of (8) to (11) above.

(13) A liquid crystal display comprising: at least one of the cellulose acylate film according to any one of (1) to (3) and (7) above, the optical compensation film according to any one of (8) to (11) above and the polarizing plate according to (12) above.

(14) A liquid crystal display of VA mode or IPS mode, comprising at least one of the cellulose acylate film according to any one of (1) to (3) and (7) above, the optical compensation film according to any one of (8) to (11) above and the polarizing plate according to (12) above.

According to an exemplary embodiment of the present invention, it is possible to decrease the humidity dependency of optical performance without excessively reducing the equilibrium water content of the film, and thus a cellulose acylate film satisfying both the polarizing plate processability and the environmental durability can be provided. Furthermore, it is also possible to provide optical elements having excellent optical properties and also environment dependency, such as a protective film for polarizing plate, an optical compensation film, a polarizing plate and the like, and also image display devices such as liquid crystal displays and the like, by using the cellulose acylate film, which has small optical anisotropy, in addition to the above-described performance, and thus is substantially optically isotropic.

### DETAILED DESCRIPTION OF THE INVENTION

Hereinafter, a cellulose acylate film of the present invention will be described in detail. (Material for cellulose acylate film)

For the material forming the cellulose acylate film of the invention, cellulose polymers, which are represented by triacetylcellulose that has been traditionally used as a transparent protective film for polarizing plate (hereinafter, referred to as cellulose acylate) can be favorably used.

(Cellulose Acylate Raw Material Cotton)

Examples of the cellulose as the cellulose acylate raw material used for the invention include cotton linter, wood pulp (hardwood pulp, softwood pulp) and the like, and a cellulose acylate obtained from any raw material cellulose can be used. In some cases, mixtures of such cellulose acylate may be also used. Details of these raw material celluloses are described in, for example, Marusawa and Uda, “Lecture on Plastic Materials (17): Cellulose Resins”, Nikkan Kogyo Shimbunsha, Ltd. (1970), or the Technical Report of Japan Institute of Invention and Innovation 2001-1745, pp. 7-8, but the invention is not limited to the descriptions.

(Degree of Substitution of Cellulose Acylate)

Next, the cellulose acylate of the invention produced using the above-described cellulose as raw material will be described. The cellulose acylate of the invention is a product resulting from the acylation of hydroxyl groups of cellulose, and the substituent that can be used includes all of an acetyl group, which is an acyl group having 2 carbon atoms, to a group having 22 carbon atoms. For the cellulose acylate of the invention, the degree of substitution for the hydroxyl group of cellulose is not particularly limited, but the degree of substitution can be obtained by measuring the degree of bonding of acetic acid and/or a fatty acid having 3 to 22 carbon atoms that substitute the hydroxyl group of cellulose, and calculating the degree of substitution therefrom. The measurement can be carried out according to ASTM D-817-91.

For the cellulose acylate of the invention, the degree of substitution for the hydroxyl group of cellulose is not particularly limited, but the degree of acyl substitution for the hydroxyl group of cellulose is preferably 2.50 to 3.00. The degree of substitution is more preferably 2.75 to 3.00, and even more preferably 2.85 to 3.00.

Among the acetic acid and/or a carboxylic acid having 3 to 22 carbon atoms that substitute the hydroxyl group of cellulose, the acyl group having 2 to 22 carbon atoms is not particularly limited to an aliphatic group or an aromatic group, and may be a single species or a mixture of two or more species. Examples thereof include alkylcarbonyl esters, alkenylcarbonyl esters or aromatic carbonyl esters, aromatic alkylcarbonyl esters of cellulose and the like, each of which may be further substituted. Preferred examples of the aliphatic acyl group include the groups of acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, cinnamoyl and the like. Among these, the groups of acetyl, propionyl, butanoyl, dodecanoyl, octadecanoyl, t-butanoyl, oleoyl, benzoyl, naphthylcarbonyl, cinnamoyl and the like are preferred, and an acetyl group, a propionyl group and a butanoyl group are more preferred. Preferred examples of the aromatic acyl group include a substitutent represented by formula (A) described later.

As a result of intensive studies undertaken by the present inventor, the acyl substituent to be substituted on the hydroxyl group of cellulose is preferably constituted solely of an acetyl group, in consideration of applicability, cost and processability in manufacturing process and because Tg and elastic modulus are not low to provide a satisfactory handling property in the produced film, and a substitution degree is preferably 2.70 to 3.00, more preferably 2.80 to 2.99 and more preferably 2.85 to 2.97 in consideration that the optical anisotropy of the film can and in consideration of a mutual solubility with additives and of a solubility in the organic solvent to be used.

Also for the purpose of further improving the water resistance of the cellulose film, the acyl substituent to be substituted on the hydroxyl group of cellulose is preferably an aromatic acyl group represented by formula (A):

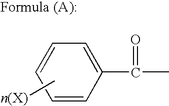

The formula (A) will be explained in the following. In formula (A), X represents a substituent. Examples of the substituent includes a halogen atom, a cyano group, an alkyl group, an alkoxy group, an aryl group, an aryloxy group, an acyl group, a carbonamide group, a sulfonamide group, an ureido group, an aralkyl group, a nitro group, an alkoxycarbonyl group, an aryloxycarbonyl group, an araylkyloxycarbonyl group, a carbamoyl group, a sulfamoyl group, an acyloxy group, an alkenyl group, an alkinyl group, an alkylsulfonyl group, an arylsulfonyl group, an alkyloxysulfonyl group, an aryloxysulfonyl group, an alkylsulfonyloxy group, an arylsulfonyloxy group, —S—R, —NH—CO—OR, —PH—R, —P(—R)₂, —PH—O—R, —P(—R)(—O—R), —P(—O—R)₂, —PH(═O)—R—P(═O)(—R)₂, —PH(═O)—O—R, —P(═O)(—R)(—O—R), —P(═O)(—O—R)₂, —O—PH(═O)—R, —O—P(═O)(—R)₂—O—PH(═O)—O—R, —O—P(═O)(—R)(—O—R), —O—P(═O)(—O—R)₂, —NH—PH(═O)—R, —NH—P(═O)(—R)(—O—R), —NH—P(═O)(—O—R)₂, —SiH₂—R, —SiH(—R)₂, —Si(—R)₃, —O—SiH₂—R, —O—SiH(—R)₂ and —O—Si(—R)₃, in which R represents an aliphatic group, an aromatic group or a heterocyclic group.

In formula (A), n indicates a number of substituents and is an integer of 0 to 5. The number (n) of the substituents is preferably 1 to 5, more preferably 1 to 4, further preferably 1 to 3 and most preferably 1 or 2. The above-mentioned substituent is preferably a halogen atom, a cyano group, an alkyl group, an alkoxy group, an aryl group, an aryloxy group, an acyl group, a carbonamide group, a sulfonamide group or an ureido group, more preferably a halogen atom, a cyano group, an alkyl group, an alkoxy group, an aryloxy group, an acyl group, or a carbonamide group, further preferably a halogen atom, a cyano group, an alkyl group, an alkoxy group, or an aryloxy group, and most preferably a halogen atom, an alkyl group or an alkoxy group.

The halogen atom includes a fluorine atom, a chlorine atom, a bromine atom and an iodine atom. The alkyl group may have a cyclic structure or a branched structure. The alkyl group preferably includes 1 to 20 carbon atoms, more preferably 1 to 12 carbon atoms, further preferably 1 to 6 carbon atoms and most preferably 1 to 4 carbon atoms. Examples of the alkyl group include a methyl group, an ethyl group, a propyl group, an isopropyl group, a butyl group, a tert-butyl group, a hexyl group, a cyclohexyl group, an actyl group and a 2-ethyl-hexyl group. The alkoxy group may have a cyclic structure or a branched structure. The alkoxy group preferably includes 1 to 20 carbon atoms, more preferably 1 to 12 carbon atoms, further preferably 1 to 6 carbon atoms and most preferably 1 to 4 carbon atoms. The alkoxy group may be further substituted with another alkoxy group. Examples of the alkoxy group includes a methoxy group, an ethoxy group, a 2-methoxyethoxy group, a 2-methoxy-2-ethoxyethoxy group, a butyloxy group, a hexyloxy group and an octyloxy group.

Also the aryl group preferably includes 6 to 20 carbon atoms, and more preferably 6 to 12 carbon atoms. Examples of the aryl group include a phenyl group and a naphthyl group. Also the aryloxy group preferably includes 6 to 20 carbon atoms, and more preferably 6 to 12 carbon atoms. Examples of the aryloxy group include a phenoxy group and a naphthoxy group. The acyl group preferably includes 1 to 20 carbon atoms, and more preferably 1 to 12 carbon atoms. Examples of the acyl group include a formyl group, an acetyl group and a benzoyl group. The carbonamide group preferably includes 1 to 20 carbon atoms, and more preferably 1 to 12 carbon atoms. Examples of the carbonamide group include an acetamide group and a benzamide group. The sulfonamide group preferably includes 1 to 20 carbon atoms, and more preferably 1 to 12 carbon atoms. Examples of the sulfonamide group include a methanesulfonamide group, a benzenesulfonamide group and a p-toluenesulfonamide group. The ureido group preferably includes 1 to 20 carbon atoms, and more preferably 1 to 12 carbon atoms. Examples of the ureido group include (non-substituted) ureide.

The aralkyl group preferably includes 7 to 20 carbon atoms, and more preferably 7 to 12 carbon atoms. Examples of the aralkyl group include a benzyl group, a phenetyl group and a naphthyl group. The alkoxycarbonyl group preferably includes 2 to 20 carbon atoms, and more preferably 2 to 12 carbon atoms. Examples of the alkoxycarbonyl group include a methoxycarbonyl group. The aryloxycarbonyl group preferably includes 7 to 20 carbon atoms, and more preferably 7 to 12 carbon atoms. Examples of the aryloxycarbonyl group include a phenoxycarbonyl group. The aralkyloxycarbonyl group preferably includes 8 to 20 carbon atoms, and more preferably 8 to 12 carbon atoms. Examples of the aralkyloxycarbonyl group include a benzyloxycarbonyl group. The carbamoyl group preferably includes 1 to 20 carbon atoms, and more preferably 1 to 12 carbon atoms. Examples of the carbamoyl group include a (non-substituted) carbamoyl group and an N-methylcarbamoyl group. The sulfamoyl group preferably includes 20 or less carbon atoms, and more preferably 12 or less carbon atoms. Examples of the sulfamoyl group include a (non-substituted) sulfamoyl group and an N-methylsulfamoyl group. The acyloxy group preferably includes 1 to 20 carbon atoms, and more preferably 1 to 12 carbon atoms. Examples of the acyloxy group include an acetoxy group and a benzoyloxy group.

The alkenyl group preferably includes 2 to 20 carbon atoms, and more preferably 2 to 12 carbon atoms. Examples of the alkenyl group include a vinyl group, an allyl group and an isopropenyl group. The alkinyl group preferably includes 2 to 20 carbon atoms, and more preferably 2 to 12 carbon atoms. Examples of the alkinyl group include a thienyl group. The alkylsulfonyl group preferably includes 1 to 20 carbon atoms, and more preferably 1 to 12 carbon atoms. The arylsulfonyl group preferably includes 6 to 20 carbon atoms, and more preferably 6 to 12 carbon atoms. The alkyloxysulfonyl group preferably includes 1 to 20 carbon atoms, and more preferably 1 to 12 carbon atoms. The aryloxysulfonyl group preferably includes 6 to 20 carbon atoms, and more preferably 6 to 12 carbon atoms. The alkylsulfonyloxy group preferably includes 1 to 20 carbon atoms, and more preferably 1 to 12 carbon atoms. The arylsulfonyloxy group preferably includes 6 to 20 carbon atoms, and more preferably 6 to 12 carbon atoms.

In formula (A), a number (n) of the substituent on the aromatic ring is 0 or 1-5, preferably 1 to 3, and particularly preferably 1 or 2.

In case the aromatic ring has two or more substituents, such substituents may be mutually same or different, or may be mutually bonded to form a condensed polycyclic compound (such as a naphthalene group, an indene group, an indane group, a phenanthrene group, a quinoline group, an isoquinoline group, a chromene group, a chromane group, a phthalazine group, an acridine group, an indole group or an indoline group). Specific examples of the aromatic acyl group represented by formula (A) are shown in the following, in which preferred are Nos. 1, 3, 5, 6, 8, 13, 18 and 28, and more preferred are Nos. 1, 3, 6 and 13.

The substitution of the hydroxyl group of cellulose with an aromatic acyl group can be generally achieved by a method utilizing a symmetric acid anhydride or an acid anhydride mixture derived from an aromatic carboxylic acid chloride or an aromatic carboxylic acid. A particularly preferable method is a method of utilizing an acid anhydride derived from an aromatic carboxylic acid (Journal of Applied Polymer Science, Vol. 29, 3981-3990 (1984)). In producing cellulose acylate or cellulose mixed acid ester of the present invention, such method can be applied as (i) a method of once preparing a cellulose-fatty acid monoester or diester and then introducing the aromatic acyl group, represented by formula (A), into remaining hydroxyl groups, or (ii) a method of reacting mixed acid anhydrides of an aliphatic carboxylic acid and an aromatic carboxylic acid directly with cellulose. In the method (i), the preparation of cellulose-fatty acid monoester or diester can be executed by a known method, but a subsequent reaction of introducing the aromatic acyl group varies depending on the type of the aromatic acyl group. The reaction temperature is preferably 0 to 100° C. and more preferably 20 to 50° C., and the reaction time is preferably 30 minutes or longer, more preferably 30 to 300 minutes. Also in the method (ii) of employing the mixed acid anhydrides, the reaction conditions vary depending on the type of the mixed acid anhydrides. The reaction temperature is preferably 0 to 100° C., more preferably 20 to 50° C., and the reaction time is preferably 30 to 300 minutes, more preferably 60 to 200 minutes. Each of these reactions may be executed with or without a solvent, but preferably with a solvent. Such solvent can be, for example, dichloromethane, chloroform or dioxane.

The substitution degree of the aromatic acyl group is, in case of a cellulose-fatty acid monoester, preferably 2.0 or less with respect to the remaining hydroxyl groups, and more preferably 0.1 to 2.0. In case of a cellulose-fatty acid diester (cellulose diacetate), it is preferably 1.0 or less with respect to the remaining hydroxyl groups, more preferably 0.1 to 1.0. In the following, specific examples (Nos. 1 to 51) of the aromatic acyl group represented by formula (A), but the present invention is not limited thereto. Among the aromatic acyl groups represented by formula (A), Nos. 1, 3, 5, 6, 8, 13, 18 and 28 are preferred, and Nos. 1, 3, 6 and 13 are more preferred.

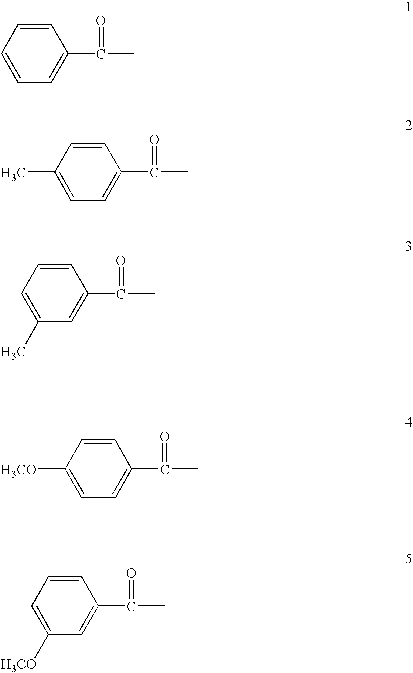

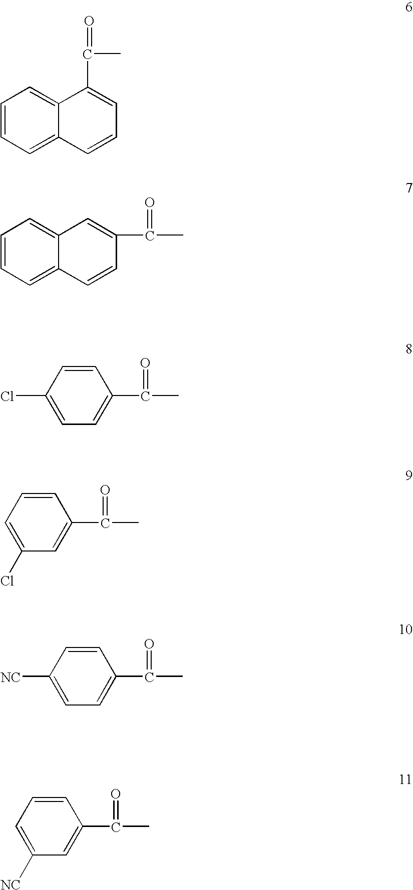

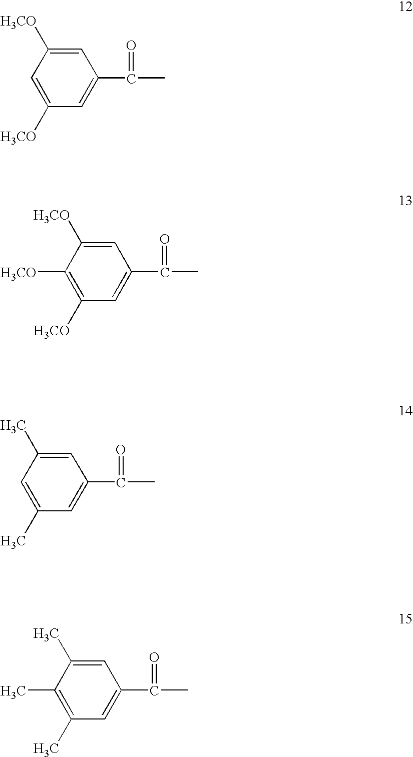

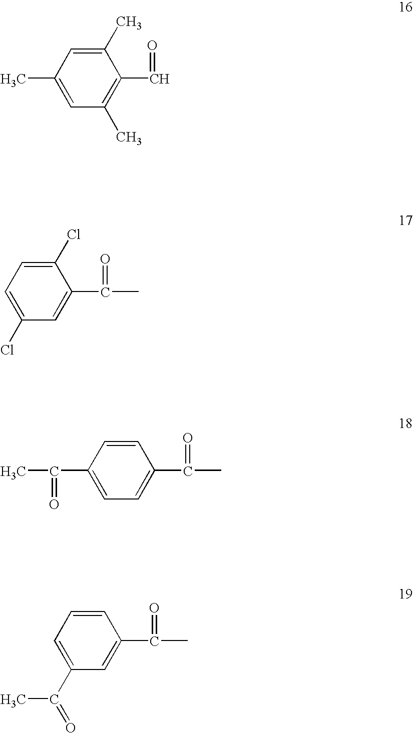

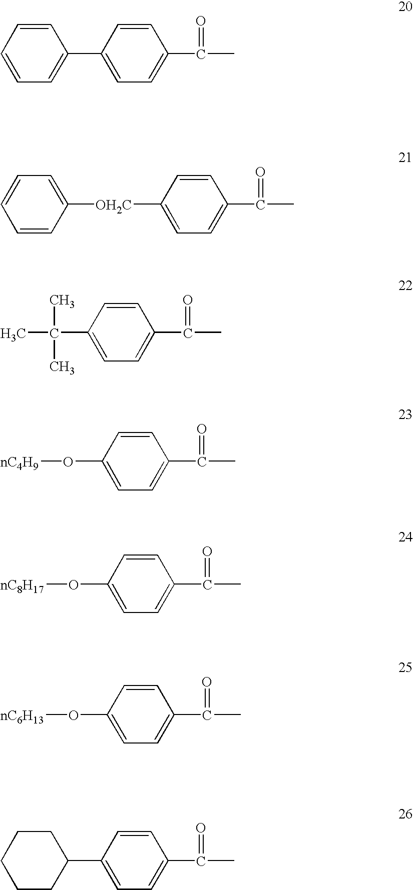

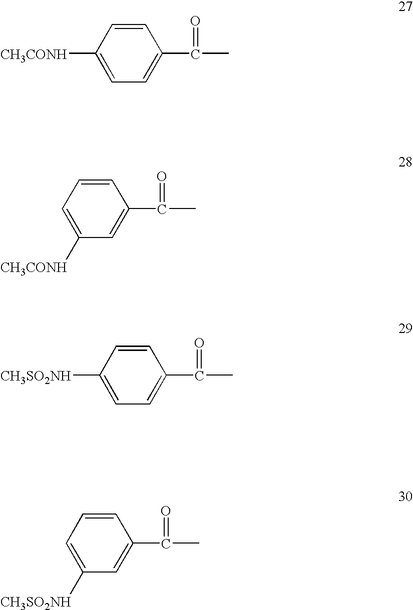

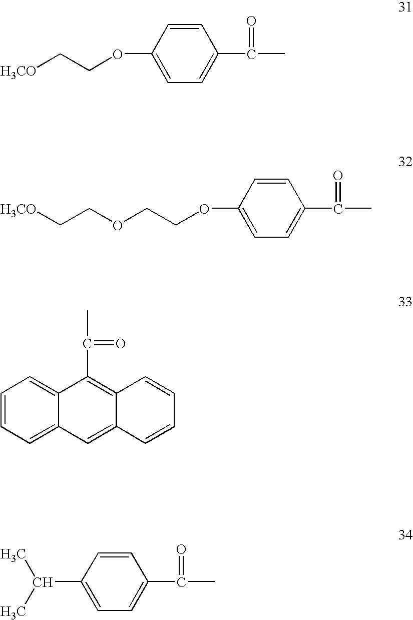

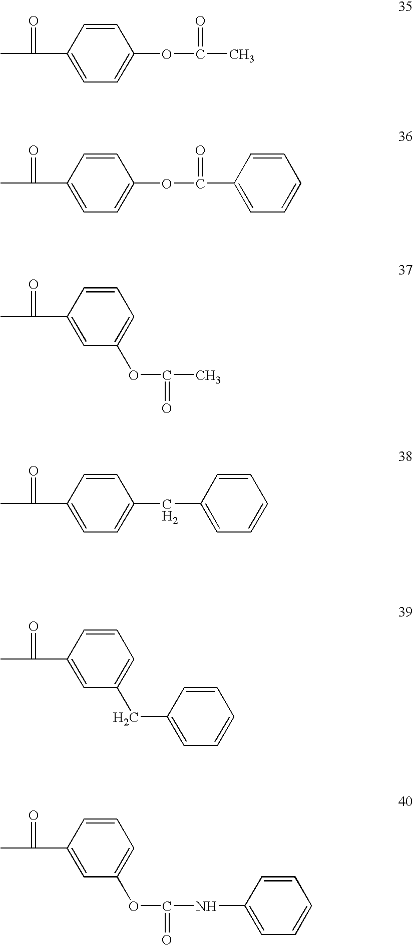

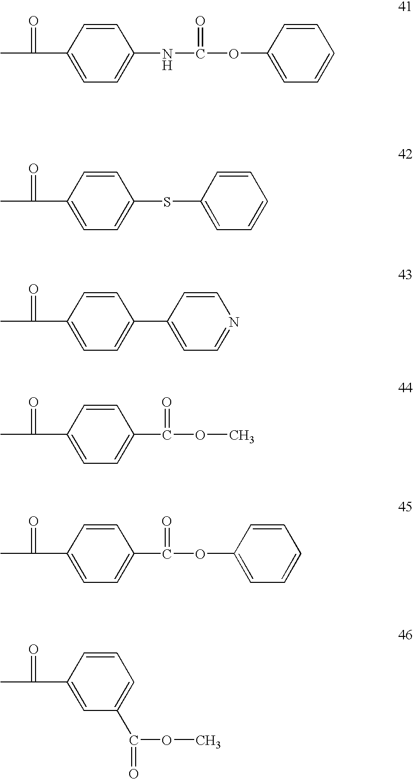

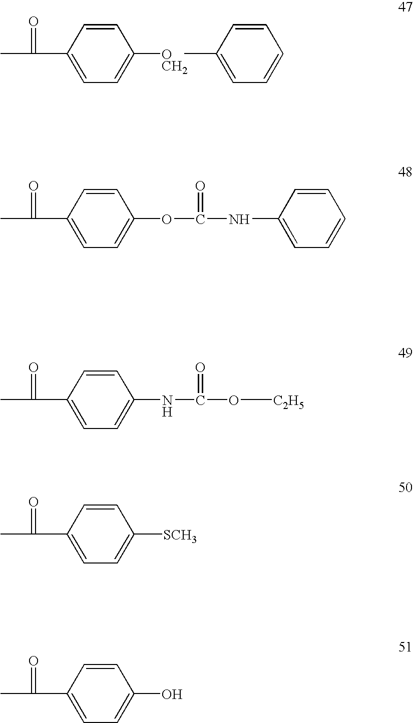

(Degree of Polymerization of Cellulose Acylate)

The degree of polymerization of cellulose acylate that is preferably used in the invention is 180 to 700 as the viscosity average degree of polymerization, and the degree of polymerization of cellulose acetate is preferably 180 to 550, more preferably 180 to 400, and particularly preferably 180 to 350. When the degree of polymerization is excessively high, the viscosity of the cellulose acylate dope solution is increased, and film production by flow casting becomes difficult. When the degree of polymerization is excessively low, strength of the produced film is decreased. The average degree of polymerization can be measured by the intrinsic viscosity method of Uda et al. (Kazuo Uda and Hideo Saito, Journal of the Society of Fiber Science and Technology, Vol. 18, No. 1, pp. 105-120 (1962)). The method is described in detail in JP-A No.9-95538.

Further, the molecular weight distribution of cellulose acylate that is preferably used for the invention is determined by gel permeation chromatography, and it is preferable that the polydispersity index Mw/Mn (Mw is the mass average molecular weight, and Mn is the number average molecular weight) is small, while the molecular weight distribution is narrow. The specific value of Mw/Mn is preferably 1.0 to 3.0, more preferably 1.0 to 2.0, and most preferably 1.0 to 1.6.

When low molecular weight components are removed, the average molecular weight (degree of polymerization) is increased, but the viscosity becomes lower than the viscosity of conventional cellulose acylate, thus the cellulose acylate of the invention being useful. A cellulose acylate having less low molecular weight components can be obtained by removing low molecular weight components from a cellulose acylate that has been synthesized using a conventional method. Removal of low molecular weight components can be carried out by washing the cellulose acylate with an appropriate organic solvent. Further, when a cellulose acylate having less low molecular weight components is to be produced, it is preferable to adjust the amount of the sulfuric acid catalyst in the acetylation reaction to 0.5 to 25 parts by weight relative to 100 parts by weight of cellulose. When the amount of the sulfuric acid catalyst is adjusted to the above-mentioned range, a cellulose acylate which is favorable in the aspect of distribution of molecular weight (having uniform molecular weight distribution) can be synthesized. When a cellulose acylate is to be used for the production of the cellulose acylate according to the invention, its water content is preferably 2% by weight or less, more preferably 1% by weight or less, and particularly preferably 0.7% by weight or less. In general, cellulose acylate contains water, and its water content is known to be 2.5 to 5% by weight. In order to attain the above-mentioned cellulose acylate water content in the invention, it is required to dry the cellulose acylate, and the method of drying is not particularly limited as long as the desired water content can be achieved. The methods for synthesizing the cellulose acylate according to the invention are described in detail in the Technical Report of Japan Institution of Invention and Innovation, Technology No. 2001-1745, published on Mar. 15, 2001, Japan Institution of Invention and Innovation, pp 7-12.

The cellulose acylate used for the invention may be used as a single species or as a mixture of two or more different species of cellulose acylate, as long as the substituent, degree of substitution, degree of polymerization, molecular weight distribution and the like fall within the above-mentioned ranges.

(Compound Used for the Invention to Reduce Humidity Dependency)

The cellulose acylate film of the invention preferably employs a compound for which a value represented by R, indicating the interaction between the subject compound and cellulose acylate, satisfies the following conditional expression (4), as a compound reducing humidity dependency, for the purpose of reducing the humidity dependency of the optical performance:
0≦R≦0.9 Conditional Expression (4)
provided that when the self-diffusion coefficient of the compound alone in a solution is Da, the self-diffusion coefficient of the compound in the co-presence of cellulose acylate in the solution is Db, and the ratio thereof is RD=Db/Da, the ratio of RD of the subject compound and of a comparison compound is R=RD (subject compound)/RD (comparison compound), and the value of R is to be determined. The comparison compound to be used is adamantane.

(Measurement of Self-Diffusion Coefficients Da and Db)

According to the invention, the self-diffusion coefficients Da and Db were measured using the PFG-NMR method in the following manner. That is, for the self-diffusion coefficient Da of the compound itself, the compound to be subject to the measurement was dissolved in a solvent for NMR (CD₂Cl₂) to a certain concentration by weight (1.2 mg/500 μl), and according to the PFG-NMR method, specifically while varying the gradient intensity (G=3.2 to 28.6 G/cm), the peak intensity of a specific peak for the subject compound was measured for each gradient intensity. From these peak intensity values and other measurement conditions, the self-diffusion coefficient Da was determined. For the self-diffusion coefficient Db of the compound in the co-presence of cellulose acylate in the solution, the compound to be subject to the measurement was dissolved to a certain concentration (1.2 mg/500 μl) in the same manner as in the measurement of Da. Cellulose acylate was also dissolved in the same solvent for NMR as that used in the measurement of Da to a specific concentration (10 mg/500 μl), and then Db was determined in the same manner as in the method for measuring the self-diffusion coefficient Da. Also, from the ratio of these coefficients, RD=Db/Da was determined. As the interaction between cellulose acylate and the compound to be subject to the measurement is larger, the self-diffusion coefficient in the co-presence of cellulose acylate is smaller. From this viewpoint, as the above-described RD value is decreased, the interaction between cellulose acylate and the compound to be subject to the measurement is increased.

According to the invention, the value R, which was obtained by standardizing the aforementioned RD values as a ratio of the measurement compound to the comparison compound, was determined by the formula: R=RD (subject compound)/RD (comparison compound), in order to use the R value as an index to indicate the interaction between cellulose acylate and the subject compound.

For details of the method of the invention for measuring the self-diffusion coefficient according to the PFG-NMR method, AVANCE-600 (Bruker Corp.) and a gradient unit (GREAT 1/10) were used as the measuring equipment, and the BPPLED method was used as the pulse program. The measurement conditions were such as that δ=3 ms, Δ=50 ms, temperature=25° C., waveform=sine wave, gradient intensity G=3.2 to 28.6 G/cm, and the integration number was 64 times.

For the purpose of reducing the humidity dependency of optical performance, the compound to be used for the cellulose acylate film of the invention is required to have larger interaction with cellulose acylate. Accordingly, it is desirable that the R value determined by the above-described method is smaller, and therefore it is more preferable that 0≦R≦0.85, even more preferably 0≦R≦0.8, and most preferably 0≦R≦0.75.

(Effect of the Compound Used for the Invention to Reduce Humidity Dependency)

It is also effective for satisfying the conditional expression (1), which is a requirement of the invention, by using a compound satisfying the above conditional expression (4) and setting the conditions for film production to the specified ranges:
0≦A≦12 Conditional Expression (1)
wherein A is a value indicated by the formula: A=−(Rth(80%)−Rth(10%))/(equilibrium water content (80%)−equilibrium water content (10%); Rth(X %) is the Rth value of the film under an ambience of 25° C. and X % RH, which is normalized to the Rth value of a 80 μm-thick film; and the equilibrium water content (X %) is the equilibrium water content of the film under an ambience of 25° C. and X % RH.

It is desirable that the cellulose acylate film of the invention has lower humidity dependency of optical performance, while the A value is preferably that 0≦A≦1, and more preferably 0≦A≦10. When the A value is larger than 12, it is necessary to reduce the equilibrium water content of the cellulose acylate film particularly under high humidity conditions, in order to reduce the humidity dependency sufficiently. However, when the water content is reduced, the polarizing plate processability is reduced.

(Other Characteristics of the Compound Used for the Invention to Reduce Humidity Dependency)

The compound used for the invention to reduce the humidity dependency preferably has a molecular weight of 3000 or less and a log p value in the range of 0 to 10, in order to further reduce the optical anisotropy of the film. When these characteristics are satisfied, the compatibility of the compound with cellulose acylate is further enhanced, and consequently the optical anisotropy of the cellulose acylate film can be reduced.

(Effect of Other Characteristics of the Compound Used for the Invention to Reduce Humidity Dependency)

When a compound satisfying the above-described characteristics is used, the following preferred requirement (conditional expressions (2) and (3)) of the invention can be satisfied:
0≦Re(λ)≦10 Conditional Expression (2)
−25≦Rth(λ)≦25 Conditional Expression (3)

(λ is in the range of 400 nm to 700 nm).

Preferably, the wavelength λ is such that 0≦Re(λ)≦5 and −20≦Rth(λ)≦20, and more preferably 0≦Re(λ)≦2 and −15≦Rth(λ)≦15, in the region ranging from 400 nm to 700 nm.

Also, in the above formula, Re(λ) is the value of in-plane retardation (unit: nm) at wavelength λ nm, while Rth(λ) is the value of retardation in the film thickness direction (unit: nm) at wavelength λ nm.

Hereinafter, the compound that can be favorably used for the invention may be specifically exemplified by a compound represented by any one of the above-described formulae (1) to (6a), but the invention is not limited to these compounds.

Furthermore, the cellulose acylate film of the invention preferably employs additives that have no dissociable groups, for the purpose of further improving the humidity dependency of the optical performance, and the cellulose acylate film of the invention more preferably employs a compound represented by any one of the above formulae (1) to (3), and even more preferably a compound represented by any one of the formulae (2) and (3).

First, the compound represented by the formula (1) of the invention will be described in detail.

In the above-described formula (1), R¹ is an aryl group. R² and R³ are each independently an alkyl group or an aryl group, at least one of them being an aryl group. When R² is an aryl group, R³ is an alkyl group or an aryl group, but R³ is more preferably an alkyl group. Here, the alkyl group may be linear, branched or cyclic, and is preferably a group having 1 to 20 carbon atoms, more preferably 1 to 15 carbon atoms, and most preferably 1 to 12 carbon atoms. The aryl group is preferably a group having 6 to 36 carbon atoms, and more preferably 6 to 24 carbon atoms.

Next, the compound represented by the formula (2) of the invention will be described in detail.

In the above-described formula (2), R⁴, R⁵ and R⁶ are each independently an alkyl group. Here, the alkyl group may be linear, branched or cyclic. It is preferable that R⁴ is a cyclic alkyl group, and it is more preferable that at least one of R⁵ and R⁶ is a cyclic alkyl group. The alkyl group is preferably a group having 1 to 20 carbon atoms, more preferably 1 to 15 carbon atoms, and most preferably 1 to 12 carbon atoms. The cyclic alkyl group is particularly preferably a cyclohexyl group.

In the above-described formulae (1) and (2), the alkyl group and aryl group may be respectively substituted. The substituent is preferably a halogen atom (e.g., chlorine, bromine, fluorine and iodine), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group or an acylamino group; more preferably a halogen atom, an alkyl group, an aryl group, an alkoxy group, an aryloxy group, a sulfonylamino group or an acylamino group; and particularly preferably an alkyl group, an aryl group, a sulfonylamino group or an acylamino group.

Further, the amount of addition of the compound represented by the formula (1) or (2) of the invention is preferably 1 to 30 parts by weight, more preferably 2 to 30 parts by weight, even more preferably 2 to 25 parts by weight, and most preferably 2 to 20 parts by weight, relative to 100 parts by weight of the cellulose product.

Next, preferred examples of the compound represented by formula (1) or formula (2) will be described below, but the invention is not intended to be limited to these specific examples.

Compound marked as (A-) are the specific examples of the compound represented by formula (1), while compounds marked as (B—) are the specific examples of the compound represented by formula (2).

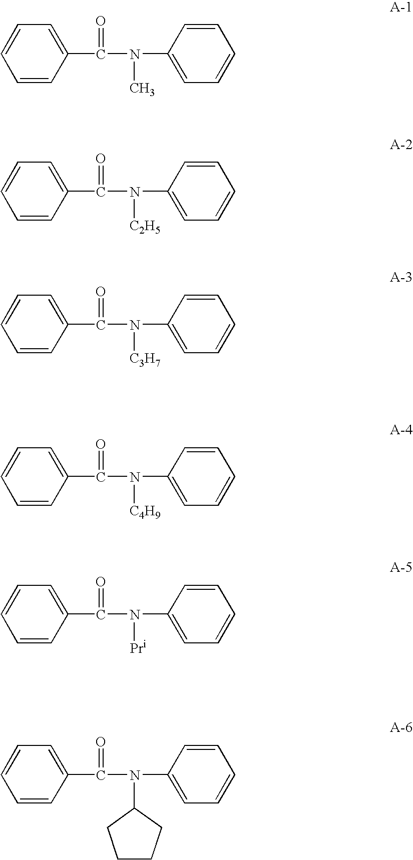

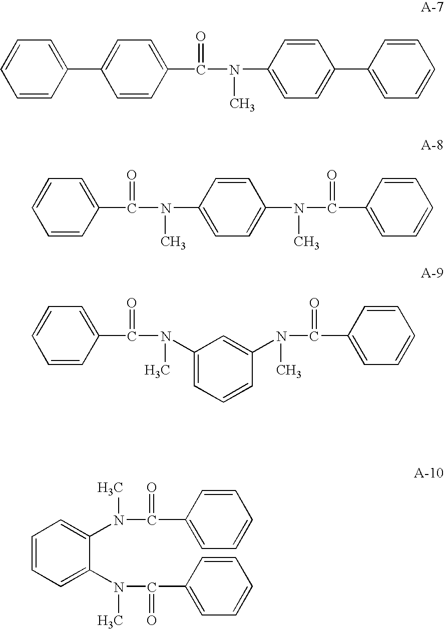

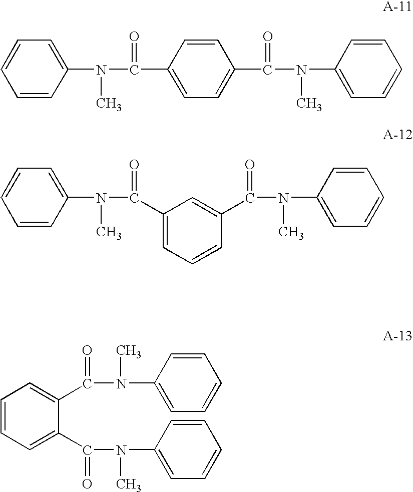

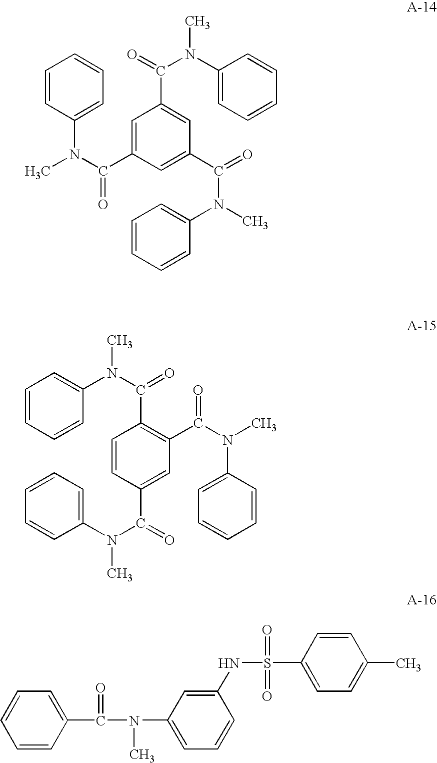

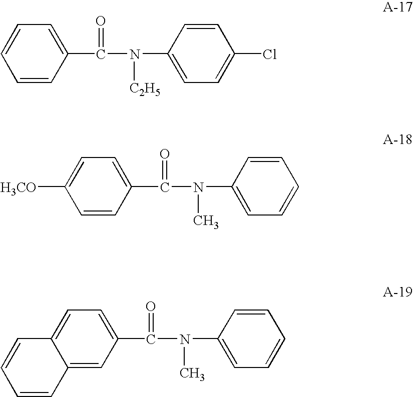

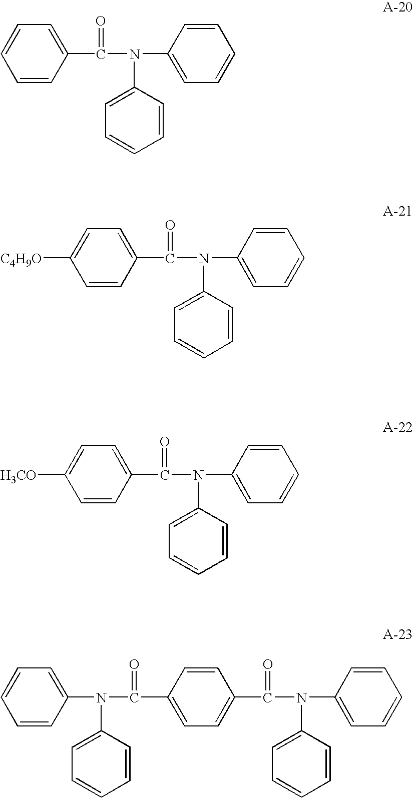

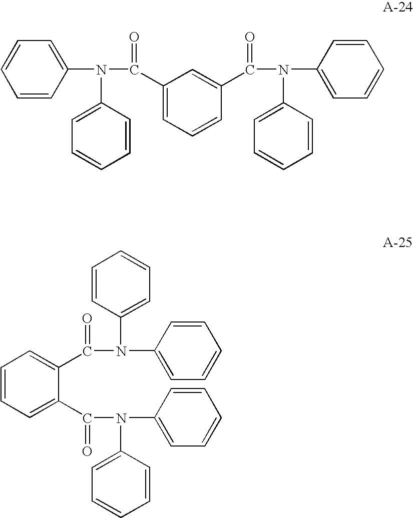

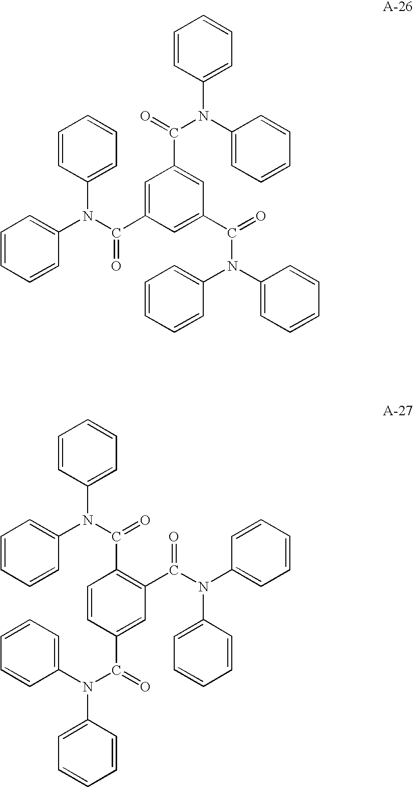

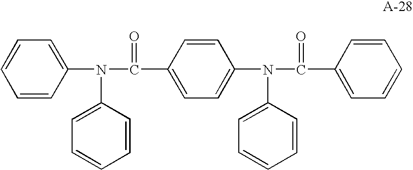

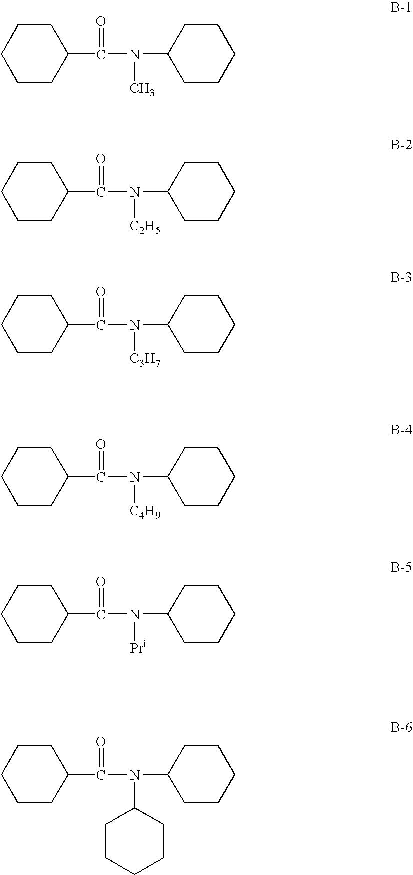

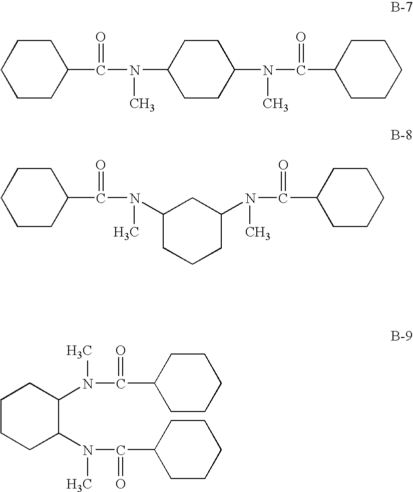

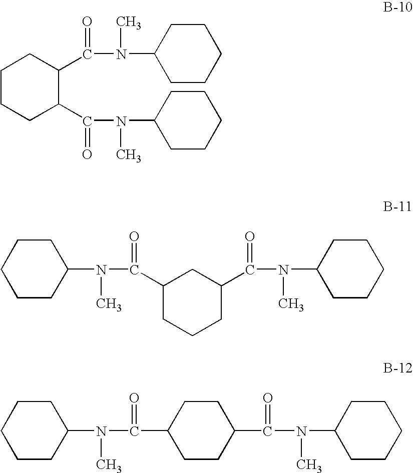

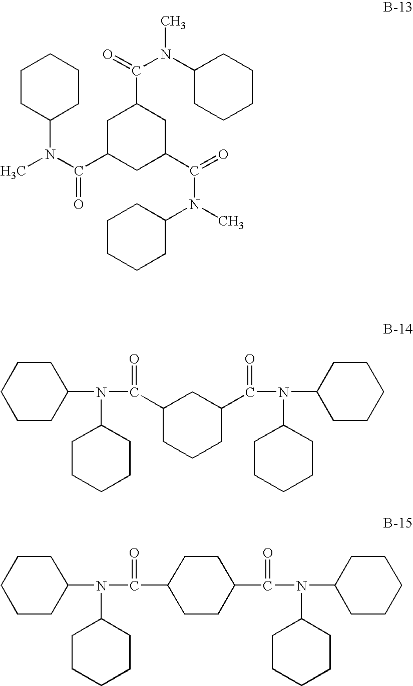

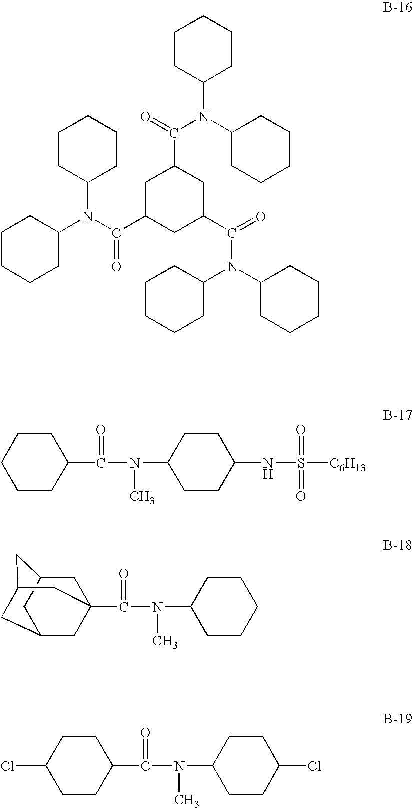

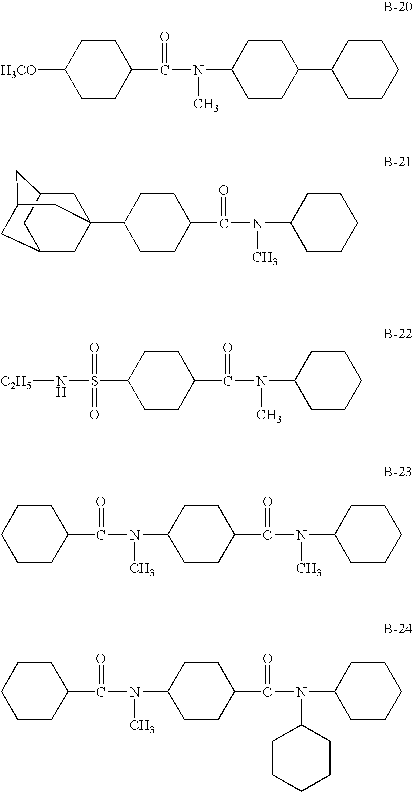

The compounds described above can be prepared by a known method. That is, the compounds of the formulae (1) and (2) can be obtained by a dehydration-condensation reaction of carboxylic acids and amines using a condensing agent (for example, dicyclohexylcarbodiimide (DCC) or the like), a substitution reaction of carboxylic chloride derivatives and amine derivative, or the like.

Next, the compound represented by the following formula (3) will be described.

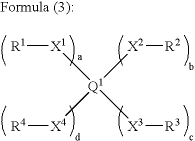

In the formula (3), R¹, R², R³ and R⁴ are each a hydrogen atom, a substituted or unsubstituted aliphatic group or a substituted or unsubstituted aromatic group. X¹, X², X³ and X⁴ are each a divalent linking group formed from at least one group selected from the group consisting of a single bond, —CO— and —NR⁵— (wherein, R¹ is a substituted or unsubstituted aliphatic group or a substituted or unsubstituted aromatic group). a, b, c and d are an integer of 0 or greater, and a+b+c+d is 2 or greater. Q¹ is an organic group having a valency of (a+b+c+d).

Further, the compound represented by formula (3) is preferably a compound represented by the following formula (7).

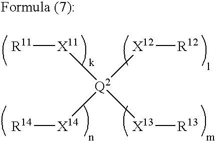

In the formula (7), R¹¹, R¹², R¹³ and R¹⁴ are each a hydrogen atom, a substituted or unsubstituted aliphatic group or a substituted or unsubstituted aromatic group. X¹¹, X¹², X¹³ and X¹⁴ are each a divalent linking group formed from at least one group selected from the group consisting of a single bond, —CO— and —NR⁵— (wherein, R⁵ is a substituted or unsubstituted aliphatic group or a substituted or unsubstituted aromatic group). k, l, m and n are 0 or 1, and k+l+m+n is 2, 3 or 4. Q² is a divalent to tetravalent organic group.

Further, the compound represented by formula (3) is preferably a compound represented by the following formula (8).
R²¹—Y¹—L¹—Y²—R²² Formula (8)

In the formula (8), R²¹ and R²² are each a substituted or unsubstituted aliphatic group or a substituted or unsubstituted aromatic group. Y¹ and Y² are each —CONR²³— and —NR²⁴CO— (wherein, R²³ and R²⁴ are a substituted or unsubstituted aliphatic group or a substituted or unsubstituted aromatic group). L¹ is a divalent organic group formed from at least one group selected from the group consisting of —O—, —S—, —SO—, —SO₂—, —CO—, —NR²⁵— (wherein, R²⁵ is a hydrogen atom, a substituted or unsubstituted aliphatic group or a substituted or unsubstituted aromatic group), an alkylene group and an arylene group.

Further, the compound represented by formula (3) is preferably a compound represented by the following formula (9).

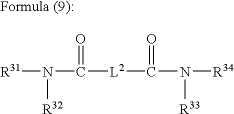

In the formula (9), R³¹, R³², R³³ and R³⁴ are each a substituted or unsubstituted aliphatic group or a substituted or unsubstituted aromatic group. L² is a divalent organic group formed from at least one group selected from the group consisting of —O—, —S—, —SO—, —SO₂—, —CO—, —NR³⁵— (wherein, R³⁵ is a hydrogen atom, a substituted or unsubstituted aliphatic group or a substituted or unsubstituted aromatic group), an alkylene group and an arylene group.

Further, the compound represented by formula (3) is preferably a compound represented by the following formula (11).

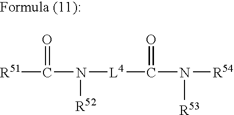

In the formula (11), R⁵¹, R⁵², R⁵³ and R⁵⁴ are each a substituted or unsubstituted aliphatic group or a substituted or unsubstituted aromatic group. L⁴ is a divalent organic group formed from at least one group selected from the group consisting of —O—, —S—, —SO—, —SO₂—, —CO—, —NR⁵⁵— (wherein, R⁵⁵ is a hydrogen atom, a substituted or unsubstituted aliphatic group or a substituted or unsubstituted aromatic group), an alkylene group and an arylene group.

The compound represented by formula (3) of the invention will be described as follows.

In the formula (3), R¹, R², R³ and R⁴ are each a hydrogen atom, a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. X¹, X², X³ and X⁴ are each a divalent linking group formed from at least one group selected from the group consisting of a single bond, —CO— and —NR⁵— (wherein, R⁵ is a substituted or unsubstituted aliphatic group or a substituted or unsubstituted aromatic group, and more preferably an unsubstituted one and/or an aliphatic group). A combination of X¹, X², X³ and X⁴ is not particularly limited, but more preferably selected from —CO— and —NR⁵—. a, b, c and d are an integer of 0 or greater, and a+b+c+d is 2 or greater. a+b+c+d is preferably 2 to 8, more preferably 2 to 6, and even more preferably 2 to 4. Q¹ is an organic group having a valency of (a+b+c+d) (excluding a cyclic one). The valence of Q¹ is preferably 2 to 8, more preferably 2 to 6, and most preferably 2 to 4.

The organic group is a group consisting of organic compounds.

Further, the compound represented by the above formula (3) is preferably a compound represented by the above formula (7).

In the formula (7), R¹¹, R¹², R¹³ and R¹⁴ are each a hydrogen atom, a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. X¹¹, X¹², X¹³ and X¹⁴ are each a divalent linking group formed from at least one group selected from the group consisting of a single bond, —CO— and —NR¹⁵— (wherein, R¹⁵ is a substituted or unsubstituted aliphatic group or a substituted or unsubstituted aromatic group, and more preferably an unsubstituted one and/or an aliphatic group). A combination of X¹¹, X¹², X¹³ and X¹⁴ is not particularly limited, but more preferably selected from —CO— and —NR¹⁵—. k, l, m and n are 0 or 1, and k+l+m+n is 2, 3 or 4. Q¹ is a divalent to tetravalent organic group (excluding a cyclic one). The valence of Q¹ is preferably 2 to 4, and more preferably 2 or 3.

The compound represented by the above formula (3) is preferably a compound represented by the above formula (8).

In the formula (8), R²¹ and R²² are each a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. Y¹ and Y² are each independently —CONR²³— or —NR²⁴CO—, and R²³ and R²⁴ are a substituted or unsubstituted aliphatic group or a substituted or unsubstituted aromatic group and more preferably an unsubstituted one and/or an aliphatic group. L¹ is a divalent organic group (excluding a cyclic one) formed from at least one group selected from the group consisting of —O—, —S—, —SO—, —SO₂—, —CO—, —NR²⁵—, an alkylene group and an arylene group. A combination of L¹ is not particularly limited, but preferably selected from —O—, —S—, —NR²⁵— and an alkylene group, more preferably selected from —O—, —S— and an alkylene group, and most preferably selected from —O— and an alkylene group.

The compound represented by formula (3) is preferably a compound represented by the above formula (9).

In the formula (9), R³¹, R³², R³³ and R³⁴ are each a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. L² is a divalent linking group formed from at least one group selected from the group consisting of —O—, —S—, —SO—, —SO₂—, —CO—, —NR³⁵— (wherein, R³⁵ is a substituted or unsubstituted aliphatic group or a substituted or unsubstituted aromatic group, and more preferably an unsubstituted one and/or an aliphatic group), an alkylene group and an arylene group. A combination of L² is not particularly limited, but preferably selected from —O—, —S—, —NR³⁵— and an alkylene group, more preferably selected from —O—, —S— and an alkylene group, and most preferably selected from —O— and an alkylene group.

The compound represented by formula (3) is preferably a compound represented by the above formula (10).

In the formula (10), R⁴¹, R⁴², R⁴³ and R⁴⁴ are each a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. L³ is a divalent linking group formed from at least one group selected from the group consisting of —O—, —S—, —SO—, —SO₂—, —CO—, —NR⁴⁵— (wherein, R⁴⁵ is a substituted or unsubstituted aliphatic group or a substituted or unsubstituted aromatic group, and more preferably an unsubstituted one and/or an aliphatic group), an alkylene group and an arylene group. A combination of L³ is not particularly limited, but preferably selected from —O—, —S—, —NR⁴⁵— and an alkylene group, more preferably selected from —O—, —S— and an alkylene group, and most preferably selected from —O— and an alkylene group.

The compound represented by formula (3) is preferably a compound represented by the above formula (11).

In the formula (11), R⁵¹, R⁵², R⁵³ and R⁵⁴ are each a substituted or unsubstituted aliphatic group or a substituted or unsubstituted aromatic group, and preferably an aliphatic group. The aliphatic group may be any one of linear, branched or cyclic, and more preferably cyclic. As a substituent of the aliphatic group and aromatic group, a substituent T described below can be mentioned, but an unsubstituted one is preferred. L⁴ is a divalent linking group formed from at least one group selected from the group consisting of —O—, —S—, —SO—, —SO₂—, —CO—, —NR⁵⁵— (wherein, R⁵⁵ is a substituted or unsubstituted aliphatic group or a substituted or unsubstituted aromatic group, and more preferably an unsubstituted one and/or an aliphatic group), an alkylene group and an arylene group. A combination of L⁴ is not particularly limited, but preferably selected from —O—, —S—, —NR⁵⁵— and an alkylene group, more preferably selected from —O—, —S— and an alkylene group, and most preferably selected from —O— and an alkylene group.

Hereinbelow, the substituted or unsubstituted aliphatic group mentioned as the substituents of formula (3) and formulae (7) to (11) will be described. The aliphatic group may be linear, branched or cyclic, and has preferably 1 to 25 carbon atoms, more preferably 6 to 25 carbon atoms, and particularly preferably 6 to 20 carbon atoms. Specific examples of the aliphatic group include a methyl group, an ethyl group, an n-propyl group, an isopropyl group, a cyclopropyl group, an n-butyl group, an isobutyl group, a tert-butyl group, an amyl group, an isoamyl group, a tert-amyl group, an n-hexyl group, a cyclohexyl group, an n-heptyl group, an n-octyl group, bicyclooctyl group, an adamantyl group, an n-decyl group, a tert-octyl group, a dodecyl group, a hexadecyl group, an octadecyl group, a didecyl group and the like.

Hereinbelow, the aromatic group mentioned as the substituents of formula (3) and formulae (7) to (11) will be described. The aromatic group may be an aromatic hydrocarbon group or an aromatic heterocyclic group, and more preferably an aromatic hydrocarbon group. The aromatic hydrocarbon group has preferably 6 to 24 carbon atoms, and even more preferably 6 to 12 carbon atoms. Specific examples of the ring of the aromatic hydrocarbon group include benzene, naphthalene, anthracene, biphenyl, terphenyl and the like. As the aromatic hydrocarbon group, particularly preferred is benzene, naphthalene and biphenyl. As the aromatic heterocyclic ring group, preferred is one containing at least one of an oxygen atom, a nitrogen atom or a sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene and the like. As the aromatic heterocyclic group, a pyridine ring, a triazine ring and a quinoline ring are particularly preferred.

Moreover, the substituent T described above in each above-mentioned formulae will be described in detail.

Examples of the substituent T include an alkyl group (an alkyl group having preferably 1 to 20 carbon atoms, more preferably 1 to 12 carbon atoms, and particularly preferably 1 to 8 carbon atoms such as a methyl group, an ethyl group, an isopropyl group, a tert-butyl group, an n-octyl group, an n-decyl group, n-hexadecyl group, a cyclopropyl group, a cyclopentyl group, a cyclohexyl group, etc.), an alkenyl group (an alkenyl group having preferably 2 to 20 carbon atoms, more preferably 2 to 12 carbon atoms, and particularly preferably 2 to 8 carbon atoms such as a vinyl group, an allyl group, a 2-butenyl group, a 3-pentenyl group, etc.), an alkynyl group (an alkynyl group having preferably 2 to 20 carbon atoms, more preferably 2 to 12 carbon atoms, and particularly preferably 2 to 8 carbon atoms such as a propargyl group, a 3-pentynyl group, etc.), an aryl group (an aryl group having preferably 6 to 30 carbon atoms, more preferably 6 to 20 carbon atoms, and particularly preferably 6 to 12 carbon atoms such as a phenyl group, a biphenyl group, a naphthyl group, etc.), an amino group (an amino group having preferably 0 to 20 carbon atoms, more preferably 0 to 10 carbon atoms, and particularly preferably 0 to 6 carbon atoms such as an amino group, a methylamino group, a dimethylamino group, a diethylamino group, a dibenzylamino group, etc.), an alkoxy group (an alkoxy group having preferably 1 to 20 carbon atoms, more preferably 1 to 12 carbon atoms, and particularly preferably 1 to 8 carbon atoms such as a methoxy group, an ethoxy group, a butoxy group, etc.), an aryloxy group (an aryloxy group having preferably 6 to 20 carbon atoms, more preferably 6 to 16 carbon atoms, and particularly preferably 6 to 12 carbon atoms such as a phenyloxy group, a 2-naphthyloxy group, etc.), an acyl group (an acyl group having 1 to 20 carbon atoms, more preferably 1 to 16 carbon atoms, and particularly preferably 1 to 12 carbon atoms such as an acetyl group, a benzoyl group, a formyl group, a pivaloyl group, etc.), an alkoxycarbonyl group (an alkoxycarbonyl group having preferably 2 to 20 carbon atoms, more preferably 2 to 16 carbon atoms, and particularly preferably 2 to 12 carbon atoms such as a methoxycarbonyl group, an ethoxycarbonyl group, etc.), an aryloxycarbonyl group (an aryloxycarbonyl group having preferably 7 to 20 carbon atoms, more preferably 7 to 16 carbon atoms, and particularly preferably 7 to 10 carbon atoms such as phenyloxycarbonyl group, etc.), an acyloxy group (an acyloxy group having preferably 2 to 20 carbon atoms, more preferably 2 to 16 carbon atoms, and particularly preferably 2 to 10 carbon atoms such as an acetoxy group, a benzoyloxy group, etc.), an acylamino group (an acylamino group having preferably 2 to 20 carbon atoms, more preferably 2 to 16 carbon atoms, and particularly preferably 2 to 10 carbon atoms such as an acetylamino group, a benzoylamino group, etc.), an alkoxycarbonylamino group (an alkoxycarbonylamino group having preferably 2 to 20 carbon atoms, more preferably 2 to 16 carbon atoms, and particularly preferably 2 to 12 carbon atoms such as methoxycarbonylamino group, etc.), an aryloxycarbonylamino group (an aryloxycarbonylamino group having preferably 7 to 20 carbon atoms, more preferably 7 to 16 carbon atoms, and particularly preferably 7 to 12 carbon atoms such as phenyloxycarbonylamino group, etc.), a sulfonylamino group (a sulfonylamino group having preferably 1 to 20 carbon atoms, more preferably 1 to 16 carbon atoms, and particularly preferably 1 to 12 carbon atoms such as a methanesulfonylamino group, a benzenesulfonylamino group, etc.), a sulfamoyl group (a sulfamoyl group having preferably 0 to 20 carbon atoms, more preferably 0 to 16 carbon atoms, and particularly preferably 0 to 12 carbon atoms such as a sulfamoyl group, a methylsulfamoyl group, a dimethylsulfamoyl group, a phenylsulfamoyl group, etc.), a carbamoyl group (a carbamoyl group having preferably 1 to 20 carbon atoms, more preferably 1 to 16 carbon atoms, and particularly preferably 1 to 12 carbon atoms such as a carbamoyl group, a methylcarbamoyl group, a diethylcarbamoyl group, a phenylcarbamoyl group, etc.), an alkylthio group (an alkylthio group having preferably 1 to 20 carbon atoms, more preferably 1 to 16 carbon atoms, and particularly preferably 1 to 12 carbon atoms such as a methylthio group, an ethylthio group, etc.), an arylthio group (an arylthio group having preferably 6 to 20 carbon atoms, more preferably 6 to 16 carbon atoms, and particularly preferably 6 to 12 carbon atoms such as a phenylthio group, etc.), a sulfonyl group (a sulfonyl group having preferably 1 to 20 carbon atoms, more preferably 1 to 16 carbon atoms, and particularly preferably 1 to 12 carbon atoms such as a mesyl group, a tosyl group, etc.), a sulfinyl group (a sulfinyl group having preferably 1 to 20 carbon atoms, more preferably 1 to 16 carbon atoms, and particularly preferably 1 to 12 carbon atoms such as a methanesulfinyl group, a benzenesulfinyl group, etc.), a ureido group (a ureido group having preferably 1 to 20 carbon atoms, more preferably 1 to 16 carbon atoms, and particularly preferably 1 to 12 carbon atoms such as an ureido group, a methylureido group, a phenylureido group, etc.), a phosphoric amido group (a phosphoric amido group having preferably 1 to 20 carbon atoms, more preferably 1 to 16 carbon atoms, and particularly preferably 1 to 12 carbon atoms such as a diethylphosphoric amido group, a phenylphosphoric amido group, etc.), a hydroxyl group, a mercapto group, a halogen atom (e.g., a fluorine atom, a chlorine atom, a bromine atom and an iodine atom), a cyano group, a sulfo group, a carboxyl group, a nitro group, a hydroxamic acid group, a sulfino group, a hydrazino group, an imino group, a hetercyclic group (a heterocyclic group having preferably 1 to 30 carbon atoms, and more preferably 1 to 12 carbon atoms such as heterocyclic group containing heteroatoms such as a nitrogen atom, an oxygen atom, a sulfur atom, e.g., an imidazolyl group, a pyridyl group, a quinolyl group, a furyl group, a piperidine group, a morpholino group, a benzoxazolyl group, a benzimidazolyl group, a benzothiazolyl group, etc.), a silyl group (a silyl group having preferably 3 to 40 carbon atoms, more preferably 3 to 30 carbon atoms, and particularly preferably 3 to 24 carbon atoms such as a trimethylsilyl group, a triphenylsilyl group, etc.).

These substituents may be further substituted. In addition, when there are two or more substituent They may be the same as or different from each other. Further, they may be bonded to each other to form a ring, if possible.

Further, an amount of the compound represented by formula (3), particularly at least any one of formulae (7) to (11), to be added, is preferably 1 to 30% by weight, more preferably 2 to 30% by weight, even more preferably 2 to 25% by weight, and most preferably 2 to 20% by weight, with respect to the cellulose product.

Preferred examples of the compound represented by formula (3) are shown below, but the invention is not limited to these specific examples.

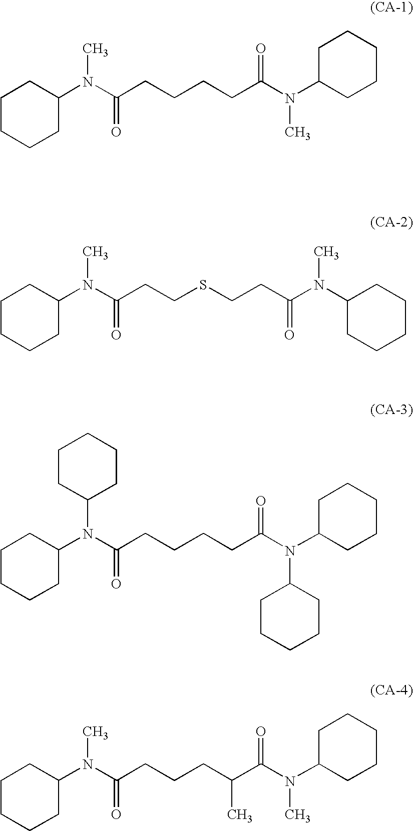

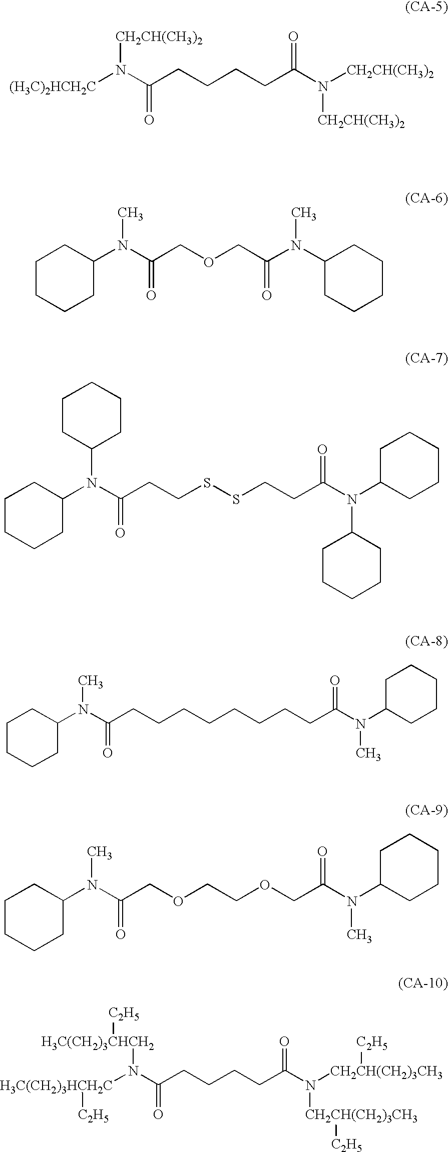

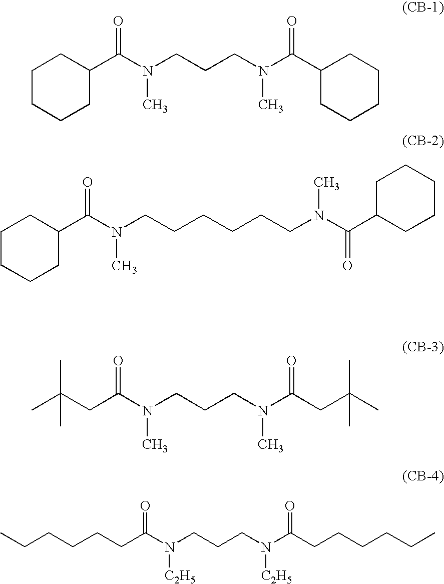

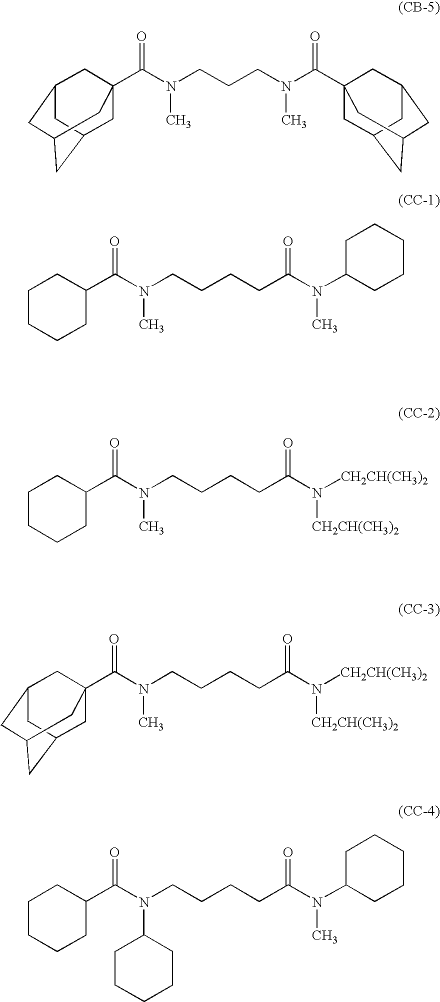

Any compound used in the invention can be prepared by a known compound. The compound represented by at least any one of formulae (3) to (11) is obtained, for example, by a condensation reaction of carbonyl chloride and amine.

The compounds of formulae (4) and (5) will be described.

In the above formula (4), R¹ is an alkyl group or an aryl group, and R² and R³ are each independently a hydrogen atom, an alkyl group or an aryl group. Further, the total number of carbon atoms of R¹, R² and R³ is particularly preferably 10 or more.

Further, in formula (5), R⁴ and R¹ are each independently an alkyl group or an aryl group. Furthermore, the total number of carbon atoms of R⁴ and R⁵ is 10 or more, and an alkyl group and an aryl group may have a substituent, respectively. Examples of the substituent include preferably a fluorine atom, an alkyl group, an aryl group, an alkoxy group, a sulfone group and a sulfonamide group, and particularly preferably an alkyl group, an aryl group, an alkoxy group, a sulfone group and 15 a sulfonamide group. In addition, an alkyl group may be linear, branched or cyclic, and has preferably 1 to 25 carbon atoms, more preferably 6 to 25 carbon atoms, and particularly preferably 6 to 20 carbon atoms (for example, methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl, and didecyl). An aryl group has preferably 6 to 30 carbon atoms, and particularly preferably 6 to 24 carbon atoms (for example, phenyl, biphenyl, terphenyl, naphthyl, binaphthyl and triphenylphenyl). Preferred examples of the compounds represented by formulae (4) and (5) are shown below, but the invention is not limited to these specific examples.

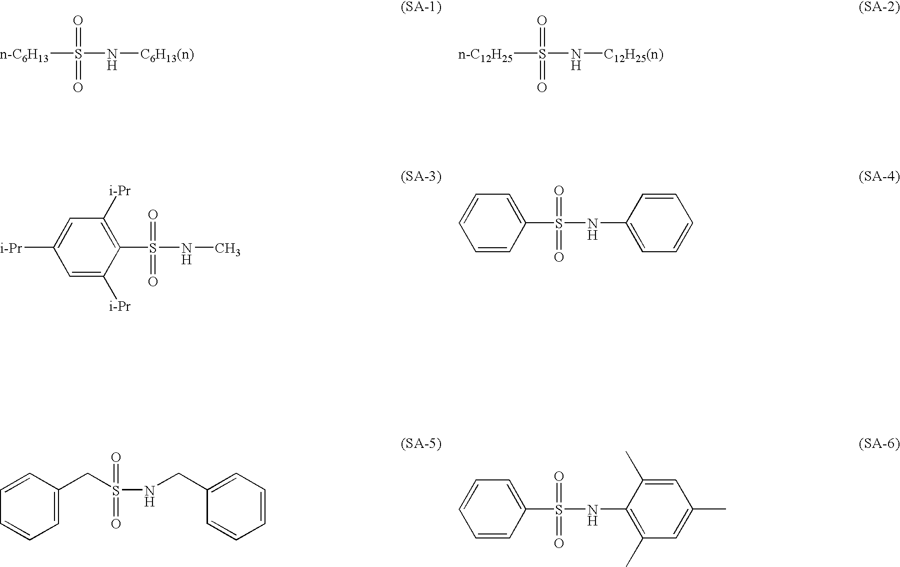

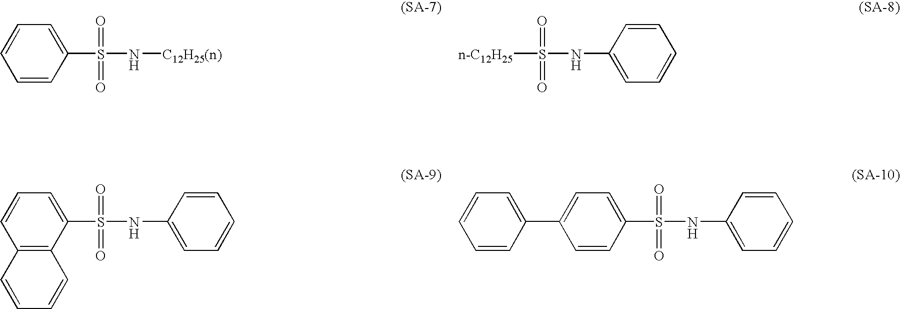

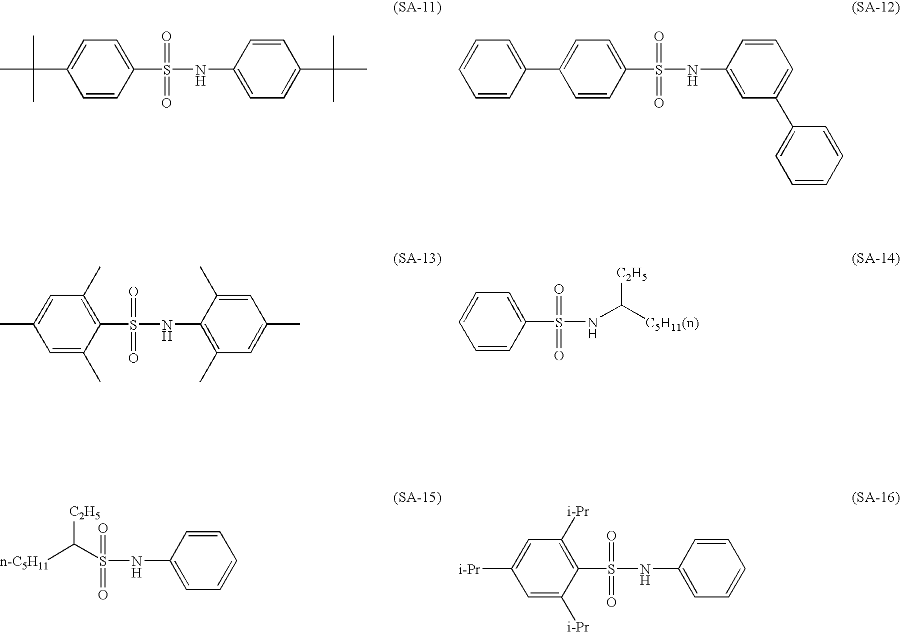

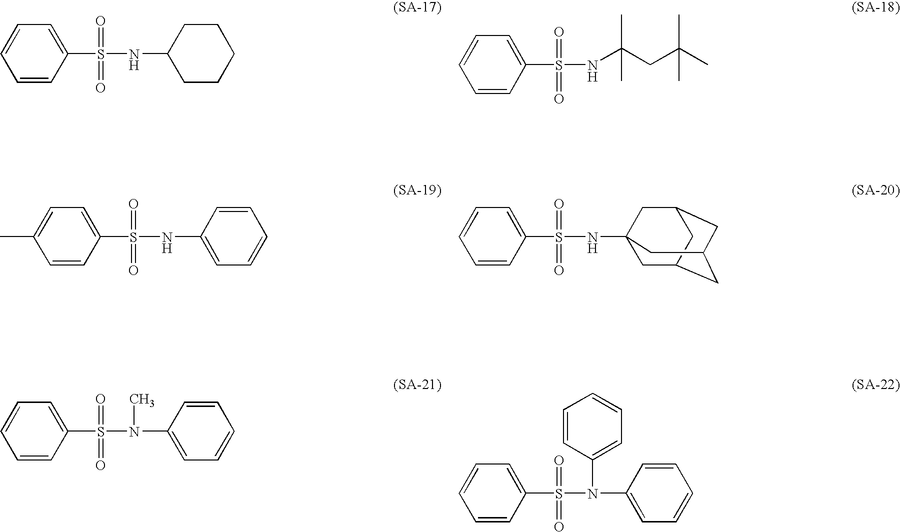

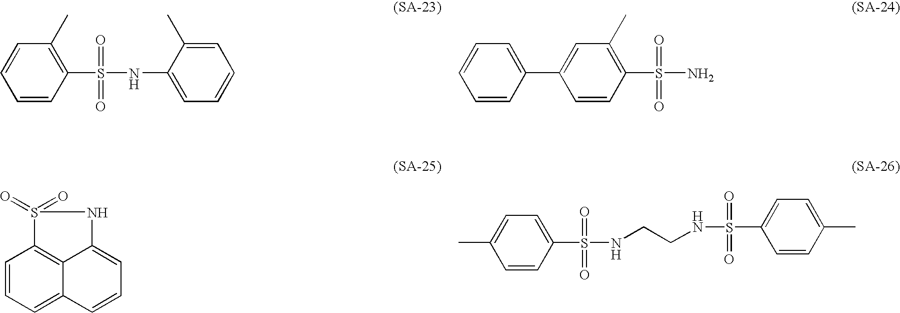

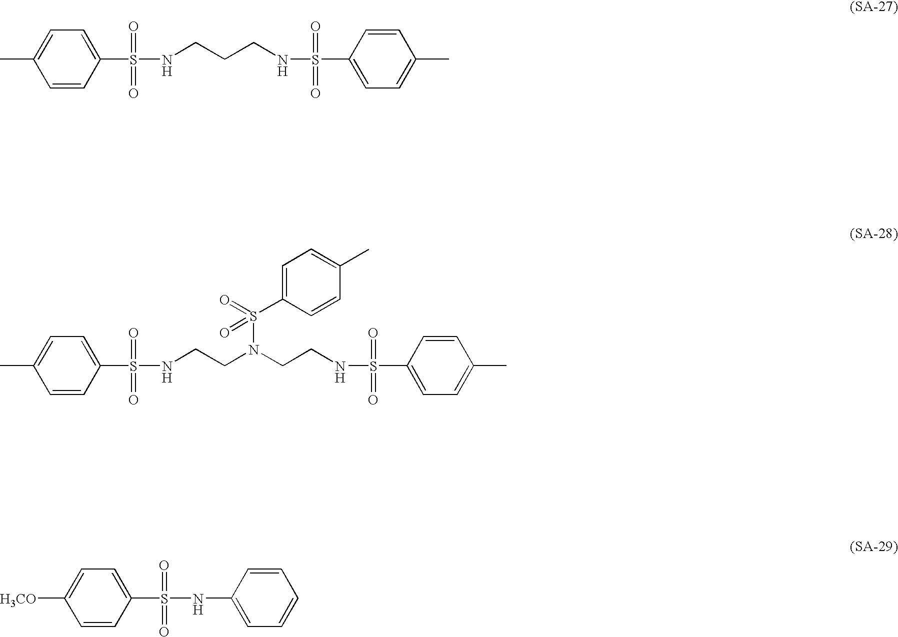

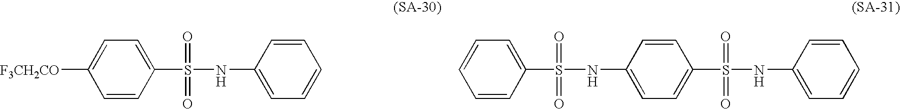

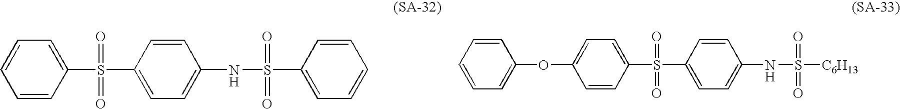

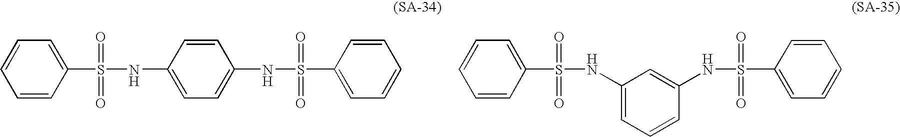

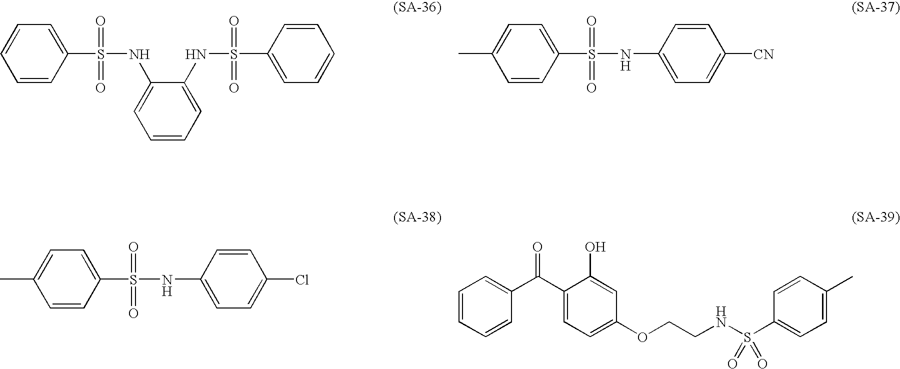

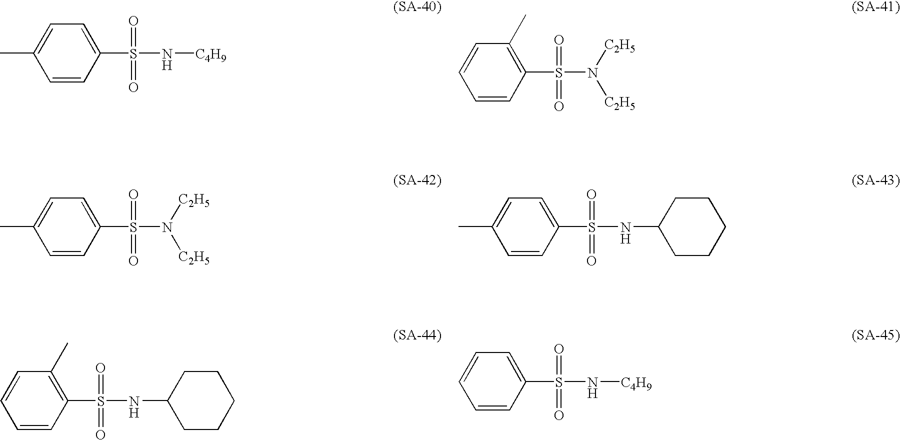

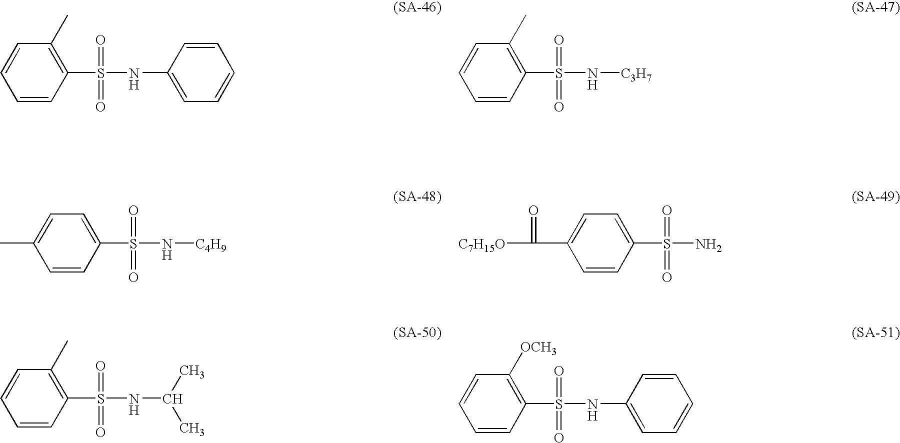

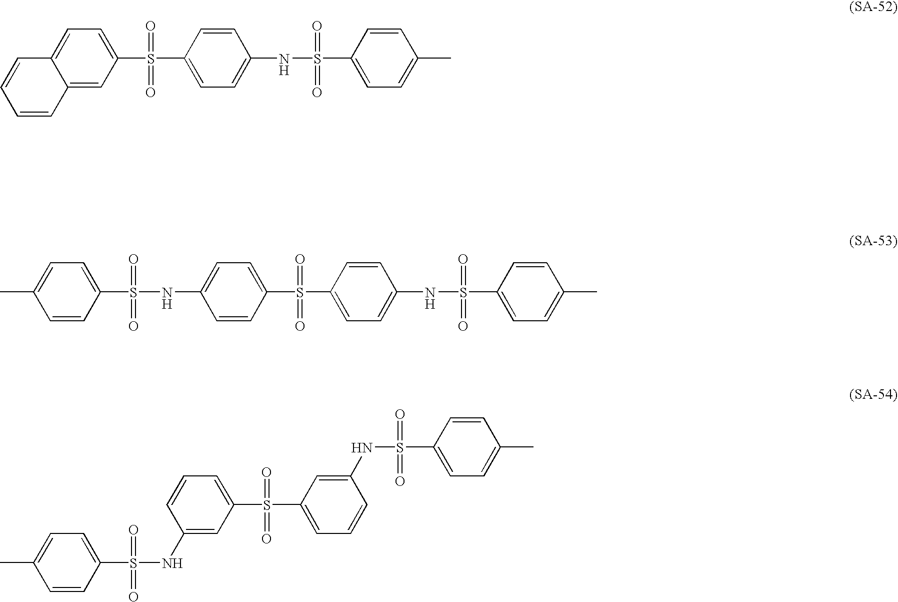

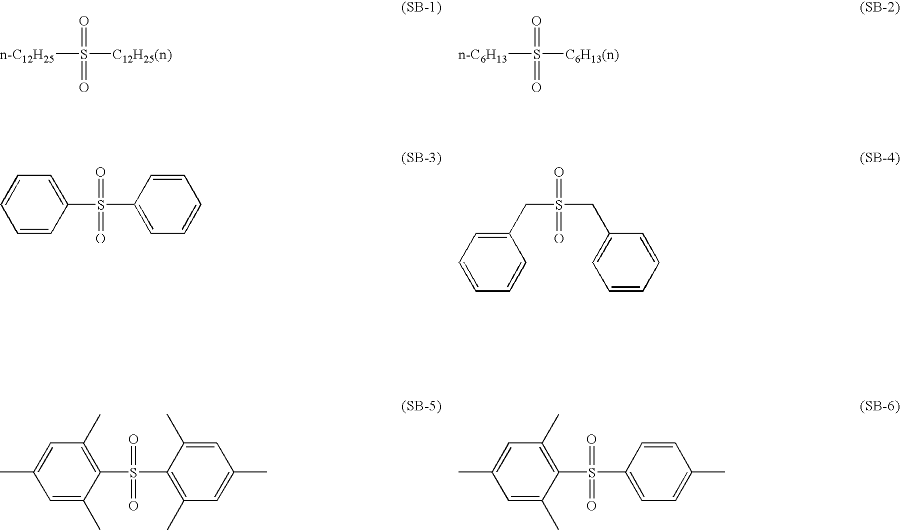

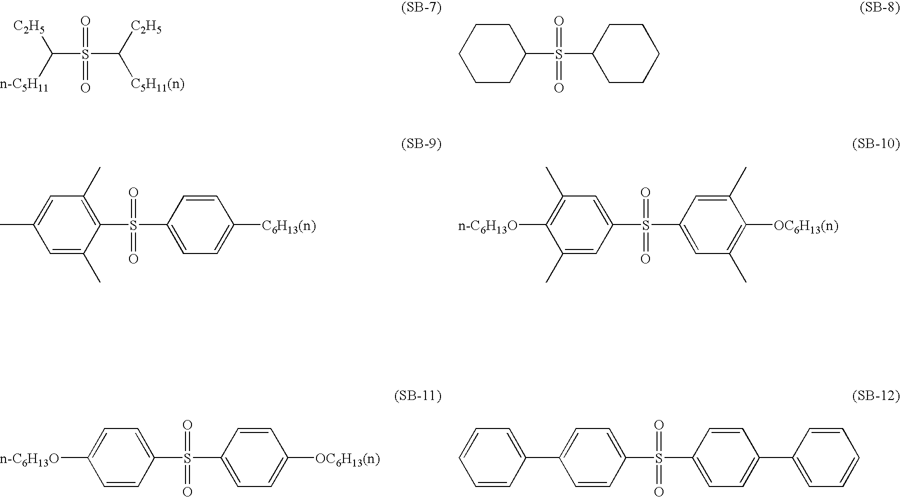

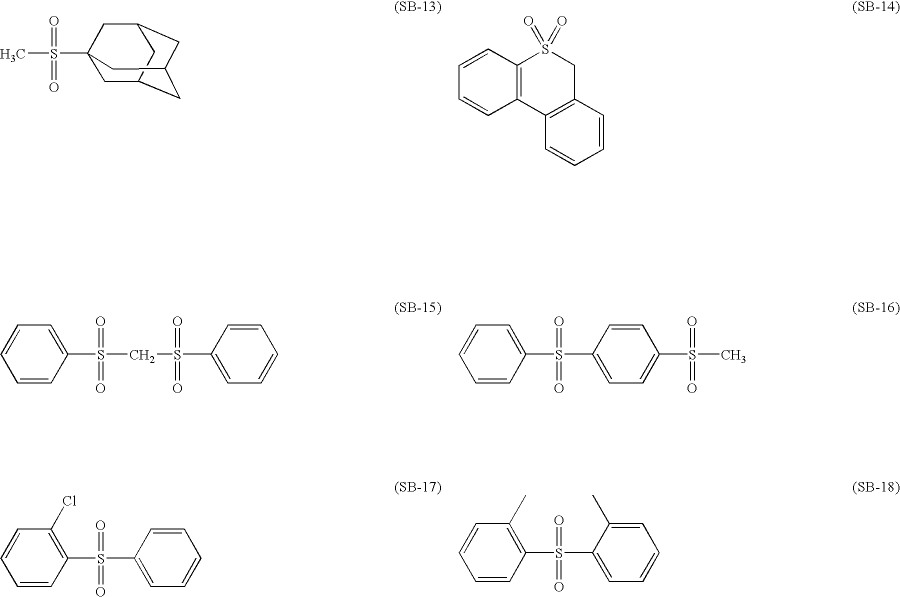

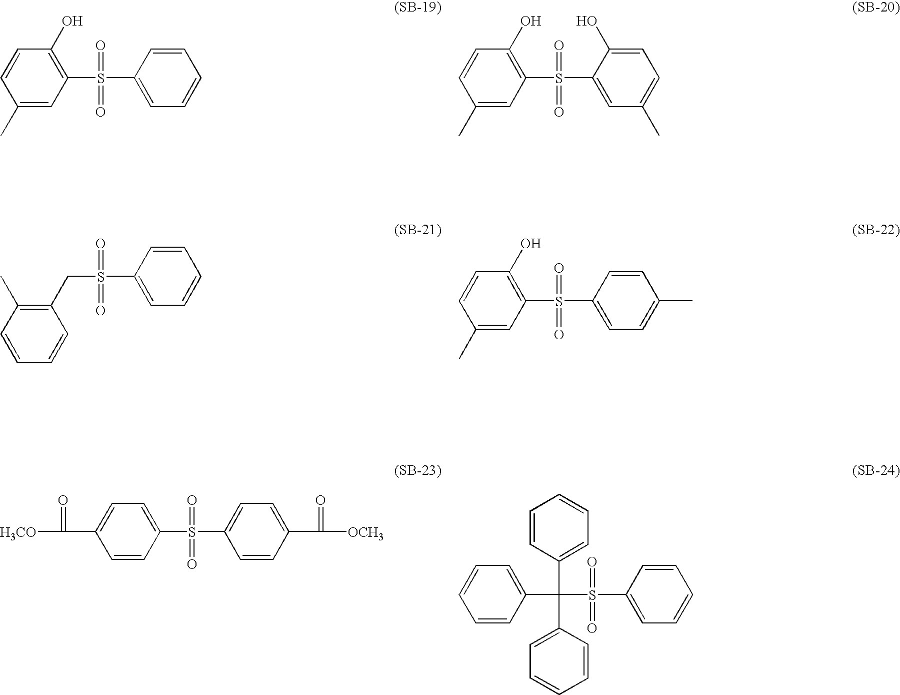

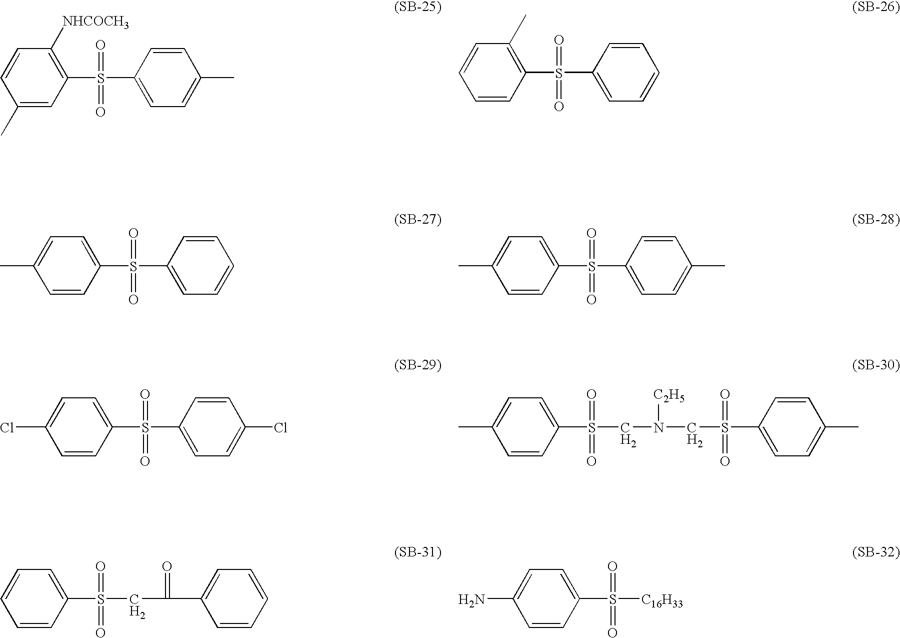

Hereinbelow, the compound represented by formula (5) of the invention will be described.

In the above formula (5), R¹ is a substituted or unsubstituted aliphatic group or a substituted or unsubstituted aromatic group, and R² is a hydrogen atom, a substituted or unsubstituted aliphatic group or a substituted or unsubstituted aromatic group. As the substituent, a substituent T described below can be mentioned (hereinafter, the same unless particularly stated). L¹ is a divalent to hexavalent linking group. The valence of L¹ is preferably 2 to 4, and more preferably 2 or 3. n is an integer of 2 to 6, more preferably 2 to 4, and particularly preferably 2 or 3 with regard to the valence of L¹.

Two or more of R¹ and R² contained in one compound may be the same as or different from each other, and preferably the same as each other.

The above compound represented by formula (5) is preferably a compound represented by formula (5a).

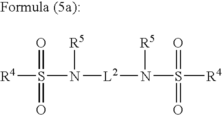

In the above formula (5a), R⁴ is a substituted or unsubstituted aliphatic group or a substituted or unsubstituted aromatic group. R⁴ is preferably a substituted or unsubstituted aromatic group, and more preferably an unsubstituted aromatic group. R⁵ is a hydrogen atom, a substituted or unsubstituted aliphatic group or a substituted or unsubstituted aromatic group. R⁵ is preferably a hydrogen atom or a substituted or unsubstituted aliphatic group, and more preferably a hydrogen atom. L² is a divalent linking group formed from at least one group selected from the group consisting of —O—, —S—, —CO—, —NR³— (wherein, R³ is a hydrogen atom, a substituted or unsubstituted aliphatic group or a substituted or unsubstituted aromatic group), an alkylene group and an arylene group. A combination of the linking group is not particularly limited, but preferably selected from —O—, —S—, —NR³— and an alkylene group, and particularly preferably selected from —O—, —S— and an alkylene group. Further, the linking group is preferably a linking group consisting of two or more selected from —O—, —S— and an alkylene group.

The substituted or unsubstituted aliphatic group may be linear, branched or cyclic, and has preferably 1 to 25 carbon atoms, more preferably 6 to 25 carbon atoms, and particularly preferably 6 to 20 carbon atoms. Specific examples of the aliphatic group include a methyl group, an ethyl group, an n-propyl group, an isopropyl group, a cyclopropyl group, an n-butyl group, an isobutyl group, a tert-butyl group, an amyl group, an isoamyl group, a tert-amyl group, an n-hexyl group, a cyclohexyl group, an n-heptyl group, an n-octyl group, a bicyclooctyl group, an adamantyl group, an n-decyl group, a tert-octyl group, a dodecyl group, a hexadecyl group, an octadecyl group, a didecyl group and the like.

The aromatic group may be an aromatic hydrocarbon group and an aromatic heterocyclic group, and more preferably an aromatic hydrocarbon group. The aromatic hydrocarbon group has preferably 6 to 24 carbon atoms, and more preferably 6 to 12 carbon atoms. Specific examples of the ring of the aromatic hydrocarbon group include benzene, naphthalene, anthracene, biphenyl, terphenyl and the like. Particularly preferably, examples of the aromatic hydrocarbon group include benzene, naphthalene and biphenyl. As the aromatic heterocyclic group, preferred is one containing at least one of an oxygen atom, a nitrogen atom or a sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene and the like. As the aromatic heterocyclic group, pyridine, triazine and quinoline are particularly preferred.

Further, the substituent T described above has the same meaning as described in formula (3).

Furthermore, the above compound represented by formula (5) is preferably a compound represented by formula (5c).

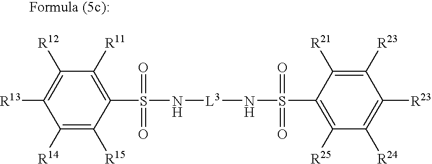

In the above formula (5c), R¹¹, R¹², R¹³, R¹⁴, R¹⁵, R²¹, R²², R²³, R²⁴ and R²⁵ are each independently a hydrogen atom or a substituent, and the above substituent T can be adopted as the substituent. R¹¹, R¹², R¹³, R¹⁴, R¹⁵, R²¹, R²², R²³, R²⁴ and R²⁵ are preferably an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, a ureido group, a phosphoric amido group, a hydroxyl group, a mercapto group, a halogen atom (e.g., a fluorine atom, a chlorine atom, a bromine atom and an iodine atom), a cyano group, a sulfo group, a carboxyl group, a nitro group, a hydroxamic acid group, a sulfino group, a hydrazino group, an imino group, a hetercyclic group (a heterocyclic group having preferably 1 to 30 carbon atoms, and more preferably 1 to 12 carbon atoms such as heterocyclic group containing heteroatoms such as a nitrogen atom, an oxygen atom, a sulfur atom, e.g., an imidazolyl group, a pyridyl group, a quinolyl group, a furyl group, a piperidine group, a morpholino group, a benzoxazolyl group, a benzimidazolyl group, a benzothiazolyl group, etc.), a silyl group, more preferably an alkyl group, an aryl group, an aryloxycarbonylamino group, an alkoxy group, an aryloxy group, and particularly preferably an alkyl group, an aryl group and an aryloxycarbonylamino group. These substituents may be further substituted with these substituents. In addition, when two or more substituents exist, they may be the same as or different from each other. Further, they may be bonded to each other to form a ring, if possible. It is preferable that R¹¹, R¹², R¹³, R¹⁴ and R¹⁵ are the same as R²¹, R²², R²⁴ and R²⁵, respectively. Moreover, it is more preferable that all of R¹¹ to R²⁵ are hydrogen atoms.

L³ is a divalent linking group formed from at least one group selected from the group consisting of —O—, —S—, —CO—, —NR³— (wherein, R³ is a hydrogen atom, an aliphatic group or an aromatic group), an alkylene group and an arylene group. A combination of the linking group is not particularly limited, but preferably selected from —O—, —S—, —NR³— and an alkylene group, and particularly preferably selected from —O—, —S— and an alkylene group.

Further, the linking group is preferably a linking group consisting of two or more selected from —O—, —S— and an alkylene group.

Preferred examples of the compounds represented by formula (5), particularly formulae (5a) and (5c), are shown below, but the invention is not limited to these specific examples.

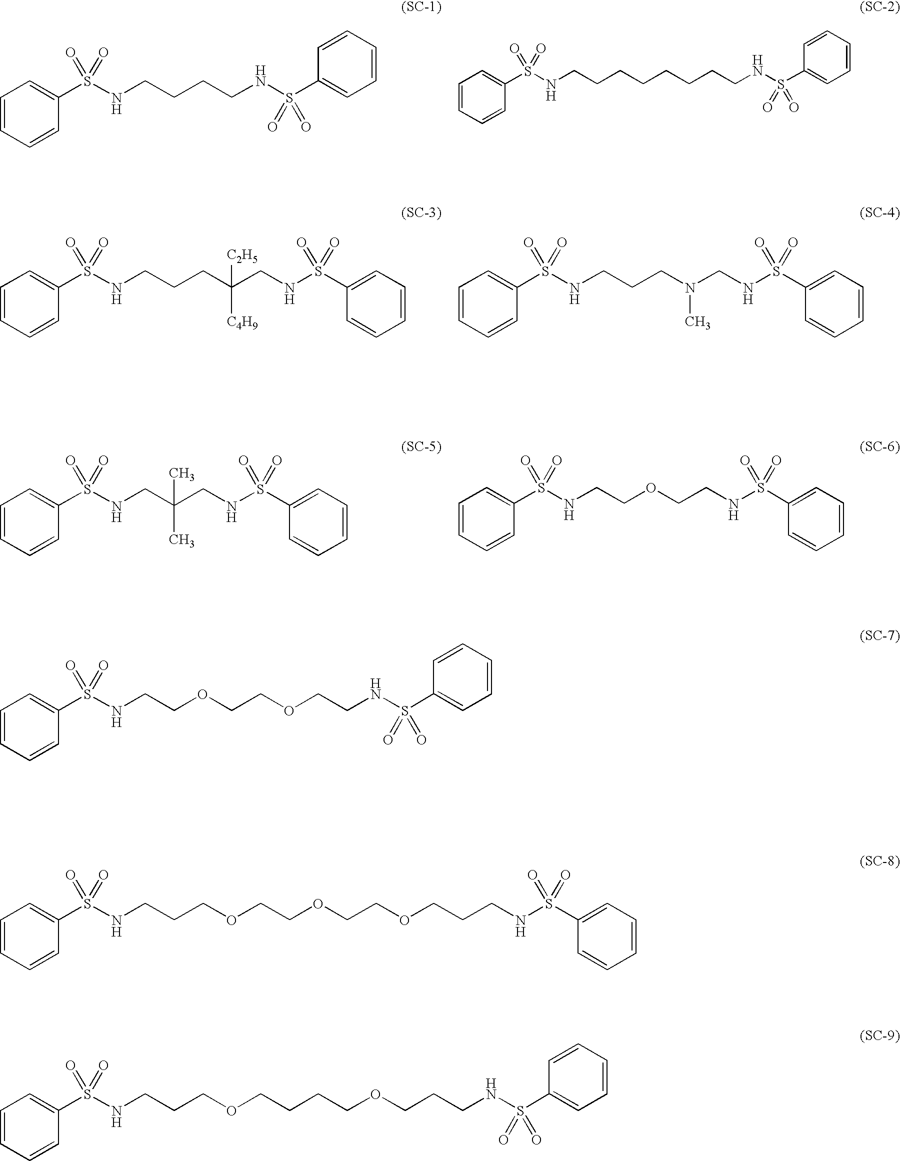

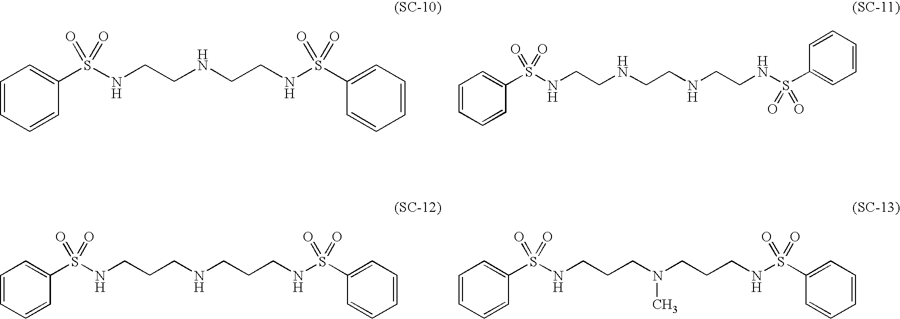

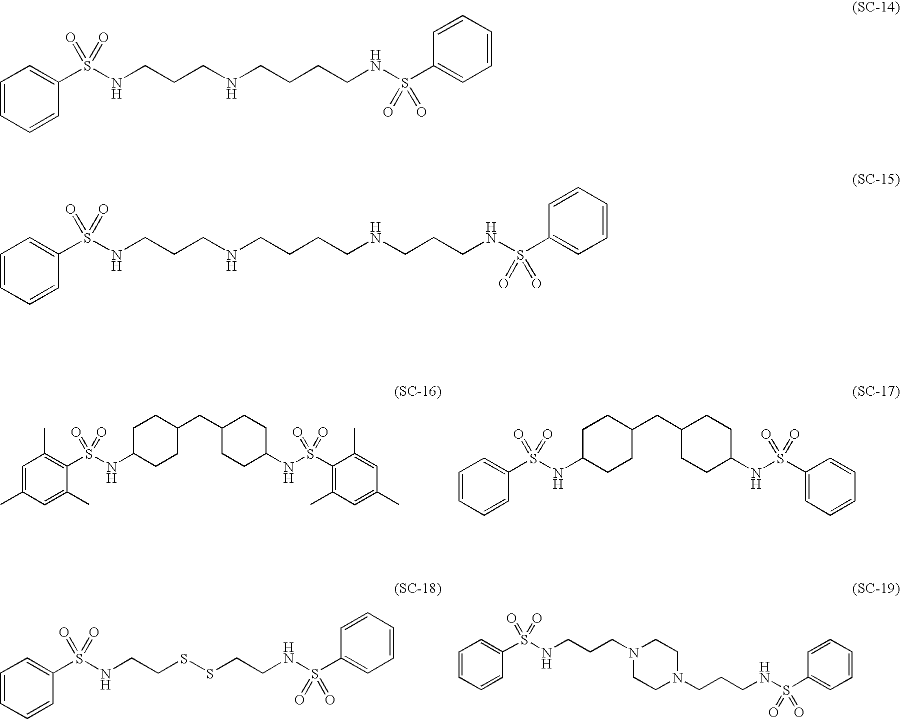

Any compound used in the invention can be prepared from a known compound. The compounds represented by formula (5), particularly formulae (5a) and (5c), are generally obtained by a condensation reaction of sulfonyl chloride and multifunctional amine.

Hereinbelow, the compound represented by formula (6a) of the invention will be described.

In the present invention, a compound represented by formula (6a) is preferably employed as a modifier for the cellulose substance.

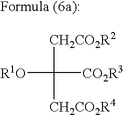

In formula (6a), R¹ represents a hydrogen atom, an aliphatic acyl group or an aromatic acyl group; and R², R³ and R⁴ each represents a hydrogen atom, an aliphatic group or an aromatic group.

In the following, the compound represented by the general formula (6a) of the present invention will be explained.

In formula (6a), R¹ represents a hydrogen atom, a substituted or non-substituted aliphatic acyl group or a substituted or non-substituted aromatic acyl group, more preferably a hydrogen atom or an aliphatic acyl group. The aliphatic acyl group may be linear, branched or cyclic. The aliphatic acyl group preferably includes 1 to 12 carbon atoms, more preferably 1 to 8 carbon atoms and most preferably 1 to 4 carbon atoms. The aromatic acyl group may be an aromatic hydrocarbon acyl group or an aromatic heterocyclic acyl group, more preferably an aromatic hydrocarbon acyl group. The aromatic hydrocarbon acyl group preferably includes 6 to 24 carbon atoms and more preferably 6 to 12 carbon atoms. A substituent that may be present in the aliphatic acyl group or the aromatic acyl group can be substituent T. R², R³ and R⁴ each represents a hydrogen atom, a substituted or non-substituted aliphatic group or a substituted or non-substituted aromatic group, more preferably an aliphatic group. The aliphatic group may be linear, branched or cyclic, more preferably branched or cyclic and particularly preferably cyclic. The aliphatic group preferably includes 5 to 24 carbon atoms, more preferably 5 to 15 carbon atoms and most preferably 5 to 12 carbon atoms. The aromatic group may be an aromatic hydrocarbon group or an aromatic heterocyclic group, more preferably an aromatiuc hydrocarbon group. The aromatic hydrocarbon group preferably includes 6 to 24 carbon atoms, and more preferably 6 to 12 carbon atoms. A substituent that may be present in the aliphatic group or the aromatic group can be substituent T, which has the same meaning as described in formula (3).

Also the compound represented by formula (6a) is preferably a compound represented by formula (6b):

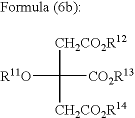

In formula (6b), R¹¹ represents a hydrogen atom or an aliphatic acyl group; and R¹², R¹³ and R¹⁴ each represents a hydrogen atom or an aliphatic group.

In formula (6b), R¹¹ represents a hydrogen atom or a substituted or non-substituted aliphatic acyl group, and preferably a hydrogen atom or a non-substituted aliphatic acyl group. The aliphatic acyl group may be linear, branched or cyclic. The aliphatic acyl group preferably includes 1 to 12 carbon atoms, more preferably 1 to 8 carbon atoms, and most preferably 1 to 4 carbon atoms. R¹², R¹³ and R¹⁴ each represents a hydrogen atom or a substituted or non-substituted aliphatic group, preferably an aliphatic group. The aliphatic group may be linear, branched or cyclic, and more preferably branched or cyclic and most preferably cyclic. The aliphatic group preferably includes 5 to 24 carbon atoms, more preferably 5 to 15 carbon atoms, and most preferably 5 to 12 carbon atoms.

Also the compound represented by formula (6a) is preferably a compound represented by formula (6c):

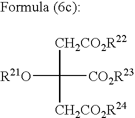

In formula (6c), R²¹ represents a hydrogen atom or an aliphatic acyl group; and R²², R²³ and R²⁴ each represents a hydrogen atom or an aliphatic group having a branched structure or a cyclic structure.

In formula (6c), R²¹ represents a hydrogen atom or a substituted or non-substituted aliphatic acyl group. The aliphatic acyl group may be linear, branched or cyclic. The aliphatic acyl group preferably includes 1 to 12 carbon atoms, more preferably 1 to 8 carbon atoms, and most preferably 1 to 4 carbon atoms. R²², R²³ and R²⁴ each represents a hydrogen atom or an aliphatic group having a branched structure or a cyclic structure. The aliphatic group preferably includes 5 to 24 carbon atoms, more preferably 5 to 15 carbon atoms, and most preferably 5 to 12 carbon atoms.

In the following, the aforementioned substituted or non-substituted aliphatic group will be explained. The aliphatic group may be linear, branched or cyclic, and preferably includes 1 to 25 carbon atoms, more preferably 6 to 25 carbon atoms and particularly preferably 6 to 20 carbon atoms. Specific examples of the aliphatic group include a methyl group, an ethyl group, an n-propyl group, an isopropyl group, a cyclopropyl group, an n-butyl group, an isobutyl group, a tert-butyl group, an amyl group, an isoamyl group, a tert-amyl group, an n-hexyl group, a cyclohexyl group, an n-heptyl group, an n-octyl group, a bicyclooctyl group, an adamantyl group, an n-decyl group, a tert-octyl group, a dodecyl group, a hexadecyl group, an octadecyl group and a didecyl group.

In the following, the aforementioned aromatic group will be explained. The aromatic group may be an aromatic hydrocarbon group or an aromatic heterocyclic group, and preferably an aromatic hydrocarbon group. The aromatic hydrocarbon group preferably includes 6 to 24 carbon atoms, more preferably 6 to 12 carbon atoms. Specific examples of the ring structure of the aromatic hydrocarbon group include benzene, naphthalene, anthracene, biphenyl and terphenyl. As the aromatic hydrocarbon group, benzene, naphthalene or biphenyl is particularly preferred. The aromatic heterocyclic group preferably contains at least one of an oxygen atom, a nitrogen atom and a sulfur atom. Specific examples of the heterocycle include furan, pyrrole, thiophene, imidazole, pyrazol, pyridine, pyrazine, pyridazine, triazole, triazine, indole, indazole, purin, thiazoline, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole, and tetrazaindene. The aromatic heterocyclic group is particularly preferably pyridine, triazine or quinoline.

An amount of addition of the compound represented by at least one of the general formulas (6a) to (6c) is preferably 1 to 30 wt % with respect to the cellulose substance, more preferably 2 to 30 wt %, further preferably 2 to 25 wt % and most preferably 2 to 20 wt %.

Preferred examples of the compound represented by the general formula (6a) are shown in the following, but the present invention is not limited to such examples.

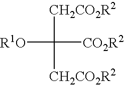

| No. | R¹ | R² |
|---|---|---|
| TA-1 | H | 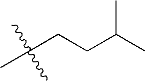 |
| TA-2 | H | 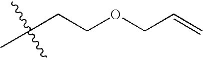 |
| TA-3 | H | 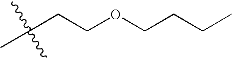 |
| TA-4 | H | 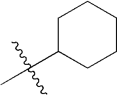 |
| TA-5 | H | 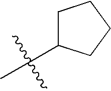 |
| TA-6 | H | 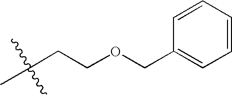 |
| TA-7 | H | 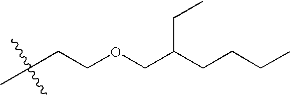 |
| TA-8 | H | 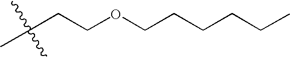 |
| TA-9 | H | 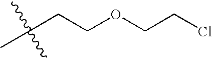 |
| TA-10 | H | 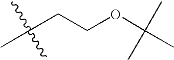 |
| TA-11 | H | 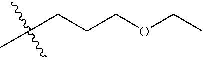 |
| TA-12 | H | 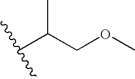 |
| TA-13 | H | 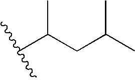 |
| TA-14 | H | 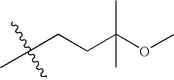 |
| TA-15 | H | 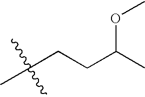 |
| TA-16 | H | 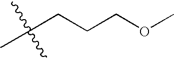 |
| TA-17 | H | 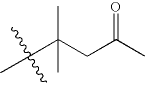 |
| TA-18 | H | 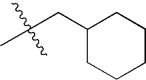 |
| TA-19 | H | 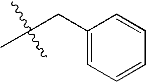 |
| TA-20 | H | 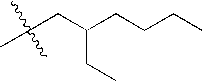 |
| TB-1 | Ac | 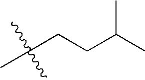 |
| TB-2 | Ac | 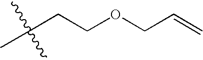 |
| TB-3 | Ac | 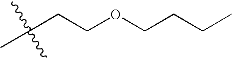 |
| TB-4 | Ac | 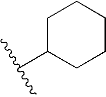 |
| TB-5 | Ac | 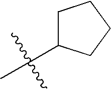 |
| TB-6 | Ac | 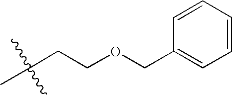 |
| TB-7 | Ac | 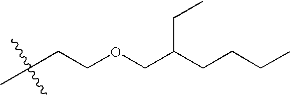 |
| TB-8 | Ac | 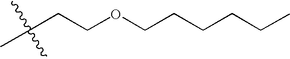 |
| TB-9 | Ac | 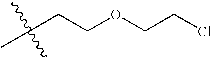 |
| TB-10 | Ac | 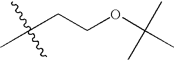 |
| TB-11 | Ac | 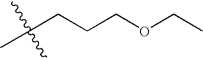 |
| TB-12 | Ac | 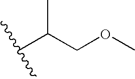 |
| TB-13 | Ac | 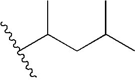 |
| TB-14 | Ac | 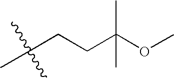 |
| TB-15 | Ac | 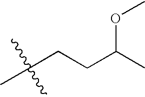 |
| TB-16 | Ac | 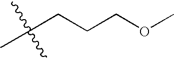 |
| TB-17 | Ac | 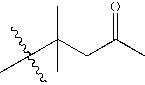 |
| TB-18 | Ac | 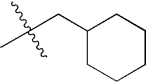 |
| TB-19 | Ac | 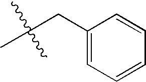 |
| TB-20 | Ac | 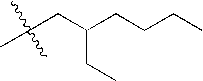 |

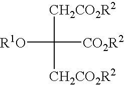

| No. | R¹ | R² (mol/mol) | |
|---|---|---|---|
| TC-1 | H | 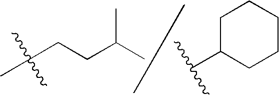 | (1/2) |
| TC-2 | H | 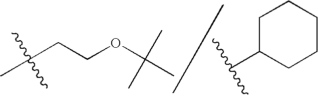 | (1/2) |
| TC-3 | H | 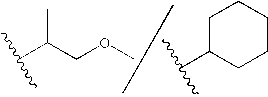 | (1/2) |
| TC-4 | H | 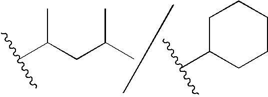 | (1/2) |
| TC-5 | H | 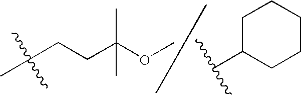 | (1/2) |
| TC-6 | H | 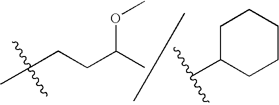 | (1/2) |
| TC-7 | H | 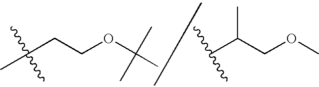 | (1/2) |
| TC-8 | H | 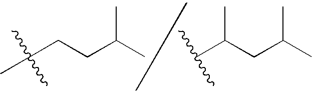 | (1/2) |
| TC-9 | H | 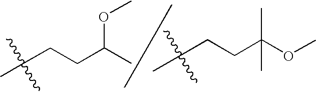 | (1/2) |
| TC-10 | H | 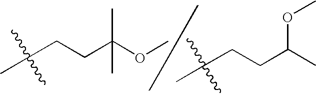 | (1/2) |
| TD-1 | Ac | 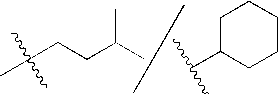 | (1/2) |
| TD-2 | Ac | 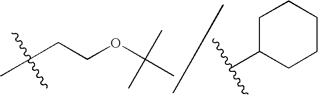 | (1/2) |
| TD-3 | Ac | 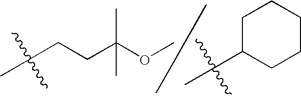 | (1/2) |
| TD-4 | Ac | 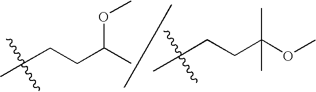 | (1/2) |
| TD-5 | Ac | 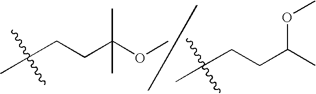 | (1/2) |

Any of the compounds to be employed in the present invention can be produced from a known compound. The compound represented by at least one of the general formulas (6a)-(6c) can be obtained, for example, by a condensation reaction of citric acid, an alcohol and a carboxylic acid.

In the compounds of formulae (1) to (6a), the compound having an octanol-water partition coefficient (log P value) of 0 to 10 is preferred. The compound having log P value of more than 10 has insufficient compatibility with cellulose acylate, thus it is easy to generate clouding or dusting of the film. Further, since the compound having log P values of less than 0 has a high hydrophilic property, there is the case that water resistance of the cellulose acetate film is deteriorated. Log P value is more preferably in the range of 1 to 7, and particularly preferably in the range of 1.5 to 5.

Measurement of the octanol-water partition coefficient (log P value) can be carried out by a Shake flask method described in JIS (Japanese Industrial Standards) Z7260-107 (2000) as described above. Furthermore, the octanol-water partition coefficient (log P value) is on behalf of actual measurement, and estimation can also be carried out by a computational chemistry method or an experimental method. As the computation method, the method described in the literature is preferably used, but a Crippen's fragmentation method (J. Chem. Inf. Comput. Sci., Vol. 27, p. 21 (1987)) is more preferably used. When log P value of some compounds varies according to the measurement method or the computation method, estimation by the Crippen's fragmentation method is preferred.

The compounds of formulae (1) to (5) have a molecular weight of preferably 150 or more and 3000 or less, preferably 170 or more and 2000 or less, and particularly preferably 200 or more and 1000 or less. When the molecular weight is in these ranges, the compounds may have a specific monomer structure, an oligomer structure in which plural monomer units are bonded together, or a polymer structure.

The compounds of formulae (1) to (5) are preferably liquid at 25° C. or solids having the melting point of 25 to 250° C., and more preferably liquid at 25° C. or solids having the melting point of 25 to 200° C. Further, the compounds, which reduce retardation, are preferably not sublimated in the process of dope casting and drying for preparation of the cellulose acylate film.

An amount of the compounds of formulae (1) to (5) to be added is preferably 0.01 to 30% by weight, more preferably 1 to 25% by weight, and particularly preferably 5 to 20% by weight of cellulose acrylate. Further, more specifically amounts of each compound of formulae (1) to (5) to be added are the same as those as described in each Formula.

The compounds of formulae (1) to (5) may be used alone or in a mixture of two or more kinds thereof in an arbitrary ratio.

The timing of the compounds of formulae (1) to (5) addition may be during the dope preparation process, or after the completion of the dope preparation process.

In the compounds of formulae (1) to (5), the average content of the compound in a part of at least from one side of the surface to 10% of the total film thickness is 80 to 99% of an average content of the compound in the central part of the cellulose acylate film. An amount of the compound of the invention to be existed can be determined by measuring the amount of the compound of the surface or the central portion, e.g., according to a method using infrared absorption spectrum described in JP-A No. 8-57879.

(Other Additives)

To the cellulose acylate film of the invention, various additives (for example, a wavelength dispersion controlling agent, fine particles, a plasticizer, an ultraviolet blocking agent, a deterioration preventing agent, a peeling agent, an optical characteristic controlling agent or the like) can be added, in addition to the compound for reducing the optical anisotropy. Moreover, the timing of these additives addition may be any time during the dope preparation process (the process for preparing a cellulose acrylate solution), or after the completion of the dope preparation process to carry out the process for preparation by adding the additives.

(Wavelength Dispersion Controlling Agent)

A compound reducing wavelength dispersion of the cellulose acylate film (hereinafter, referred to as wavelength dispersion controlling agent) will be described. In order to reduce wavelength dispersion of Rth of the cellulose acylate film of the invention, it is preferable to contain at least one kind of the compound for reducing wavelength dispersion of Rth represented by the following conditional expression (iii) ΔRth=|Rth(400)−Rth(700)| in the range satisfying the following conditional expressions (iv) and (v).
ΔRth=|Rth(400)−Rth(700)| (iii)
(ΔRth(B)−ΔRth(0))/B≦−2.0 (iv)
0.01≦B≦30 (iv)
wherein, ΔRth(B) is ΔRth(nm) of the film containing B % of the compound reducing wavelength dispersion of Rth, ΔRth(0) is ΔRth(nm) of the film without containing the compound reducing wavelength dispersion of Rth, and B is a weight (%) of the compound when a weight of cellulose acrylate is 100.

The condtional expressions (iv) and (v) are preferably represented as follows:
(ΔRth(B)−ΔRth(0))/B≦−3.0 (vi)
0.05≦B≦25, (vii)
further, the condtional expressions (viii) and (ix) are preferably represented as follows:
(ΔRth(B)−ΔRth(0))/B≦−4.0 (viii)
0.1≦B≦20 (ix)

By having the optical characteristics of the film in the above ranges, Re(λ) and Rth(λ) at the wavelength of 400 nm to 700 nm can be in the desired range.

The wavelength dispersion controlling agent absorbs at an UV region of 200 to 400 nm, a compound reducing both of |Re(400)−Re(700)| and |Rth(400)−Rth(700)| of the film is preferred, and 0.01 to 30% by weight with respect to a cellulose acylate solid content may be used.

Retardation of the cellulose acylate film, particularly Rth, generally has larger wavelength dispersion characteristics on the long wavelength side than the short wavelength side in the visible region (400 nm to 700 nm). Therefore, it is possible to adjust wavelength dispersion of Rth of the cellulose acylate film by absorbing at a UV region of 200 to 400 nm and using one assumed that Re and Rth of the compound itself having large wavelength dispersion on the short wavelength side in the visible region. For this, it is required that a compound adjusting wavelength dispersion is sufficiently uniformly compatible with cellulose acrylate. The range of the absorption band of the UV region of these compounds is preferably 200 to 400 nm, more preferably 220 to 395 nm, and even more preferably 240 to 390 nm.

In addition, an optical member used in the liquid crystal display is required to have excellent transmittance, so that spectral transmittance is excellent in the visible region. In the case where the cellulose acylate film of the invention contains the wavelength dispersion controlling agent, spectral transmittance is 45% or more and 95% or less at the wavelength of 380 nm, and spectral transmittance is 10% or less at the wavelength of 350 nm.

The above wavelength dispersion controlling agent, which is preferably used in the invention, has preferably a molecular weight of 250 to 1000 from the viewpoint of sublimability. The molecular weight is more preferably 260 to 800, even more preferably 270 to 800, and particularly preferably 300 to 800. When the molecular weight is in this range, the compounds may have a specific monomer structure, an oligomer structure in which plural monomer units are bonded together, and a polymer structure.

In the viewpoint of handlability and solubility in the dope, these compounds are preferably liquid at 25° C. or solids having the melting point of 25 to 250° C., and more preferably liquid at 25° C. or solids having the melting point of 25 to 200° C. Further, the compounds, which reduce retardation, are preferably not sublimated in dope casting and drying for the preparation of the cellulose acylate film.

(Amount of Compound to be Added)

An amount of the wavelength dispersion controlling agent to be added, which is preferably used in the invention, is preferably 0.01 to 30% by weight, more preferably 0.1 to 20% by weight, and particularly preferably 0.2 to 10% by weight.

(Compound Addition Method)

Further, the wavelength dispersion controlling agent may be used alone or in combination of 2 or more compounds in an arbitrary ratio.

Also, the timing of the wavelength dispersion controlling agent addition may be any time during the dope preparation process or after the completion of the dope preparation process.

Specific examples of the wavelength dispersion controlling agent preferably used in the invention include benzotriazole compounds, benzophenone compounds, cyano group-containing compounds, oxybenzophenone compounds, salicylic acid ester compounds, nickel complex salt compounds and the like, but the invention is not limited to only these compounds. Among these, the compounds represented by the following formulae (101) to (103) are preferred, the compounds represented by the following formula (101) or formula (102) are more preferred and the compound represented by the following formula (101) is even more preferred.
Q¹-Q²-OH Formula (101)
wherein, Q¹ is a nitrogen-containing aromatic heterocyclic ring group and Q² is an aromatic ring group.

Q¹ is a nitrogen-containing aromatic heterocyclic ring group, preferably a 5- to 7-membered nitrogen-containing aromatic heterocyclic ring group and more preferably a 5- to 6-membered nitrogen-containing aromatic heterocyclic ring group, and examples thereof include imidazole, pyrazole, triazole, tetrazole, thiazole, oxazole, selenazole, benzotriazole, benzothiazole, benzoxazole, benzoselenazole, thiadiazole, oxadiazole, naphthothiazole, naphthoxazole, azabenzimidazole, purine, pyridine, pyrazine, pyrimidine, pyridazine, triazine, triazaindene, tetrazaindene and the like; even more preferably, a 5-membered nitrogen-containing aromatic heterocyclic ring group or a triazine ring, and specific examples thereof include imidazole, pyrazole, triazole, tetrazole, thiazole, oxazole, benzotriazole, benzothiazole, benzoxazole, thiadiazole, oxadiazole, 1,3,5-triazine and the like; and particularly preferably a benzotriazole ring or a 1,3,5-triazine ring.

A nitrogen-containing aromatic heterocyclic ring represented by Q¹ may further have a substituent, and the substituent may be exemplified by the following substituent T. Moreover, in the case of having a plurality of substituents, each substituent may be fused to further form a ring.

The aromatic ring represented by Q² may be an aromatic hydrocarbon ring or an aromatic heterocyclic ring. Also, the aromatic rings may be monocyclic or may form a fused ring with other rings.

The aromatic hydrocarbon ring is preferably a monocyclic or bicyclic aromatic hydrocarbon ring having 6 to 30 carbon atoms (e.g., a benzene ring, a naphthalene ring, etc.), more preferably an aromatic hydrocarbon ring having 6 to 20 carbon atoms, and even more preferably an aromatic hydrocarbon ring having 6 to 12 carbon atoms. Particularly preferred is a benzene ring.

The aromatic heterocyclic ring is preferably an aromatic heterocyclic ring containing a nitrogen atom or a sulfur atom. Specific examples of the heterocyclic ring include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene and the like. Preferable examples of the aromatic heterocyclic ring include a pyridine ring, a triazine ring, and a quinoline ring.

The aromatic ring represented by Q² is preferably an aromatic hydrocarbon ring group, more preferably a naphthalene ring group or a benzene ring group, and particularly preferably a benzene ring group. Q² may further have a substituent, and substituent T is preferably used. The substituent T has the same meaning as described in formula (3).

The compound represented by formula (101) is preferably a compound represented by the following formula (101-A): 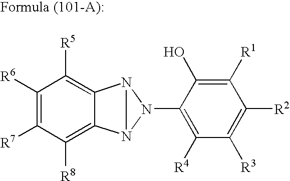
wherein R¹, R², R³, R⁴, R⁵, R⁶, R⁷ and R⁸ are each independently a hydrogen atom or a substituent

R¹, R², R³, R⁴, R⁵, R⁶, R⁷ and R⁸ are each independently a hydrogen atom or a substituent, and the substituent may be exemplified by the above-described substituent T. These substituents may be further substituted with other substituents, and the substituents may be fused to each other to form a ring structure.

R¹ and R³ are preferably a hydrogen atom, an alkyl group, an alkenyl group, an alkynyl group, an aryl group, a substituted or unsubstituted amino group, an alkoxy group, an aryloxy group, a hydroxyl group, and a halogen atom; more preferably a hydrogen atom, an alkyl group, an aryl group, an alkyloxy group, an aryloxy group, and a halogen atom; even more preferably a hydrogen atom, an alkyl group having 1 to 12 carbon atoms; and particularly preferably an alkyl group having 1 to 12 carbon atoms (preferably having 4 to 12 carbon atoms).

R² and R⁴ are preferably a hydrogen atom, an alkyl group, an alkenyl group, an alkynyl group, an aryl group, a substituted or unsubstituted amino group, an alkoxy group, an aryloxy group, a hydroxyl group, and a halogen atom; more preferably a hydrogen atom, an alkyl group, an aryl group, an alkyloxy group, an aryloxy group, and a halogen atom; even more preferably a hydrogen atom, an alkyl group having 1 to 12 carbon atoms; particularly preferably a hydrogen atom or a methyl group; and most preferably a hydrogen atom.

R⁵ and R⁸ are preferably a hydrogen atom, an alkyl group, an alkenyl group, an alkynyl group, an aryl group, a substituted or unsubstituted amino group, an alkoxy group, an aryloxy group, a hydroxyl group, and a halogen atom; more preferably a hydrogen atom, an alkyl group, an aryl group, an alkyloxy group, an aryloxy group, and a halogen atom; even more preferably a hydrogen atom, an alkyl group having 1 to 12 carbon atoms; particularly preferably a hydrogen atom or a methyl group; and most preferably a hydrogen atom.

R⁶ and R⁷ are preferably a hydrogen atom, an alkyl group, an alkenyl group, an alkynyl group, an aryl group, a substituted or unsubstituted amino group, an alkoxy group, an aryloxy group, a hydroxyl group, and a halogen atom; more preferably a hydrogen atom, an alkyl group, an aryl group, an alkyloxy group, an aryloxy group, and a halogen atom; even more preferably a hydrogen atom or a halogen atom; and particularly preferably a hydrogen atom or a chlorine atom.

The compound represented by formula (101) is preferably a compound represented by the following formula (101-B): 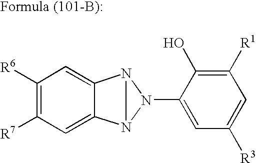
wherein R¹, R³, R⁶ and R⁷ have the same as meaning as those in formula (101-A), and their preferable ranges are the same as those in formula (101-A).

The compound other than the compound represented by formula (101) is preferably a compound represented by the following formula (U-11):
Q¹-Q²-OH Formula (U-11)
wherein, Q¹ is a 1,3,5-triazine ring and Q² is an aromatic ring.

In the formula (U-11), Q¹ is a 1,3,5-triazine ring and may further have a substituent, and the substituent may be exemplified by the above-described substituent T of formula (101). Also, in the case of having a plurality of substituents, each substituent may be fused to further form a ring. The aromatic ring represented by Q² has the same meaning as in formula (101).

The compound represented by formula (101) is preferably a compound represented by the following formula (I):

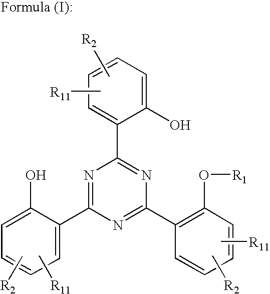

Preferably in the formula (1), R₁ is any one of the following (a), (b) and (c). Specifically, R₁ is: (a) an alkyl group having 1 to 18 carbon atoms; a cycloalkyl group having 5 to 12 carbon atoms; an alkenyl group having 3 to 18 carbon atoms; a phenyl group; an alkyl group having 1 to 18 carbon atoms substituted with a phenyl group, OH, an alkoxy group having 1 to 18 carbon atoms, a cycloalkoxy group having 5 to 12 carbon atoms, an alkenyloxy group having 3 to 18 carbon atoms, a halogen atom, —COOH, —COOR₄, —O—CO—R₅, —O—CO—O—R₆, —CO—NH₂, —CO—NHR₇, —CO—N(R₇)(R₈), CN, NH₂, NHR₇, —N(R₇)(R₈), —NH—CO—R₅, a phenoxy group, a phenoxy group substituted with an alkyl group having 1 to 18 carbon atoms, a phenyl-alkoxy group having 1 to 4 carbon atoms, a bicycloalkoxy group having 6 to 15 carbon atoms, a bicycloalkylalkoxy group having 6 to 15 carbon atoms, a bicycloalkenylalkoxy group having 6 to 15 carbon atoms or a tricycloalkoxy group having 6 to 15 carbon atoms; a cycloalkyl group having 5 to 12 carbon atoms substituted with OH, an alkyl group having 1 to 4 carbon atoms, an alkenyl group having 2 to 6 carbon atoms or —O—CO—R₅; a glycidyl group; —CO—R₉ or —SO₂—R₁₀, (b) an alkyl group having 3 to 50 carbon atoms interrupted by one or more oxygen atoms and/or substituted with OH, a phenoxy group or an alkylphenoxy group having 7 to 18 carbon atoms, or (c) -A; —CH₂—CH(XA)-CH₂—O—R₁₂; —CR₁₃R′₁₃—(CH₂)ₘ—X-A; —CH₂—CH(OA)-R₁₄; —CH₂—CH(OH)—CH₂—XA;

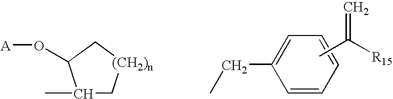

—CR₁₅R═₁₅—C(═CH₂)—R″₁₅; —CR₁₃R′₁₃—(CH₂)ₘ—X-A; —CR₁₃R′₁₃—(CH₂)ₘ—CO—O—CR₁₅R′₁₅—C(═CH₂)—R″₁₅ or —CO—O—CR₁₅R′₁₅—C(═CH₂)—R″₁₅ (wherein, A is —CO—CR₁₆═CH—R₁₇).

R₂'s are each independently an alkyl group having 6 to 18 carbon atoms; an alkenyl group having 2 to 6 carbon atoms; a phenyl group; a phenylalkyl group having 7 to 11 carbon atoms; COOR₄; CN; —NH—CO—R₅; a halogen atom; a trifluoromethyl group; and —O—R₃.

R₃ has the same meaning as R₁. R₄ is an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or an alkyl group having 3 to 50 carbon atoms interrupted by one or more of —O—, —NH—, —NR₇— and —S—, and which may be substituted with OH, phenoxy group or an alkylphenoxy group having 7 to 18 carbon atoms.

R₅ is H; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a bicycloalkyl group having 6 to 15 carbon atoms; a bicycloalkenyl group having 6 to 15 carbon atoms; or a tricycloalkyl group having 6 to 15 carbon atoms.

R₆ is H; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R₇ and R₈ are each independently an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms. Otherwise, R₇ and R₈ are together an alkylene group having 3 to 9 carbon atoms; an oxa-alkylene group having 3 to 9 carbon atoms or an aza-alkylene group having 3 to 9 carbon atoms.

R₉ is an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a bicycloalkyl group having 6 to 15 carbon atoms; a bicycloalkylalkyl group having 6 to 15 carbon atoms; a bicycloalkenyl group having 6 to 15 carbon atoms; or a tricycloalkyl group having 6 to 15 carbon atoms.

R₁₀ is an alkyl group having 1 to 12 carbon atoms; a phenyl group; a naphthyl group; or an alkylphenyl group having 7 to 14 carbon atoms.

R₁₁'s are each independently H; an alkyl group having 1 to 18 carbon atoms; an alkenyl group having 3 to 6 carbon atoms; a phenyl group; a phenylalkyl group having 7 to 11 carbon atoms; a halogen atom; or an alkoxy group having 1 to 18 carbon atoms.

R₁₂ is an alkyl group having 1 to 18 carbon atoms; an alkenyl group having 3 to 18 carbon atoms; a phenyl group; a phenyl group substituted with 1 to 3 substituents of an alkyl group having 1 to 8 carbon atoms, an alkoxy group having 1 to 8 carbon atoms, an alkenoxy group having 3 to 8 carbon atoms, a halogen atom or a trifluoromethyl group; a phenylalkyl group having 7 to 11 carbon atoms; a cycloalkyl group having 5 to 12 carbon atoms; a tricycloalkyl group having 6 to 15 carbon atoms; a bicycloalkyl group having 6 to 15 carbon atoms; a bicycloalkylalkyl group having 6 to 15 carbon atoms; a bicycloalkenylalkyl group having 6 to 15 carbon atoms; or —CO—R₅. Otherwise, R₁₂ is an alkyl group having 3 to 50 carbon atoms interrupted by one or more of —O—, —NH—, —NR₇— or —S—, and which may be substituted with OH, a phenoxy group or an alkylphenoxy group having 7 to 18 carbon atoms.

R₁₃ and R′₁₃ are each independently H; an alkyl group having 1 to 18 carbon atoms; or a phenyl group.

R₁₄ is an alkyl group having 1 to 18 carbon atoms; an alkoxyalkyl group having 3 to 12 carbon atoms; a phenyl group; or a phenyl-alkyl group having 1 to 4 carbon atoms.

R₁₅, R′₁₅ and R″₁₅ are each independently H or CH₃, R₁₆ is H; —CH₂—COO—R₄; an alkyl group having 1 to 4 carbon atoms; or CN, and R₁₇ is H; —COOR₄; an alkyl group having 1 to 17 carbon atoms; or a phenyl group.

X is —NH—; —NR₇—; —O—; —NH—(CH₂)ₚ—NH—; or —O—(CH₂)_{q}—NH—; and the index numbers m is a number among 0 to 19; n is a number among 1 to 8; p is a number among 0 to 4; and q is a number among 2 to 4; provided in formula (I) that, at least one or 2 or more of R₁, R₂ and R₁₁ contains a carbon atom.

The compound of formula (I) will be further described.

The groups R₁ to R₁₀, R₁₂ to R₁₄, R₁₆ and R₁₇ as alkyl groups are branched or a branched alkyl groups, and examples thereof include a methyl group, an ethyl group, a propyl group, an isopropyl group, an n-butyl group, a secondary butyl group, an isobutyl group, a tertiary butyl group, a 2-ethylbutyl group, an n-pentyl group, an isopentyl group, a 1-methylpentyl group, a 1,3-dimethylbutyl group, an n-hexyl group, a 1-methylhexyl group, an n-heptyl group, an isoheptyl group, a 1,1,3,3-tetramethylbutyl group, a 1-methylheptyl group, a 3-methylheptyl group, an n-octyl group, a 2-ethylhexyl group, a 1,1,3-trimethylhexyl group, a 1,1,3,3-tetramethylpentyl group, a nonyl group, a decyl group, a undecyl group, a 1-methylundecyl group, a dodecyl group, a 1,1,3,3,5,5-hexamethylhexyl group, a tridecyl group, a tetradecyl group, a pentadecyl group, a hexadecyl group, a heptadecyl group or an octadecyl group.

Examples of R₁, R₃ to R₉ and R₁₂ as cycloalkyl groups having 5 to 12 carbon atoms include a cyclopentyl group, a cyclohexyl group, a cycloheptyl group, a cyclooctyl group, a cyclononyl group, a cyclodecyl group, a cycloundecyl group and a cyclododecyl group. The preferred are a cyclopentyl group, a cyclohexyl group, a cyclooctyl group and a cyclododecyl group.

Examples of R₆, R₉, R₁₁ and R₁₂ as alkenyl groups particularly include an allyl group, an isopropenyl group, a 2-butenyl group, a 3-butenyl group, an isobutenyl group, an n-hepta-2,4-diethyl group, a 3-methyl-but-2-enyl group, an n-oct-2-enyl group, an n-dodec-2-enyl group, an iso-dodecenyl group and an n-octadec-4-enyl group.

The substituted alkyl group, cycloalkyl group or phenyl group can be substituted with one or more substituents, and a substituent can be substituted at the carbon atom bonded with a substituent (at the α-position) or at other carbon atoms. When a substituent is bonded via a hetero atom (e.g., an alkoxy group), it is preferable that the substituent is not bonded at the α-position, and that the substituted alkyl group contains two carbon atoms, particularly, 3 or more carbon atoms. Two or more substituents are preferably bonded with different carbon atoms.

Further, the alkyl group interrupted by —O—, —NH—, —NR₇— or —S— may be interrupted by one or more of these groups. In each case, one group, in general, is inserted between one bond, and a hetero-hetero bond such as O—O, S—S or NH—NH is not occurred. When the interrupted alkyl group is further substituted, the substituent, in general, is not located at the α-position with respect to the hetero atom. When two or more of the interrupting groups such as —O—, —NH—, —NR₇— and —S— types are occurred within one group, these, in general, are the same.

An aryl group, in general, is an aromatic hydrocarbon group, for example, a phenyl group, a biphenylyl group or a naphthyl group, and preferably a phenyl group and a biphenylyl group. Aralkyl, in general, is an aryl group, and particularly an alkyl group substituted with a phenyl group; therefore, examples of aralkyl having 7 to 20 carbon atoms include a benzyl group, an α-methylbenzyl group, a phenylethyl group, a phenylpropyl group, a phenylbutyl group, a phenylpentyl group and a phenylhexyl group. Further, a phenylalkyl group having 7 to 11 carbon atoms is preferably a benzyl group, an α-methylbenzyl group, and an α,α-dimethylbenzyl group.

An alkylphenyl group or an alkylphenoxy group is a phenyl group or a phenoxy group substituted with an alkyl group, respectively.

Halogen atoms to be a halogen substituent are preferably a fluorine atom, a chlorine atom, a bromine atom or an iodine atom, more preferably a fluorine atom or chlorine atom, and particularly preferably a chlorine atom.

Examples of an alkylene group having 1 to 20 carbon atoms include a methylene group, an ethylene group, a propylene group, a butylenes group, a pentylene group, a hexylene group and the like. Herein, the alkyl chain can be also a branched chain, thus examples include an isopropylene group.

Examples of a cycloalkenyl group having 4 to 12 carbon atoms include a 2-cyclobuten-2-yl group, a 2-cyclopenten-1-yl group, a 2,4-cyclopentadien-1-yl group, a 2-cyclohecen-1-yl group, a 2-cyclohepten-1-yl group and 2-cycloocten-1-yl group.

Examples of a bicycloalkyl group having 6 to 15 carbon atoms include a bornyl group, a norbornyl group and [2.2.2]bicyclooctyl group, preferably a bornyl group and a norbornyl group, and particularly preferably a bornyl group and a norborn-2-yl group.

Examples of a bicycloalkoxy group having 6 to 15 carbon atoms include a bornyloxy group and a norborn-2-yloxy group.

A bicycloalkyl group having 6 to 15 carbon atoms-alkyl group or -alkoxy group is an alkyl group or alkoxy group substituted with a bicycloalkyl group, which has the total number of carbon atoms of 6 to 15; and, specific examples thereof include a norbornane-2-methyl group and a norbornyl-2-methoxy group.

Examples of a bicycloalkenyl group having 6 to 15 carbon atoms include a norbornenyl group and a norbornadienyl group, preferably a notbornenyl group, and particularly preferably a norborn-5-ene group.

A bicycloalkenylalkoxy group having 6 to 15 carbon atoms is an alkoxy group substituted with a bicycloalkenyl group, which has the total number of carbon atoms of 6 to 15; and examples thereof include a norborn-5-ene-2-methoxy group.

Examples of a tricycloalkyl group having 6 to 15 carbon atoms include a 1-adamantyl group and a 2-adamantyl group, and preferably a 1-adamantyl group.

Examples of a tricycloalkoxy group having 6 to 15 carbon atoms include an adamantyloxy group. A heteroaryl group having 3 to 12 carbon atoms is preferably a pyridyl group, a pyrimidinyl group, a triazinyl group, a pyrrolyl group, a furanyl group, a thiophenyl group and a quinolinyl group.

Further preferably, in the compound represented by formula (I), R₁ is any one of the following (a), (b) and (c). Specifically, R₁ is one of: (a) an alkyl group having 1 to 18 carbon atoms; a cycloalkyl group having 5 to 12 carbon atoms; an alkenyl group having 3 to 12 carbon atoms; a phenyl group; an alkyl group having 1 to 18 carbon atoms substituted with a phenyl group, OH, an alkoxy group having 1 to 18 carbon atoms, a cycloalkoxy group having 5 to 12 carbon atoms, an alkenyloxy group having 3 to 18 carbon atoms, a halogen atom, —COOH, —COOR₄, —O—CO—R₅, —O—CO—O—R₆, —CO—NH₂, —CO—NHR₇, —CO—N(R₇)(R₈), CN, NH₂, NHR₇, —N(R₇)(R₈), —NH—CO—R₅, a phenoxy group, a phenoxy group substituted with an alkyl group having 1 to 18 carbon atoms, a phenyl-alkoxy group having 1 to 4 carbon atoms, a bornyloxy group, a norborn-2-yloxy group, a norbornyl-2-methoxy group, a norborn-5-ene-2-methoxy group or an adamantyloxy group; a cycloalkyl group having 5 to 12 carbon atoms substituted with OH, an alkyl group having 1 to 4 carbon atoms, an alkenyl group having 2 to 6 carbon atoms and/or —O—CO—R₅; a glycidyl group; —CO—R₉ or —SO₂—R₁₀, (b) an alkyl group having 3 to 50 carbon atoms interrupted by one or more oxygen atoms and/or substituted with OH, a phenoxy group or an alkylphenoxy group having 7 to 18 carbon atoms, or (c) -A; —CH₂—CH(XA)-CH₂—O—R₁₂; —CR₁₃R′₁₃—(CH₂)ₘ—X-A; —CH₂—CH(OA)-R₁₄; —CH₂—CH(OH)—CH₂—XA;

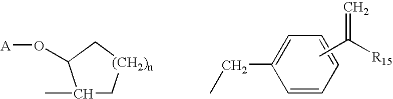

—CR₁₅R′₁₅—C(═CH2)—R″₁₅; —CR₁₃R′₁₃—(CH₂)ₘ—X-A; —CR₁₃R′₁₃—(CH₂)ₘ—CO—O—CR₁₅R′₁₅—C(═CH₂)—R″₁₅ or —CO—O—CR₁₅R′₁₅—C(═CH₂)—R″₁₅ (wherein, A is —CO—CR₁₆═CH—R₁₇).

R₂ is an alkyl group having 6 to 18 carbon atoms; an alkenyl group having 2 to 6 carbon atoms; a phenyl group; —O—R₃ or —NH—CO—R₅. R₃ has the same meaning as R₁, and is independent from each other. R₄ is an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or R₁₄ is an alkyl group having 3 to 50 carbon atoms interrupted by one or more of —O—, —NH—, —NR₇— and —S—, and which may be substituted with OH, phenoxy group or an alkylphenoxy group having 7 to 18 carbon atoms.

R₅ is H; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a norborn-2-yl group; a norborn-5-en-2-yl group; or an adamantyl group.

R₆ is H; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R₇ and R₈ are each independently an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms. Otherwise, R₇ and R₈ are together an alkylene group having 3 to 9 carbon atoms; an oxa-alkylene group having 3 to 9 carbon atoms or an aza-alkylene group having 3 to 9 carbon atoms.

R₉ is an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a norborn-2-yl group; a norborn-5-en-2-yl group; or an adamantyl group.

R₁₀ is an alkyl group having 1 to 12 carbon atoms; a phenyl group; a naphthyl group; or an alkylphenyl group having 7 to 14 carbon atoms.

R₁₁'s are each independently H; an alkyl group having 1 to 18 carbon atoms; or a phenylalkyl group having 7 to 11 carbon atoms.

R₁₂ is an alkyl group having 1 to 18 carbon atoms; an alkenyl group having 3 to 18 carbon atoms; a phenyl group; a phenyl group substituted with 1 to 3 substituents of an alkyl group having 1 to 8 carbon atoms, an alkoxy group having 1 to 8 carbon atoms, an alkenoxy group having 3 to 8 carbon atoms, a halogen atom or a trifluoromethyl group; or a phenylalkyl group having 7 to 11 carbon atoms; a cycloalkyl group having 5 to 12 carbon atoms; a 1-adamantyl group; a 2-adamantyl group; a norbornyl group; a norbornane-2-methyl-; or —CO—R₅. Otherwise, R₁₂ is an alkyl group having 3 to 50 carbon atoms interrupted by one or more of —O—, —NH—, —NR₇— and —S—, and which may be substituted with OH, a phenoxy group or an alkylphenoxy group having 7 to 18 carbon atoms.

R₁₃ and R′₁₃ are each independently H; an alkyl group having 1 to 18 carbon atoms; or a phenyl group.

R₁₄ is an alkyl group having 1 to 18 carbon atoms; an alkoxyalkyl group having 3 to 12 carbon atoms; a phenyl group; or a phenyl-alkyl group having 1 to 4 carbon atoms.

R₁₅, R′₁₅ and R″₁₅ are each independently H or CH₃, R₁₆ is H; —CH₂—COO—R₄; an alkyl group having 1 to 4 carbon atoms; or CN, and R₁₇ is H; —COOR₄; an alkyl group having 1 to 17 carbon atoms; or a phenyl group.

X is —NH—; —NR₇—; —O—; —NH—(CH₂)ₚ—NH—; or —O—(CH₂)_{q}—NH—; and the index numbers m is a number among 0 to 19; n is a number among 1 to 8; p is a number among 0 to 4; and q is a number among 2 to 4.

The compounds represented by Formulae (U-11) and (I) can be obtained as in the same manner with conventionally known compounds by a practical method, for example, the Friedel-Craft addition of halotriazine to corresponding phenol according to or in the same manner as described in publications of Europe Patent No. 434608 or H. Brunetti & C. E. Luthi, Helv. Chim. Acta, Vol. 55, p. 1566 (1972).

Next, preferred examples of the compound represented by formula (101), formula (U-11) or formula (I) are given below, but the invention is not limited to the specific examples.

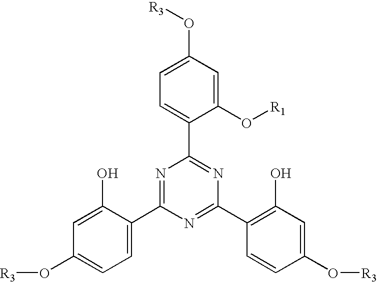

| Compound No. | R₃ | R₁ |
|---|---|---|
| UVA-1 | —CH₂CH(OH)CH₂OC₄H₉-n | —CH₃ |
| UVA-2 | —CH₂CH(OH)CH₂OC₄H₉-n | —C₂H₅ |
| UVA-3 | R₃ = R₁ = | |
| | —CH₂CH(OH)CH₂OC₄H₉-n | |
| UVA-4 | —CH(CH₃)—CO—O—C₂H₅ | —C₂H₅ |
| UVA-5 | R₃ = R₁ = | |
| | —CH(CH₃)—CO—O—C₂H₅ | |
| UVA-6 | —C₂H₅ | —C₂H₅ |
| UVA-7 | —CH₂CH(OH)CH₂OC₄H₉-n | —CH(CH₃)₂ |
| UVA-8 | —CH₂CH(OH)CH₂OC₄H₉-n | —CH(CH₃)—C₂H₅ |
| UVA-9 | R₃ = R₁ = | |
| | —CH₂CH(C₂H₅)—C₄H₉-n | |
| UVA-10 | —C₈H₁₇-n | —C₈H₁₇-n |
| UVA-11 | —C₃H₇-n | —CH₃ |
| UVA-12 | —C₃H₇-n | —C₂H₅ |
| UVA-13 | —C₃H₇-n | —C₃H₇-n |
| UVA-14 | —C₃H₇-iso | —CH₃ |
| UVA-15 | —C₃H₇-iso | —C₂H₅ |
| UVA-16 | —C₃H₇-iso | —C₃H₇-iso |
| UVA-17 | —C₄H₉-n | —CH₃ |
| UVA-18 | —C₄H₉-n | —C₂H₅ |
| UVA-19 | —C₄H₉-n | —C₄H₉-n |
| UVA-20 | —CH₂CH(CH₃)₂ | —CH₃ |
| UVA-21 | —CH₂CH(CH₃)₂ | —C₂H₅ |
| UVA-22 | —CH₂CH(CH₃)₂ | —CH₂CH(CH₃)₂ |
| UVA-23 | n-hexyl | —CH₃ |
| UVA-24 | n-hexyl | —C₂H₅ |
| UVA-25 | n-hexyl | n-hexyl |
| UVA-26 | —C₇H₁₅-n | —CH₃ |
| UVA-27 | —C₇H₁₅-n | —C₂H₅ |
| UVA-28 | —C₇H₁₅-n | —C₇H₁₅-n |
| UVA-29 | —C₈H₁₇-n | —CH₃ |
| UVA-30 | —C₈H₁₇-n | —C₂H₅ |
| UVA-31 | —CH₂CHCH(CH₃)₂ | —CH₂CHCH(CH₃)₂ |
| UVA-32 | —C₅H₁₁-n | —C₅H₁₁-n |
| UVA-33 | —C₁₂H₂₅-n | —C₁₂H₂₅-n |
| UVA-34 | —C₁₆H₃₆-n | —C₂H₅ |
| UVA-35 | —CH₂—CO—O—C₂H₅ | —CH₂—CO—O—C₂H₅ |

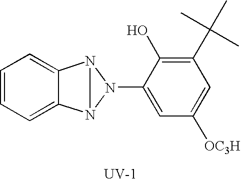

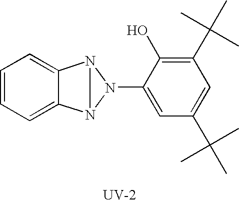

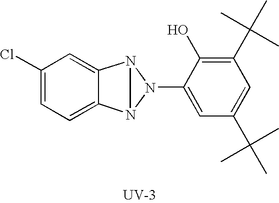

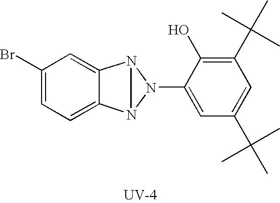

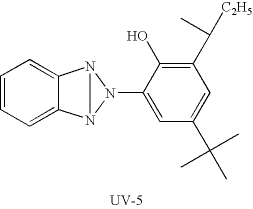

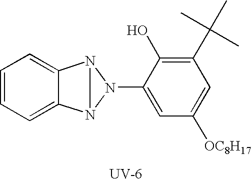

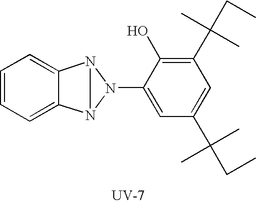

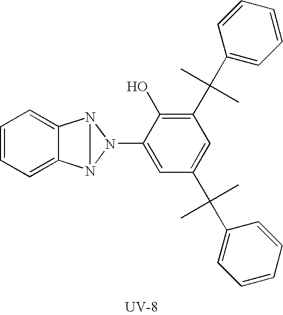

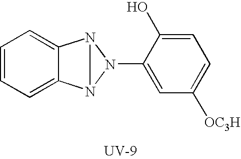

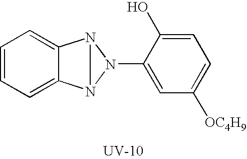

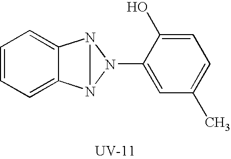

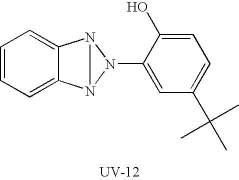

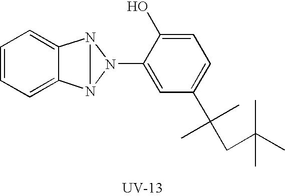

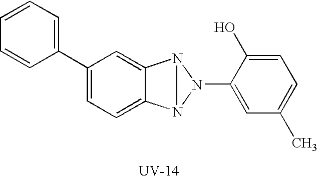

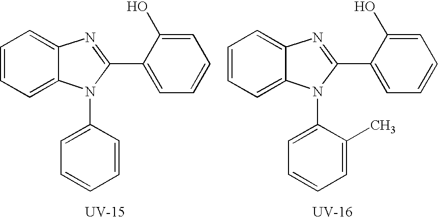

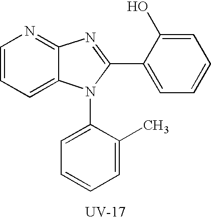

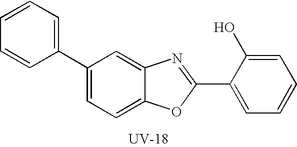

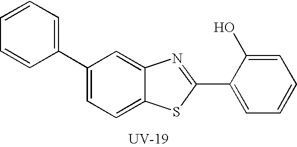

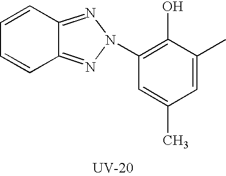

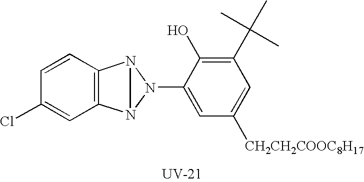

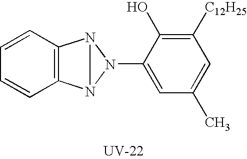

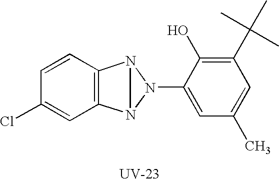

Further, the wavelength dispersion controlling agent of the invention, the compound represented by formula (102) is preferably used: 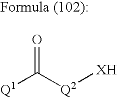
wherein Q¹ and Q² are each independently an aromatic ring, and X is NR (wherein R is a hydrogen atom or a substituent), an oxygen atom or a sulfur atom.

The aromatic ring represented by Q¹ and Q² may be an aromatic hydrocarbon ring or an aromatic heterocyclic ring. These substituents may be monocyclic or may form a fused ring with other rings.

The aromatic hydrocarbon ring represented by Q¹ and Q² is preferably a monocyclic or bicyclic aromatic hydrocarbon ring having 6 to 30 carbon atoms (e.g., a benzene ring, a naphthalene ring, etc.), more preferably an aromatic hydrocarbon ring having 6 to 20 carbon atoms, even more preferably an aromatic hydrocarbon ring having 6 to 12 carbon atoms, and still more preferably a benzene ring.

The aromatic heterocyclic ring group represented by Q¹ and Q² is preferably an aromatic heterocyclic ring group containing at least one selected from an oxygen atom, a nitrogen atom and a sulfur atom. Specific examples of the heterocyclic ring include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene and the like. Preferred examples of the aromatic heterocyclic ring are a pyridine ring, a triazine ring and a quinoline ring.

The aromatic ring represented by Q¹ and Q² is preferably an aromatic hydrocarbon ring, more preferably an aromatic hydrocarbon ring having 6 to 10 carbon atoms, and even more preferably a substituted or unsubstituted benzene ring.

Q¹ and Q² may be further substituted, and the substituent is preferably the substituent T, which has the same meaning as those in formula (101). However, the substituent does not include carboxylic acids, sulfonic acids or quaternary ammonium salts. If possible, the substituents may be fused to each other to form a ring structure.

X is NR (wherein R is a hydrogen atom or a substituent, and the substituent may be exemplified by the above substituent T), an oxygen atom or a sulfur atom. X is preferably NR (wherein R is preferably an acyl group or a sulfonyl group, and these substituents may be further substituted.) or an oxygen atom, and particularly preferably an oxygen atom.

The compound represented by formula (102) is preferably a compound represented by the following formula (102-A): 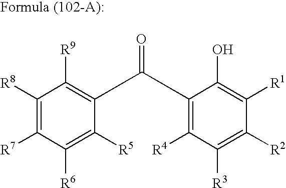
wherein R¹, R², R³, R⁴, R⁵, R⁶, R⁷, R₈ and R⁹ are each independently a hydrogen atom or a sub

R¹, R², R³, R⁴, R⁵, R⁶, R⁷, R₈ and R⁹ are each independently a hydrogen atom or a substituent, and the substituent may be exemplified by the above-described substituent T. These substituents may be further substituted with other substituents, and the substituents may be fused to each other to form a ring structure.

R¹, R³, R⁴, R⁵, R⁶, R⁸ and R⁹ are preferably a hydrogen atom, an alkyl group, an alkenyl group, an alkynyl group, an aryl group, a substituted or unsubstituted amino group, an alkoxy group, an aryloxy group, a hydroxyl group, or a halogen atom; more preferably a hydrogen atom, an alkyl group, an aryl group, an alkyloxy group, an aryloxy group or a halogen atom; even more preferably a hydrogen atom or an alkyl group having 1 to 12 carbon atoms; particularly preferably a hydrogen atom or a methyl group; and most preferably a hydrogen atom.

R² is preferably a hydrogen atom, an alkyl group, an alkenyl group, an alkynyl group, an aryl group, a substituted or unsubstituted amino group, an alkoxy group, an aryloxy group, a hydroxyl group, or a halogen atom; more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group; even more preferably an alkoxy group having 1 to 20 carbon atoms; and particularly preferably an alkoxy group having 1 to 12 carbon atoms.

R⁷ is preferably a hydrogen atom, an alkyl group, an alkenyl group, an alkynyl group, an aryl group, a substituted or unsubstituted amino group, an alkoxy group, an aryloxy group, a hydroxyl group, or a halogen atom; more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group; even more preferably a hydrogen atom, an alkyl group having 1 to 20 carbon atoms (preferably having 1 to 12 carbon atoms, more preferably 1 to 8 carbon atoms, and even more preferably a methyl group); and particularly preferably a methyl group or a hydrogen atom.

The compound represented by formula (102) is more preferably a compound represented by the following formula (102-B): 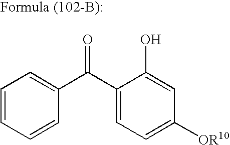
wherein R₁₀ is a hydrogen atom, a substituted or unsubstituted alkyl group, a substituted or unsubstituted alkenyl group, a substituted or unsubstituted alkynyl group, or a substituted or unsubstituted aryl group.

R₁₀ is a hydrogen atom, a substituted or unsubstituted alkyl group, a substituted or unsubstituted alkenyl group, a substituted or unsubstituted alkynyl group, or a substituted or unsubstituted aryl group, and the substituents on the aforementioned groups can be exemplified by the substituent T.

R₁₀ is preferably a substituted or unsubstituted alkyl group, more preferably a substituted or unsubstituted alkyl group having 5 to 20 carbon atoms, even more preferably a substituted or unsubstituted alkyl group having 5 to 12 carbon atoms (e.g., an n-hexyl group, a 2-ethylhexyl group, an n-octyl group, an n-decyl group, an n-dodecyl group, a benzyl group, etc.), and particularly preferably a substituted or unsubstituted alkyl group having 6 to 12 carbon atoms (e.g., a 2-ethylhexyl group, an n-octyl group, an n-decyl group, an n-dodecyl group or a benzyl group).

The compound represented by Formula (102) can be synthesized by a known method described in JP-A No. 11-12219.

Specific examples of the compound represented by Formula (102) are given below, but the invention is not limited to the specific examples.

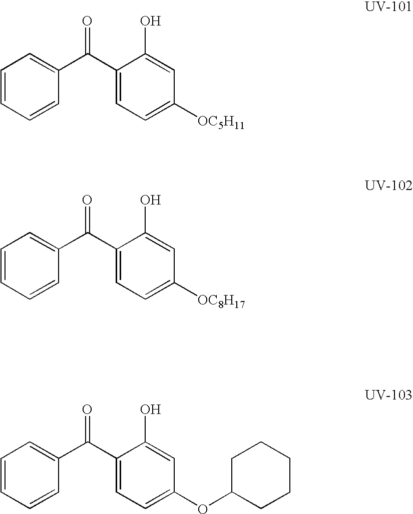

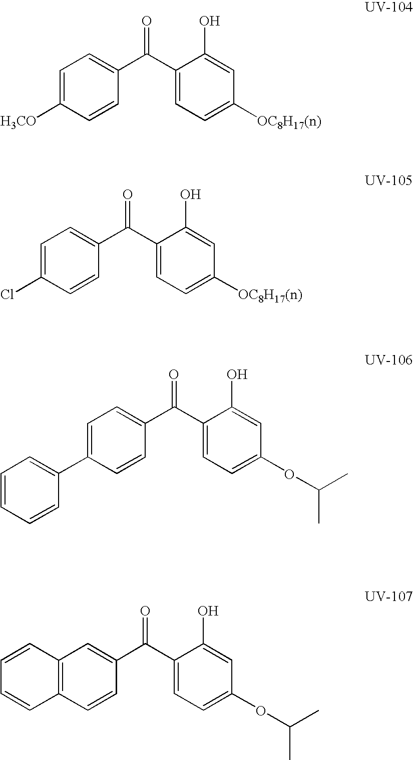

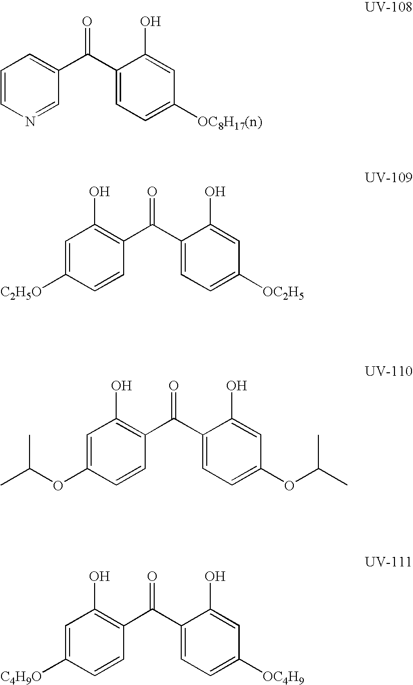

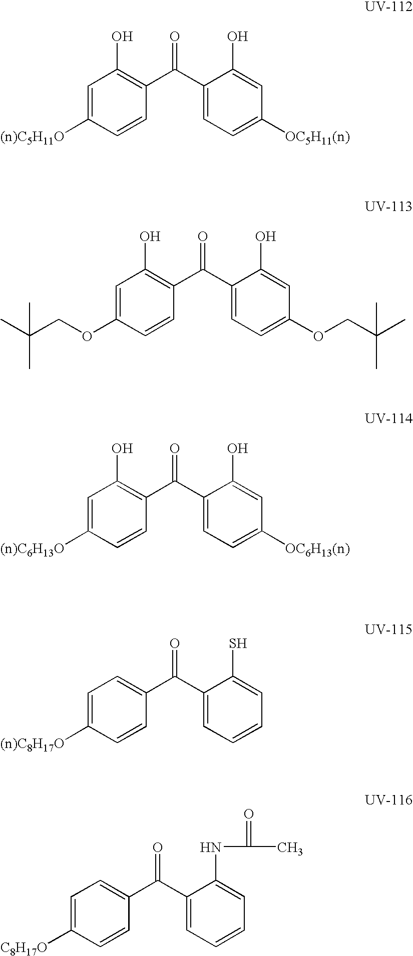

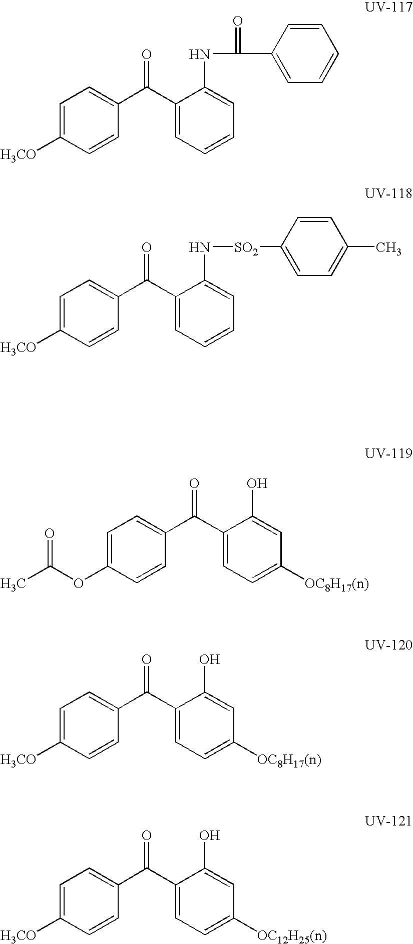

Further, the wavelength dispersion controlling agent used in the invention, a compound represented by formula (103) is preferably used: 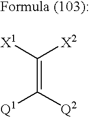
wherein Q¹ and Q² are each independently an aromatic ring. X¹ and X² are each a hydrogen atom or a substituent, and at least one of them is a cyano group.

The aromatic ring represented by Q¹ and Q² may be an aromatic hydrocarbon ring or an aromatic heterocyclic ring. Further, these may be monocyclic or may form a fused ring with other rings.

The aromatic hydrocarbon ring is preferably a monocyclic or bicyclic aromatic hydrocarbon ring having 6 to 30 carbon atoms (e.g., a benzene ring, a naphthalene ring, etc.), more preferably an aromatic hydrocarbon ring having 6 to 20 carbon atoms, even more preferably an aromatic hydrocarbon ring having 6 to 12 carbon atoms, and still more preferably a benzene ring.

The aromatic heterocyclic ring is preferably an aromatic heterocyclic ring containing a nitrogen atom or a sulfur atom. Specific examples of the heterocyclic ring include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene and the like. The aromatic heterocyclic ring is preferably a pyridine ring, a triazine ring or a quinoline ring.

The aromatic ring represented by Q¹ and Q² is preferably an aromatic hydrocarbon ring, and more preferably a benzene ring.

Q¹ and Q² may be further substituted, and the substituent T is preferably used. The substituent T has the same meaning as those in Formula (101).

X¹ and X² are a hydrogen atom or a substituent and at least one group is a cyano group. A substituent represented by X¹ and X² may be exemplified by the above-mentioned substituent T. In addition, the substituent represented by X¹ and X² may be further substituted with other substituents and each substituent represented by X¹ and X² may be fused to form a ring structure.

X¹ and X² are preferably a hydrogen atom, an alkyl group, an aryl group, a cyano group, a nitro group, a carbonyl group, a sulfonyl group or an aromatic heterocyclic ring; more preferably a cyano group, a carbonyl group, a sulfonyl group or an aromatic heterocyclic ring; even more preferably a cyano group or a carbonyl group; and particularly preferably a cyano group or an alkoxycarbonyl group (—C(═O)OR (wherein, R is an alkyl group having 1 to 20 carbon atoms, an aryl group having 6 to 12 carbon atoms, and a combination thereof).

The compound represented by formula (103) is preferably a compound represented by the following formula (103-A): 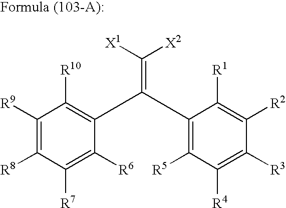
wherein R¹, R², R³, R⁴, R⁵, R⁶, R⁷, R₈, R⁹ and R¹⁰ are each independently a hydrogen atom or a substituent. X¹ and X² have the same meanings as those in formula (103) and their preferable ranges are the same as those in formula (103).

R¹, R², R³, R⁴, R⁵, R⁶, R⁷, R⁸, R⁹ and R¹⁰ are each independently a hydrogen atom or a substituent, and the substituent may be exemplified by the above-described substituent T. These substituents may be further substituted with other substituents, and the substituents may be fused to each other to form a ring structure.

R¹, R², R⁴, R⁵, R⁶, R⁷, R⁹ and R¹⁰ are preferably a hydrogen atom, an alkyl group, an alkenyl group, an alkynyl group, an aryl group, a substituted or unsubstituted amino group, an alkoxy group, an aryloxy group, a hydroxyl group, or a halogen atom; more preferably a hydrogen atom, an alkyl group, an aryl group, an alkyloxy group, an aryloxy group or a halogen atom; even more preferably a hydrogen atom or an alkyl group having 1 to 12 carbon atoms; particularly preferably a hydrogen atom or a methyl group; and most preferably a hydrogen atom.

R³ and R⁸ are preferably a hydrogen atom, an alkyl group, an alkenyl group, an alkynyl group, an aryl group, a substituted or unsubstituted amino group, an alkoxy group, an aryloxy group, a hydroxyl group, or a halogen atom; more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group; even more preferably a hydrogen atom, an alkyl group having 1 to 12 carbon atoms, or an alkoxy group having 1 to 12 carbon atoms; and particularly preferably a hydrogen atom.

The compound represented by formula (103) is more preferably a compound represented by the following formula (103-B): 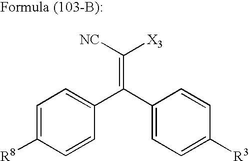
wherein R³ and R⁸ have the same meanings as those in formula (103-A) and their preferable ranges are the same as those in formula (103-A). X³is a hydrogen atom or a substituent.

X³ is a hydrogen atom or a substituent, and the substituent may be exemplified by the above-described substituent T. The substituent may be further substituted with other substituents, if possible. X³ is preferably a hydrogen atom, an alkyl group, an aryl group, a cyano group, a nitro group, a carbonyl group, a sulfonyl group or an aromatic heterocyclic ring; more preferably a cyano group, a carbonyl group, a sulfonyl group or an aromatic heterocyclic ring; even more preferably a cyano group or a carbonyl group; and particularly preferably a cyano group or an alkoxycarbonyl group (—C(═O)OR (wherein, R is an alkyl group having 1 to 20 carbon atoms, an aryl group having 6 to 12 carbon atoms, and a combination thereof).

The compound represented by formula (103) is more preferably a compound represented by the following formula (103-C): 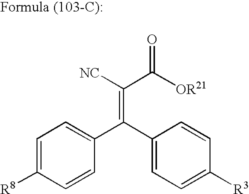
wherein R³ and R⁸ have the same meanings as those in formula (103-A) and their preferable ranges are the same as those in formula (103-A). R²¹ is an alkyl group having 1 to 20 carbon atoms.

When both of R³ and R⁸ are a hydrogen atom, R²¹ is preferably an alkyl group having 2 to 12 carbon atoms, more preferably an alkyl group having 4 to 12 carbon atoms, even more preferably an alkyl group having 6 to 12 carbon atoms, particularly preferably an n-octyl group, a tert-octyl group, a 2-ethylhexyl group, an n-decyl group, or an n-dodecyl group, and most preferably a 2-ethylhexyl group.

When R³ and R⁸ are not a hydrogen atom, the compound represented by the Formula (103-C) has a molecular weight of 300 or more, and R²¹ is preferably an alkyl group having 20 or less carbon atoms.

The compound represented by Formula (103 can be synthesized by a method described in Journal of American Chemical Society, Vol. 63, p. 3452 (1941).

Specific examples of the compound represented by Formula (103) are given below, but the invention is not limited to the specific examples.

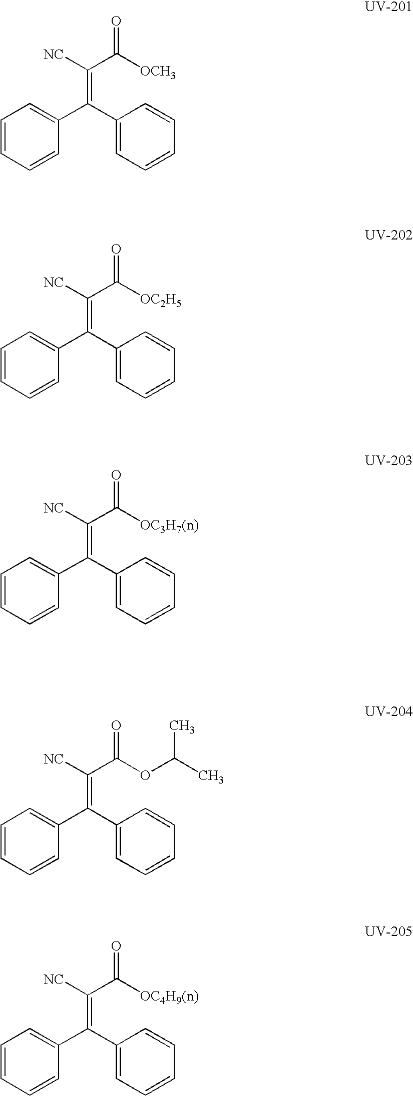

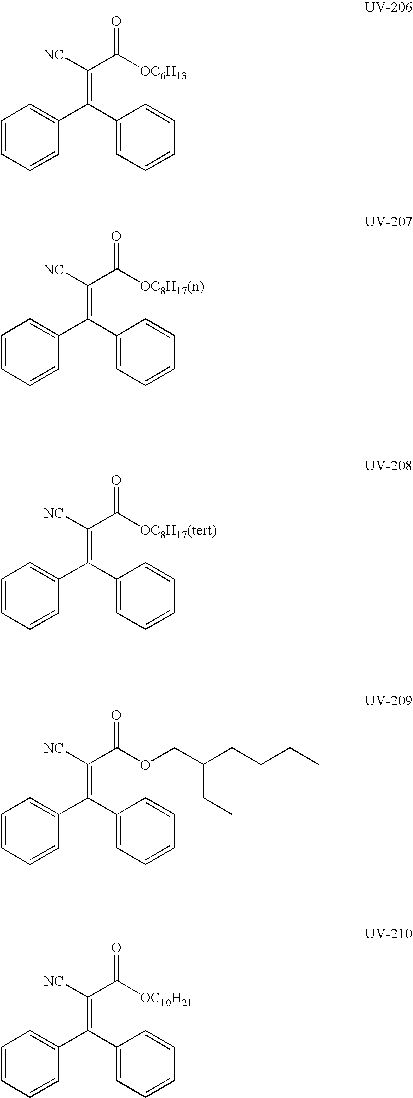

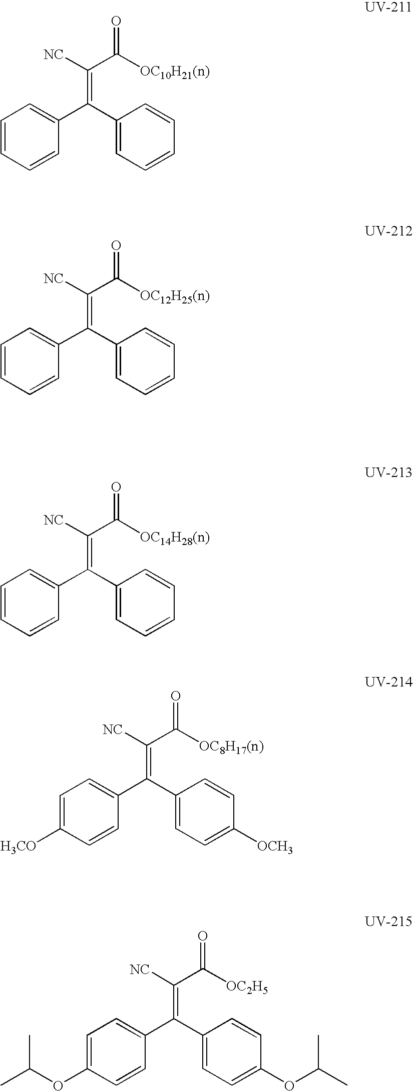

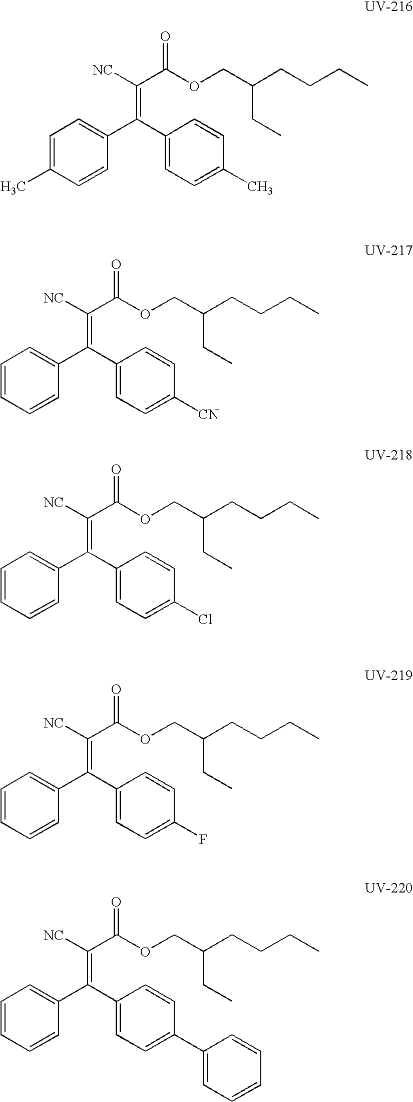

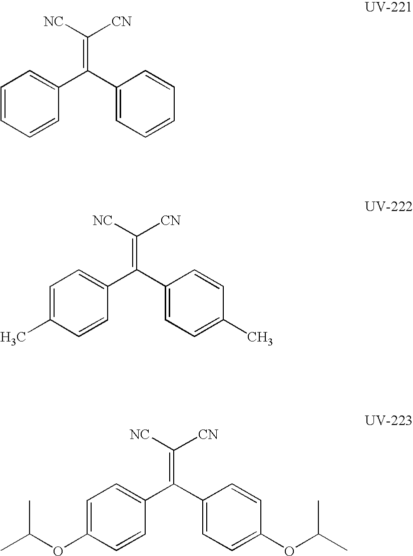

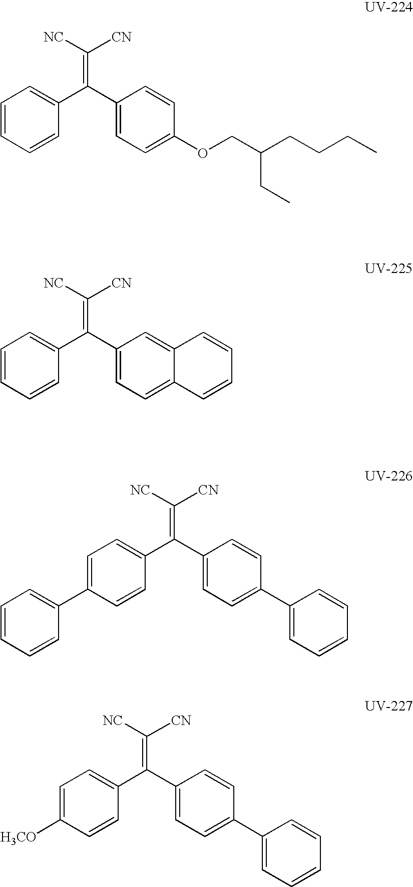

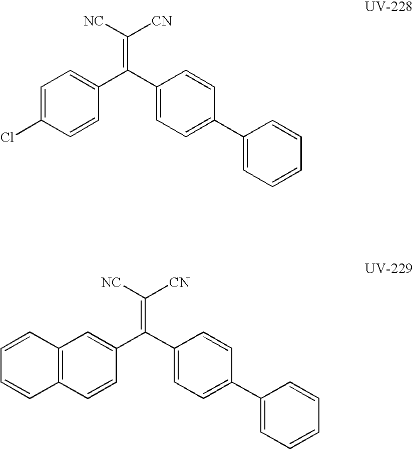

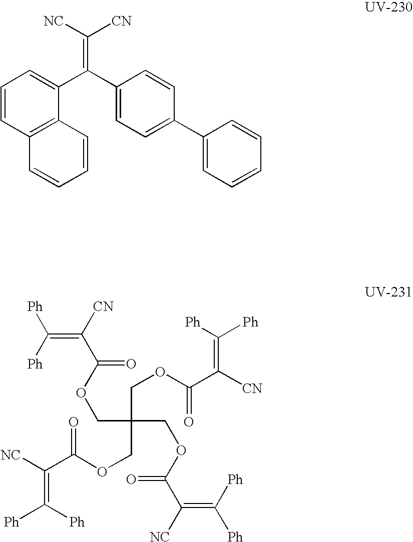

(Matting Agent Microparticles)

It is preferable to add microparticles as a matting agent to the cellulose acylate film of the invention. The microparticles that can be used for the invention may be exemplified by silicon dioxide, titanium dioxide, aluminum oxide, zirconium oxide, calcium carbonate, talc, clay, calcined kaolin, calcined calcium silicate, calcium hydrosilicate, aluminum silicate, magnesium silicate or calcium phosphate. The microparticles preferably contain silicon in view of lowering the turbidity, and silicon dioxide is particularly preferred. The silicon dioxide microparticles preferably have a primary average particle size of 20 nm or less, as well as an apparent specific gravity of 70 g/liter or greater. It is more preferable that the average diameter of the primary particle is small in the range of 5 to 16 nm, in view of lowering the haze of the film. The apparent specific gravity is preferably 90 to 200 g/liter or larger, and more preferably 100 to 200 g/liter or larger. As the apparent specific gravity is larger, it is possible to prepare a dispersion of higher concentration, and thus haze and aggregate become good, which is preferable.

These microparticles form secondary particles having an average particle size of usually 0.1 to 3.0 μm, and these microparticles exist as aggregates of primary particles in the film, thus forming irregularities in the range of 0.1 to 3.0 μm on the film surface. The average particle size of the secondary particle is preferably in the range of 0.2 μm to 1.5 μm, more preferably in the range of 0.4 μm to 1.2 μm, and most preferably in the range of 0.6 μm to 1.1 μm. The particle size of the primary and secondary particles were determined by observing a particle with a scanning electron microscope and taking the diameter of a circle circumscribing the particle as the particle size. Further, 200 particles at varying sites were observed, and the average value was taken as the average particle size.

For silicon dioxide microparticles, commercially available products such as, for example, Aerosil R972, R972V, R974, R812, 200, 200V, 300, R202, OX50, TT600 (all available from Nippon Aerosil Co., Ltd.) and the like can be used. Zirconium oxide microparticles that can be used are commercially available under the tradename of Aerosil R976 and R811 (all available from Nippon Aerosil Co., Ltd.).

Among these, Aerosil 200V and Aerosil R972V are silicon dioxide microparticles having a primary average particle size of 20 nm or less, and also an apparent specific gravity of 70 g/liter or larger. They have a significant effect of lowering the friction coefficient while maintaining the turbidity of an optical film low, and thus they are particularly preferable.

According to the invention, in order to obtain a cellulose acylate film having particles of small secondary average particle size, several techniques for preparing a dispersion of microparticles can be considered. For example, a method of preparing in advance a microparticle dispersion having a solvent and microparticles mixed with stirring, adding this microparticle dispersion to a small amount of separately prepared cellulose acylate solution, dissolving the mixture with stirring, and mixing the resulting solution with the remaining large amount of the cellulose acylate solution (dope solution), is available. This method is a preferred preparation method from the viewpoint that since the dispersibility of silicon dioxide is good, silicon dioxide microparticles have difficulties in undergoing further re-aggregation. In addition to that, there is available a method of adding a small amount of cellulose ester to a solvent, dissolving the cellulose ester with stirring, then adding microparticles to the resulting solution and dispersing with a disperser to obtain a microparticulate additive liquid, and sufficiently mixing this microparticulate additive liquid with a dope solution using an in-line mixer. The present invention is not limited to these methods, but the concentration of silicon dioxide upon mixing and dispersing the silicon dioxide microparticles with a solvent or the like is preferably 5 to 30% by weight, more preferably 10 to 25% by weight, and most preferably 15 to 20% by weight. When the dispersion concentration is high, the liquid turbidity relative to the amount of addition decreases, and the haze and aggregate become good, which is preferable. The amount of addition of the matting agent microparticles in the final cellulose acylate dope solution is preferably 0.01 to 1.0 g, more preferably 0.03 to 0.3 g, and most preferably 0.08 to 0.16 g, per 1 m³.

The solvent to be used may be exemplified by lower alcohols, preferably methyl alcohol, ethyl alcohol, propyl alcohol, isopropyl alcohol, butyl alcohol or the like. Solvents other than the lower alcohols are not particularly limited, but it is preferable to use a solvent that is used for the formation of cellulose ester film.

(Plasticizer, Deterioration Preventing Agent, Peeling Agent)

In addition to the compound reducing optical anisotropy and the wavelength dispersion controlling agent, the cellulose acylate of the invention may contain various additives in accordance with the use (for example, a plasticizer, a ultraviolet blocking agent, deterioration preventing agent, peeling agent, infrared absorbent, etc.), as described above, and these additives may be solid or oily matter. That is, the additives are not particularly limited in the aspect of the melting point or boiling point. For example, ultraviolet absorbing materials of 20° C. or higher and of 20° C. or lower may be mixed, and plasticizers also may be mixed likewise, and they are described in JP-A No. 2001-151901 and the like, for example. Further, infrared absorbents are described in, for example, JP-A No. 2001-194522. The time of the addition may be at any time during the dope preparation process, but it is desirable to add the additives at the final step of the dope preparation process. The amount of addition of each additive is not particularly limited, as long as the function is exhibited. In the case where a cellulose acylate film is formed in multilayer, the type or amount of addition of the additives in each layer may be different. For example, the techniques are described in JP-A No. 2001-151902 and the like, and they are traditionally known techniques. For details of the additives, the materials described in detail in the Technical Report of Japan Institute of Invention and Innovation (Technology No. 2001-1745, published on Mar. 15, 2001 by Japan Institute of Invention and Innovation), pp. 16-22, are favorably used.

(Ratio of Compound Addition)

For the cellulose acylate film of the invention, the total amount of the compound having a molecular weight of 3000 or less is preferably 5 to 45% with respect to the weight of cellulose acylate. The total amount is more preferably 10 to 40%, and even more preferably 15 to 30%. The compound may be exemplified, as described above, by a compound reducing optical anisotropy, a wavelength dispersion controlling agent, an ultraviolet blocking agent, a plasticizer, a deterioration preventing agent, a microparticle, a peeling agent, an infrared absorbent or the like. Molecular weight of the compound is preferably 3000 or less, more preferably 2000 or less, and even more preferably 1000 or less. When the total amount of these compounds is less than 5% by weight, the properties of the elemental cellulose acylate substance are likely to be exhibited, and there is a problem that, for example, the optical performance or physical strength is susceptible to fluctuate with the change in temperature or humidity, or the like. Furthermore, when the total amount of these compounds exceeds 45% by weight, the compatibility of the compounds in the cellulose acylate film goes beyond the limit, and thus the compounds are likely to cause problems such as that the compounds precipitate out on the film surface to result in clouding of the film (bleeding from the film), and the like.

(Organic Solvent for Cellulose Acylate Solution)

According to the invention, it is preferable to produce a cellulose acylate film by solvent casting method, and the film is produced using a solution (dope) in which cellulose acylate is dissolved in an organic solvent.

According to the invention, for the purpose of promoting gelation of an undried dope film that is formed by flow casting a cellulose acylate solution on a metal substrate during the flow casting step to be described later, so as to enhance peelability, and of increasing the elastic modulus of the produced film, the cellulose acylate solution preferably contains at least two or more alcohol solvents as the organic solvent (dissolving agent) to dissolve cellulose acylate. For the alcohol solvent, any alcohol having 1 to 8 carbon atoms may be used. Also, at least one species is preferably an alcohol having 3 to 8 carbon atoms, and more preferably having 4 to 6 carbon atoms. The alcohol content in the solvent composition may be any value between 0.1 to 40%, more preferably between 1.0 to 30%, and even more preferably between 2.0 to 20%.

In addition, the organic solvent that is favorably used as the main solvent of the invention is preferably a solvent selected from esters, ketones and ethers having 3 to 12 carbon atoms, and halogenated hydrocarbons having 1 to 7 carbon atoms. The esters, ketones and ethers may have cyclic structures. A compound having any two or more among the functional groups of ester, ketone and ether (i.e., —O—, —CO— and —COO—) also can be used as the main solvent, and may also have other functional groups such as, for example, an alcoholic hydroxyl group. In the case of the main solvent having two or more different functional groups, the number of carbon atoms may be any number within the defined range for a compound having functional groups. The main solvent is preferably a chlorine-based solvent or an acetic acid ester, and more preferably methylene chloride or methyl acetate.

Heretofore, the cellulose acylate film of the invention may employ a chlorine-based halogenated hydrocarbon as the main solvent, and may also employ a non-chlorine-based solvent as the main solvent, as described in the Technical Report of Japan Institute of Invention and Innovation, Technology No. 2001-1745 (pp. 12-16).

Other solvents related to the cellulose acylate solution and film of the invention, including the dissolving methods, are described in the following unexamined patent applications, and are preferred embodiments. They are described in, for example, JP-A Nos. 2000-95876, 12-95877, 10-324774, 8-152514, 10-330538, 9-95538, 9-95557, 10-235664, 12-63534, 11-21379, 10-182853, 10-278056, 10-279702, 10-323853, 10-237186, 11-60807, 11-152342, 11-292988, 11-60752 and the like. These patent application publications describe preferred solvents for the cellulose acylate of the invention, as well as the solution properties and co-existing substances to be co-present in the solution, and they are preferred embodiments according to the invention.

(Production Process for Cellulose Acylate Film)

(Dissolution Process)

In the production of the cellulose acylate solution (dope) of the invention, the dissolving method is not particularly limited, and may be carried out at room temperature. Further, the production can be carried out using a cooled dissolution method or a high temperature dissolution method, or even a combination of these.

Also, for the cellulose acylate film of the invention, it is preferable to include a process of dissolution by heating which satisfies the condition represented by the following conditional expression (5) to the dissolution process, so as to make the interaction between the compound used and cellulose acylate more effective, for the purpose of reducing the humidity dependency of the optical performance.
BP(° C.)+5≦Heating temperature(° C.)≦BP(° C.)+70(° C.) Conditional Expression (5)
wherein BP(° C.) is the boiling point of the solvent having the lowest boiling point among the solvents used for the cellulose acylate solution.

In order to make the interaction between the compound and cellulose acylate more effective, the range of heating temperature is preferably BP(° C.)+10≦Heating temperature(° C.)≦BP(° C.)+65(° C.), more preferably BP(° C.)+20≦Heating temperature(° C.)≦BP(° C.)+60(° C.), and even more preferably BP(° C.)+30≦Heating temperature(° C.)≦BP(° C.)+55(° C.).

In addition, for the respective processes of preparation of the cellulose acylate solution according to the invention, and further concentration and filtration of the solution associated with the dissolution process, the production process described in detail in pages 22 to 25 of the Technical Report of Japan Institute of Invention and Innovation (Technology No. 2001-1745, published on Mar. 15, 2001 by Japan Institute of Invention and Innovation) is also favorably used.

(Transparency of Dope Solution)

The dope transparency of the cellulose acylate solution of the invention is preferably 85% or higher, more preferably 88% or higher, and even more preferably 90% or higher. According to the invention, various additives are sufficiently dissolved in the cellulose acylate dope solution. In a specific method for calculating the dope transparency, the dope solution is introduced into a glass cell with each edge being 1 cm, and the absorbance at 550 nm is measured with a spectrophotometer (for example, UV-3150, Shimadzu Corp.). Only the solvent is measured in advance as a blank, and the transparency of the cellulose acylate solution is calculated from the ratio of the absorbance of the solution to the absorbance of the blank.

(Flow Casting, Drying, Winding Processes)

Next, the method of producing a film using the cellulose acylate solution of the invention will be described. The method and equipment for the production of the cellulose acylate film of the invention that can be used are the method of solution flow casting film formation and the equipment for solution flow casting film formation that are conventionally provided for cellulose acylate film production. A dope (cellulose acylate solution) prepared in a dissolving vessel (kettle) is first stored in a storage kettle, and the final preparation is carried out by defoaming the dope. The dope is transferred to a pressurizable die from a dope exit through, for example, a pressurizable metering gear pump which can transport a defined amount with high precision attained by the speed of rotation. The dope is discharged from an orifice (slit) of the pressurizable die to be uniformly flow cast on a metal substrate at the flow casting section, which is endlessly running. At the point of peel-off where the metal substrate has run around a virtually full circle, a not fully dried dope film (also called as web) is peeled from the metal substrate. With both edges of the obtained web being clamped with clips, the web is conveyed to a tenter, while maintaining the width, and dried. The continuously obtained film is mechanically conveyed with a group of rollers of the drying apparatus, is completely dried and is taken up (wound up) in a roll shape with a winding machine to a predetermined length. The combination of the tenter and the group of rollers in the drying apparatus may vary in accordance with the purpose. According to the method of solution flow casting film formation used for the functional protective film which is an optical member for electronic display devices, which is a major application of the cellulose acylate film of the invention, coating apparatuses are often added, in addition to the solution flow casting film formation apparatus, for the purpose of surface processing on the film, such as providing an undercoat layer, an antistatic layer, an anti-halation layer, a protective layer and the like. For these coating apparatuses, details are described in the Technical Report of Japan Instituted of Invention and Innovation (Technology No. 2001-1745, published on Mar. 15, 2001, Japan Institute of Invention and Innovation), pp. 25-30, and they are classified under the classes of flow casting (including co-flow casting), metal support, drying, peeling off and the like, which can be favorably used for the invention.

In the method of producing cellulose acylate film of the invention, it is required to set the conditions for drying the dope film on the support after flow casting within the defined ranges, for the purpose of making the interaction between the compound used as additive and cellulose acylate more effective and thereby reducing the humidity dependency of the optical performance of the film. That is, it is preferable to produce a cellulose acylate film by flow casting the cellulose acylate solution on a support at a temperature of −10° C. to 39° C., drying the cellulose acylate solution on the support with dry air at a temperature of 55° C. to 180° C., then peeling off the flow cast film from the support, and drying the flow cast film again during the drying process.

When the temperature of the cellulose acylate solution upon the flow casting is 39° C. or higher, the film obtained after film formation has high crystallinity, and consequently the humidity dependency of the optical performance increases. Also, on the other hand, when the temperature of the cellulose acylate solution is −10° C. or lower, the viscosity of the solution is excessively increased, and the flow cast film is accompanied by failure in the line shape, and thus the surface shape falls beyond an acceptable scope. The temperature of the cellulose acylate solution is more preferably in the range of 0° C. to 39° C., and even more preferably in the range of 10° C. to 39° C.

In addition, when the temperature of the dry air on the support is 55° C. or lower, the interaction between cellulose acylate and the compound used as additive is not sufficient, and as a result, the relation between the humidity dependency of the optical performance of the produced film and the water content increases beyond the defined scope. Also, when the temperature of the dry air on the support is 180° C. or higher, the crystallinity of the film is improved, and consequently the humidity dependency increases; in addition to that, drying occurs too rapidly that there occurs foaming of the film or bleeding of additives.

The temperature of the support for flow casting is preferably in the range of −10° C. to 50° C. When the temperature is 50° C. or higher, the solvent volatilizes from the solution to cause foaming of the solution, thereby the final produced film also containing bubbles, and thus the surface shape falls beyond an acceptable scope. Also, when the temperature of the support for flow casting is −10° C. or lower, the difference between the support temperature and the dry air temperature is excessively large, and bleeding tends to occur. In addition to that, there occurs dew condensation on the support, thereby deteriorating the surface shape of the flow cast film. The temperature of this support is more preferably in the range of −5° C. to 45° C., and even more preferably in the range of 0° C. to 40° C.

The thickness of the produced cellulose acylate film is preferably 10 to 200 μm, more preferably 20 to 150 μm, and even more preferably 30 to 100 μm.

(Change in Optical Performance of the Film After High Humidity Treatment)

With respect to the change in the optical performance of the cellulose acylate film of the invention due to environmental change, the amount of change of Re(400), Re(700), Rth(400) and Rth(700) of the film conditioned under an ambience of 60° C. and 90% RH for 240 hours is preferably in the range of 0 nm to 5 nm, more preferably in the range of 0 nm to 12 nm, and even more preferably in the range of 0 nm to 10 nm.

(Change in Optical Performance of the Film After High Temperature Treatment)

Further, the amount of change of Re(400), Re(700), Rth(400) and Rth(700) of the film conditioned under an ambience of 80° C. for 240 hours is preferably in the range of 0 nm to 15 nm, more preferably in the range of 0 nm to 12 nm, and even more preferably in the range of 0 nm to 10 nm.

(Amount of Sublimation of Compound After Film Heating Treatment)

For the compound favorably used for the cellulose acylate film of the invention to reduce Rth and the compound to reduce ΔRth, the amount of sublimation of such a compound from the film conditioned at 80° C. for 240 hours is preferably in the range of 0% to 30%, more preferably in the range of 0% to 25%, and even more preferably in the range of 0% to 20%. The amount of sublimation from the film is determined from the following formula, after dissolving a film that has been conditioned at 80° C. for 240 hours and a film that is not conditioned, respectively in a solvent, detecting the compound by high speed liquid chromatography, and taking the peak area of the compound as the amount of the compound remaining in the film:
Amount of sublimation (%)={(amount of residual compound in the untreated product)−(amount of residual compound in the treated product)}/(amount of residual compound in the untreated product)×100

(Glass Transition Temperature Tg of Film)

The glass transition temperature Tg of the cellulose acylate film of the invention is 80 to 165° C. From the viewpoint of heat resistance, Tg is more preferably 100 to 160° C., and particularly preferably 110 to 150° C. Measurement of the glass transition temperature Tg is carried out by subjecting 10 mg of a sample of the cellulose acylate film of the invention to calorie measurement using a differential scanning calorimeter (for example, DSC2910, TA Instruments, Inc.), from ambient temperature to 200° C. at a temperature elevating or lowering rate of 5° C./min, thus to determine the glass transition temperature Tg.

(Haze of Film)

The haze of the cellulose acylate film of the invention is preferably 0.0% to 2.0%, more preferably 0.0% to 1.5%, and even more preferably 0.0% to 1.0%. Transparency of the film is important when used as an optical film. Measurement of the haze is carried out according to JIS K-6714, using a sample of the cellulose acylate film of the invention having a size of 40 mm×80 mm, with a haze meter (HGM-2DP, Suga Test Instruments Co., Ltd.) at 25° C. and 60% RH.

(Humidity Dependency of Re and Rth of Film)

Both Re and Rth of the cellulose acylate film of the invention preferably undergo smaller changes due to humidity. Inter alia, for the humidity dependency of Rth, when the equilibrium water content of the film and the humidity dependency of Rth fall within the ranges defined by conditional expression (1), a sufficiently low humidity dependency, which is desired in the invention, is achieved, as described above. On the other hand, for Re, it is preferable that specifically the in-plane retardation of the film, Re(λ) (wherein λ is wavelength (nm)) satisfies the following conditional expression (II):
(Re_{A})−(Re_{B})≦10 nm Conditional Expression (II)
wherein (Re_{A}) is Re₍₆₃₀₎ under the conditions of 25° C. and 10% RH, and (Re_{B}) is Re₍₆₃₀₎ under the conditions of 25° C. and 80% RH.

(Re_{A})−(Re_{B}) is more preferably 0 to 8 nm, and even more preferably 0 to 5 nm.

(Equilibrium Water Content of Film)

The equilibrium water content of the cellulose acylate film of the invention is such that the equilibrium water content at 25° C. and 80% RH, regardless of the film thickness, is preferably 0 to 4%, more preferably 0.1 to 3.5%, and particularly preferably 1 to 3%, in order not to impair the adhesiveness of the cellulose acylate film to water-soluble polymers such as polyvinyl alcohol and the like when the cellulose acylate film is used as a protective film for polarizing plate. When the equilibrium water content is 4% or greater, the dependency of the retardation on humidity change increases excessively, which is not preferred.

The water content was measured according to the Karl-Fisher method, using a sample of the cellulose acylate film of the invention having a size of 7 mm×35 mm, with a moisture meter and a sample drying apparatus (CA-03 and VA-05, all by Mitsubishi Chemical Corporation). The amount of moisture (g) was calculated by dividing by the sample mass (g).

(Moisture Permeability of Film)

The moisture permeability of the cellulose acylate film of the invention is measured on the basis of JIS Standards JIS Z0208 under the conditions of a temperature of 60° C. and a humidity of 95% RH, and the moisture permeability value is preferably 400 to 1800 g/m²·24 h, more preferably 500 to 1600 g/m²·24 h, and particularly preferably 600 to 1500 g/m²·24 h, as normalized to the moisture permeability value of a 80 μm-thick film. When the moisture permeability exceeds 1800 g/m²·24 h, the humidity dependency of Re and Rth of the film increases, and its absolute value strongly tends to exceed 0.5 nm/% RH. Even in the case of laminating a liquid crystalline compound layer on the cellulose acylate film of the invention to use as an optical compensation film, the absolute value of the humidity dependency of the Re value and Rth value strongly tends to exceed 0.5 nm/% RH, which is not desirable. When such optical compensation sheet or polarizing plate is installed in a liquid crystal display, there occurs color change or a decrease in the viewing angle. When the moisture permeability of the cellulose acylate film is less than 400 g/m²·24 h, in the case of producing a polarizing plate by adhering the cellulose acylate film on both sides of a polarizing film, or the like, drying of the adhesive is disturbed by the cellulose acylate film, causing poor adhesion.

When the film thickness of the cellulose acylate film is large, the moisture permeability decreases, while when the film thickness is small, the moisture permeability increases. Thus, it is necessary to normalize samples having arbitrary film thicknesses to an 80 μm-thick film. Conversion of the film thickness can be conducted according to the formula: (moisture permeability after normalization to 80 μm=actually measured moisture permeability×actually measured film thickness μm/80 μm).

For the method of measuring moisture permeability, the method described in “Properties of Polymers II” (Lecture on Polymer Experimentation No. 4, Kyoritsu Shuppan Co., Ltd.), pp. 285-294: Measurement of amount of vapor permeation (mass method, thermometer method, vapor pressure method, adsorbed quantity method) can be applied. A sample of the cellulose acylate film of the invention having a size of 70 mmφ is humidified at 25° C. and 90% RH and at 60° C. and 95% RH for 24 hours, respectively, and the amount of moisture per unit area (g/m²) is determined according to JIS Z0208 using a moisture permeability testing apparatus (KK-709007, Toyo Seiki Kogyo Co., Ltd.). The moisture permeability is calculated by subtracting the mass before humidification from the mass after humidification.

(Change of Film Dimension)

The dimensional stability of the cellulose acylate film of the invention is such that the rate of dimensional change in the case of conditioning the film at 60° C. and 90% RH for 24 hours (high humidity), and the rate of dimensional change in the case of conditioning the film at 90° C. and 5% RH for 24 hours (high temperature) are all preferably in the range of 0% to 0.5%, more preferably in the range of 0% and 0.3%, and even more preferably in the range of 0% and 0.15%.

For the specific measuring method, two sheets of cellulose acylate film samples having 30 mm×120 mm are humidified at 25° C. and 60% RH for 24 hours, and holes of 6 mmφ are perforated at an interval of 100 mm at both edges of the film samples using an automatic pin gauge (Shinto Scientific Co., Ltd.), with this perforation interval being taken as the original dimension of perforation interval (L0). One sheet of the sample is conditioned at 60° C. and 90% RH for 24 hours, and then the dimension of perforation interval (L1) is measured. Another sheet of the sample is conditioned at 90° C. and 5% RH for 24 hours, and then the dimension of perforation interval (L2) is measured. All measurements of the perforation intervals are made to a minimum scale of 1/1000 mm. The rates of dimensional change are determined by the formulae: Rate of dimensional change at 60° C. and 90% RH (high humidity)={|L0−L1|/L0}×100 and Rate of dimensional change at 90° C. and 5% RH (high temperature)={|L0−L2|/L0}×100.

(Sound Velocity of Film)

For the sound velocity of the cellulose acylate film of the invention, the absolute value is not particularly limited, but the ratio of the sound velocity in the width direction VT and the sound velocity in the longitudinal direction, R(VT/VM), is preferably 1.05 to 1.50, more preferably 1.06 to 1.45, and even more preferably 1.07 to 1.40. When the ratio is larger than 1.50, the curl during the durability test or the change in optical performance is increased. For the specific method of measuring the sound velocity, a film that has been humidified in an atmosphere of 25° C. and 55% RH for 6 hours or longer is used to measure the sound velocity in the width direction and the sound velocity in the longitudinal direction in an atmosphere of 25° C. and 55% RH, using a sound velocity measuring apparatus SST-110 manufactured by Nomura Shoji Co., Ltd., and the ratio of the measured sound velocities is determined.

(Tensile Modulus of Film)

For the cellulose acylate film of the invention, at least one of the tensile modulus in the longitudinal direction and the tensile modulus in the width direction is 450 to 600 kgf/mm² (4.4 kPa to 5.9 kPa), preferably 460 to 580 kgf/mm² (4.5 kPa to 5.7 kPa), and more preferably 470 to 550 kgf/mm² (4.6 kPa to 5.4 kPa). The ratio of the tensile modulus in the longitudinal direction and the tensile modulus in the width direction (MD/TD) is 1.10 to 1.80, and preferably 1.15 to 1.50.

In a specific method of measuring the tensile modulus, the stress resulting from 0.5% stretching at a tensile rate of 10%/min in an atmosphere of 23° C. and 70% RH was measured using a universal tensile testing machine STMT50BP manufactured by Toyo Baldwin Co., Ltd., and the modulus was determined.

(Storage Modulus of Film)

For the cellulose acylate film of the invention, it is preferable that both the storage modulus in the width direction and the storage modulus in the longitudinal direction are 15,000 to 80,000 kgf/cm² (1.47 GPa to 7.84 GPa), and at the same time, the ratio of the storage modulus in the width direction and the storage modulus in the longitudinal direction, as expressed as the former/the latter, is 1.10 to 1.80.

More preferably, the storage modulus in the width direction and the storage modulus in the longitudinal direction are both 18,000 to 75,000 kgf/cm² (1.76 GPa to 7.35 GPa), and the ratio of the storage modulus in the width direction and the storage modulus in the longitudinal direction, as expressed as the former/the latter, is 1.14 to 1.60. Even more preferably, the storage modulus in the direction perpendicular to the in-plane conveying direction, and the storage modulus in the conveying direction are both 20,000 to 70,000 kgf/cm² (1.96 GPa to 6.86 GPa), and the ratio of the storage modulus in the width direction and the storage modulus in the longitudinal direction, as expressed as the former/the latter, is preferably 1.17 to 1.50.

In a specific measuring method, the storage modulus was determined by measuring the dynamic viscoelasticity while altering the temperature.

(Fracture Elongation and Fracture Strength of Film)

The cellulose acylate film of the invention preferably has a fraction elongation in the range of 10% to 60%, more preferably in the range of 15% to 50%, and even more preferably in the range of 20% to 40%. The fracture strength is preferably in the range of 10 kgf/mm² to 20 kgf/mm² (98 to 196 MPa), more preferably in the range of 11 kgf/mm² to 19 kgf/mm² (108 to 186 MPa), and even more preferably in the range of 12 kgf/mm² to 18 kgf/mm² (118 to 176 MPa).

In a specific method of measuring the fracture elongation and fracture strength, the cellulose acylate film is subjected to stretching at a tensile rate of 10%/min in an atmosphere of 23° C. and 60% RH using a universal tensile testing machine STMT50BP manufactured by Toyo Baldwin Co., Ltd., and the elongation at the fracture point and the strength at the fracture point are measured.

(Photoelastic Coefficient of Film)

For the cellulose acylate film of the invention, it is preferable that both the photoelastic coefficient in the width direction and the photoelastic coefficient in the longitudinal direction are 25×10⁻¹³ cm²/dyne (2.5×10⁻¹³ N/m²) or less, and at the same time, the ratio of the storage modulus in the width direction and the storage modulus in the longitudinal direction, as expressed as the former/the latter, is 0.60 to 0.97.

More preferably, the photoelastic coefficient in the direction perpendicular to the conveying direction in-plane and the photoelastic modulus in the conveying direction are both 22×10⁻¹³ cm²/dyne (2.2×10⁻¹³ N/m²) or less, and at the same time, the ratio of storage modulus in the width direction and the storage modulus in the longitudinal direction, as expressed as the former/the latter, is 0.65 to 0.96.

Even more preferably, the photoelastic coefficient in the direction perpendicular to the conveying direction in-plane and the photoelastic modulus in the conveying direction are both 20×10⁻¹³ cm²/dyne (2.0×10⁻¹³ N/m²) or less, and at the same time, the ratio of storage modulus in the width direction and the storage modulus in the longitudinal direction, as expressed as the former/the latter, is 0.70 to 0.95.

In a specific measuring method, a cellulose acylate film of the invention having a size of 12 mm×120 mm is subjected to tensile stress in the width direction or in the longitudinal direction, and the retardations under the tensile stress are measured with an ellipsometer (M150 JASCO Corp.). Thus, the photoelastic coefficients are calculated from the amount of change in the retardation against the stress.

(Change in In-Plane Retardation Before and After Stretching, and Detection of Slow Axis)

A sample having a size of 100 mm in length×100 mm in width is cut out from a band-shaped film, and the sample was stretched in parallel with the longitudinal direction (machine direction, MD) or in parallel with the width direction (tangential direction, TD) at a temperature of 140° C. using a fixed single screw stretching machine. The in-plane retardation Re of each sample before and after the stretching was measured using an automatic birefringence analyzer (for example, KOBRA 21ADH, Oji Scientific Instruments Co., Ltd.). Detection of the slow axis was determined from the angle of orientation obtained during the measurement of retardation. The cellulose acylate film, which is disposed adjacent to the polarizing film, preferably has a small change in the Re due to stretching. Specifically, when Re(n) is the in-plane retardation (nm) of an n % stretched film, and Re(0) is the in-plane retardation (nm) of an unstretched film, it is preferable that |Re(n)−Re(0)|/n≦1.0, and more preferably |Re(n)−Re(0)|/n≦0.3.

(Direction of Having Slow Axis)

When the cellulose acylate film of the invention is used as a protective film for polarizing film, since the polarizing film has an absorption axis in the machine conveying direction (MD), the cellulose acylate film preferably has the slow axis close to the MD or close to the TD. As the slow axis lies in parallel with or perpendicular to the polarizing film, light leakage or color change can be reduced. The term “close to” means that the slow axis and the MD or TD direction lie within the range of 0 to 10°, and preferably in the range of 0 to 5°.

(Cellulose Acylate Film Having Positive Intrinsic Birefringence)

The cellulose acylate film of the invention is such that when the film is stretched in the direction having the slow axis in plane, the in-plane retardation Re increases, while when the film is stretched in the direction perpendicular to the direction having the slow axis, the in-plane retardation Re decreases. This implies that the intrinsic birefringence is positive, and thus, in order to eliminate Re expressed in the film, it is effective to stretch the film in the direction perpendicular to the slow axis. For this method, it can be considered that, for example, when the film has the slow axis in the MD direction, the frontal Re is decreased using tenter stretching in the direction perpendicular to the MD (TD direction). In contrast, when the film has the slow axis in the TD direction, it can be considered to decrease the frontal Re by stretching the film with strong tension in the conveying roller that is in parallel with the MD.

Various properties of the cellulose acylate and the film obtained therefrom can be achieved by appropriately controlling the conditions for the below-described alignment such as stretching treatment or shrinking treatment.

(Evaluation Method for Cellulose Acylate Film of the Invention)

In the evaluation of the cellulose acylate film of the invention, the following measuring methods were carried out.

(In-Plane Retardation Re and Retardation in the Film Thickness Direction Rth)

Re(λ) is measured by injecting a light ray at a wavelength of λ nm in the direction normal to the film in an automatic birefringence analyzer (for example, KOBRA 21ADH (Oji Scientific Instruments)). Rth(λ) is calculated by KOBRA 21ADH from retardation values measured in three directions, such as the above-described Re(λ), the retardation value measured by injecting a light ray at a wavelength of λ nm from a direction +40° tilted relative to the direction normal to the film, taking the in-plane slow axis (determined by KOBRA 21ADH) as the tilt axis (rotational axis), and the retardation value measured by injecting a light ray at a wavelength of λ nm from a direction −40° tilted relative to the direction normal to the film, taking the in-plane slow axis as the tilt axis (rotational axis); a presumed value of average refractive index; and an input value of film thickness. Here, for the presumed value of average refractive index, values given in the Polymer Handbook (John Wiley & Sons, Inc.) and catalogue values for various optical films can be used. When the average refractive index value is not known for a film, the value can be measured using an Abbe refractometer. The average refractive index values for mainly used optical films are presented below: Cellulose acylate (1.48), cycloolefin polymer (1.52), polycarbonate (1.59), polymethyl methacrylate (1.49), and polystyrene (1.59). As the presumed value of average refractive index and film thickness are input, KOBRA 21ADH calculates nx, ny and nz.

(Transmittance)

The transmittance of visible light (615 nm) is measured using a sample having a size of 20 mm×70 mm at 25° C. and 60% RH with a diaphanometer (AKA photoelectric colorimeter, Kotaki Seisakusho Co., Ltd.).

(Nature of Film Surface)

(Surface Shape)

The surface of the cellulose acylate film of the invention is preferably such that the arithmetic average roughness (Ra) of the surface irregularity of the film based on JIS B0601-1994 is 0.1 μm or less, and the maximum height (Ry) is 0.5 μm or less. Preferably, the arithmetic average roughness (Ra) is 0.05 μm or less, and the maximum height (Ry) is 0.2 μm or less. The shapes of the concave and convex on the film surface can be evaluated using an atomic force microscope (AFM).

(Surface Energy)

The surface energy of the cellulose acylate film of the invention can be measured according to the following method. That is, a sample is placed horizontally on a horizontal plate, and certain amounts of water and methylene iodide are placed on the sample surface. After a definite amount of time, the contact angles of water and methylene iodide on the sample surface are determined. From the measured contact angles, the surface energy is determined according to Owens' method.

(In-Plane Non-Uniformity of Retardations of Cellulose Acylate Film)

The cellulose acylate film of the invention preferably satisfies the following formula:
|Re_{(MAX)}−Re_{(MIN)}|≦3 and |Rth_{(MAX)}−Rth_{(MIN)}|≦5
wherein Re_{(MAX)} and Rth_{(MAX)} are the maximum retardation values of a film arbitrarily cut out to a size of 1 m on the four sides, while Re_{(MIN)} and Rth_{(MIN)} are the minimum values.

(Retentivity of Film)

The cellulose acylate film of the invention is required to have retentivity for various compounds added to the film. Specifically, when the cellulose acylate film of the invention is left to stand under the conditions of 80° C. and 90% RH for 48 hours, the change of film mass is preferably 0 to 5%, more preferably 0 to 3%, and even more preferably 0 to 2%.

<Evaluation Method for Retentivity>

A sample is cut to a size of 10 cm×10 cm, and after conditioning the sample under an ambience of 23° C. and 55% RH for 24 hours, the mass of the sample was measured. Then, the sample was left to stand under the conditions of 80±5° C. and 90±10% RH for 48 hours. The surface of the sample after conditioning was lightly wiped, and the mass of the sample after the conditioning at 23° C. and 55% RH for 1 day was measured, thus to calculate the retentivity by the following method:
Retentivity (mass %)={(mass before standing−mass after standing)/mass before standing}×100

(Dynamic Properties of Film)

(Curl)

The curl value in the width direction of the cellulose acylate film of the invention is preferably −10/m to +10/m. For the cellulose acylate film of the invention, when the below-described surface treatment or rubbing treatment upon coating of an optically anisotropic layer is carried out, or when coating or bonding of an alignment film or an optical anisotropic layer is carried out lengthwise, the value of curl in the width direction of the cellulose acylate film of the invention may cause difficulties in handling of the film outside the above-described range, thus causing breakage of the film. Also, as the film is brought into contact with the conveying roller at the edges or center of the film, dusting is likely to occur, and adherence of foreign matters on the film heavily occurs. Thus, the frequency of point defects or coating lines on the optical compensation film may exceed an acceptable value. Also, when the curl is adjusted to the above-described range, the failure in color unevenness that is likely to occur upon provision of the optically anisotropic layer can be reduced. In addition, upon bonding of the polarizing film, entrainment of air bubbles can be prevented, which is desirable.

The curl value can be measured according to the measuring method specified by the American National Standards Institute (ANSI/ASCPH1.29-1985).

(Tear Strength)

When the film thickness of the cellulose acylate film of the invention is in the range of 20 to 80 μm, the tear strength value based on the tear testing method of JIS K7128-2: 1998 (Elmendorf tear method) is preferably 2 g or larger, more preferably 5 to 25 g, and even more preferably 6 to 25 g. The tear strength value normalized to that of a 60 μm-thick film is preferably 8 g or larger, and more preferably 8 to 15 g. Specifically, the tear strength can be measured after humidifying a sample specimen having a size of 50 mm×64 mm under the conditions of 25° C. and 65% RH for 2 hours, using a light load tear strength testing machine.

(Amount of Residual Solvent of Film)

The cellulose acylate film of the invention is preferably dried under the conditions such that the amount of residual solvent falls within the range of 0.01 to 1.5% by weight, and more preferably 0.01 to 1.0% by weight. Bu adjusting the amount of residual solvent to 1.5% by weight, curling can be suppressed. It is even more preferable that the amount of residual solvent is 1.0% by weight. This is thought to be because when the amount of residual solvent upon film formation by the above-described solvent casting method, the free volume is decreased, and this is an important factor for the main optical and properties effects.

(Hygroscopic Expansion Coefficient of Film)

The hygroscopic expansion coefficient of the cellulose acylate film of the invention is preferably 30×10⁻⁵/% RH or less. The hygroscopic expansion coefficient is preferably 15×10⁻⁵/% RH, and more preferably 10×10⁻⁵/% RH. Also, it is preferable that the hygroscopic expansion coefficient is smaller, but its usual value is 1.0×10⁻⁵/% RH or larger. The hygroscopic expansion coefficient indicates the amount of change in the sample length when the relative humidity is varied at a constant temperature. When the cellulose acylate film of the invention is used as the support for an optical compensation film, with the hygroscopic expansion coefficient being adjusted, a frame-shaped increase in the transmittance, that is, light leakage due to distortion, can be prevented while maintaining the optical compensation function of the optical compensation film.

(Functional Layer)

The cellulose acylate film of the invention is applied to optical applications and photographic light-sensitive material as its use. In particular, it is preferable that the optical application is a liquid crystal display, and it is more preferable that the liquid crystal display has a constitution comprising a liquid crystal cell formed by supporting liquid crystals between two sheets of electrode substrates, two sheets of polarizing plates disposed on both sides of the liquid crystal cell, and at least one optical compensation sheet disposed between the liquid crystal cell and the polarizing plate. Such liquid crystal display is preferably TN, IPS, FLC, AFLC, OCB, STN, ECB, VA and HAN. In particular, IPS and VA are preferred.

When the cellulose acylate film is used for the above-described optical application, various functional layers are provided. The functional layers are, for example, antistatic layer, curable resin layer (transparent hard coat layer), antireflection layer, reverse adhesive layer, antiglare layer, optical compensation layer, alignment layer, liquid crystal layer and the like. These functional layers for which the cellulose acylate film of the invention can be used, and the materials therefore may be exemplified by surfactant, lubricant, matting agent, antistatic layer, hard coat layer and the like, and they are described in detail in the Technical Report of Japan Institute of Invention and Innovation, Technology No. 2001-1745 (published on Mar. 15, 2001 by Japan Institute of Invention and Innovation), pp. 32-45, which can be favorably used for the invention.

(Use (Polarizing Plate))

The uses of the cellulose acylate film of the invention will be described.

The cellulose acylate film of the invention is particularly useful as a protective film for polarizing plate. The polarizing plate includes a polarizing film and protective films protecting both sides of the polarizing film, and a protective film is bonded on one side of the polarizing plate, while a separator film is bonded on the other side. The protective film and the separator film are used for the purpose of protecting the polarizing plate upon shipping of the polarizing plate, product inspection and the like. In this case, the protective film is bonded for the purpose of protecting the surface of the polarizing plate and is used on the opposite side of the surface where the polarizing plate is bonded to the liquid crystal cell. Further, the separator film is used for the purpose of covering the adhesive layer for bonding to the liquid crystal cell, and is used on the surface where the polarizing plate is bonded to the liquid crystal cell. The protective film may be formed from the cellulose acylate film of the invention.

The polarizing film is preferably a coated type polarizing film represented by the product of Optiva, Inc., or a polarizing film comprising a binder and iodine or a dichromatic dye.

The iodine and dichromatic dye in the polarizing film expresses deflection function when aligned in the binder. The iodine and dichromatic dye are preferably aligned along the binder molecules, or the dichromatic dye is preferably aligned in one direction by self-assembly in the same manner as liquid crystals do.

At present, a polarizing film for general use is generally produced by immersing stretched polymer in a solution of iodine or dichromatic dye contained in a bath and allowing the iodine or dichromatic dye to penetrate into the binder. The polarizing film for general use has the iodine or dichromatic dye distributed over about 4 μm from the polymer surface (about 8 μm in total of both sides), and in order to obtain sufficient polarizing function, a thickness of at least 10 μm is required. The degree of penetration can be controlled by the concentration of the iodine or dichromatic dye solution, temperature of the bath and immersion time.

The binder in the polarizing film may be crosslinked. A polymer capable of crosslinking per se can be used as the crosslinked binder. A polarizing film can be formed by allowing a polymer having a functional group or a binder obtained by introducing a functional group to a polymer, to react between the binder molecules under the action of light, heat or pH change.

Also, a crosslinked structure may be introduced to a polymer by a crosslinking agent. The crosslinked structure can be formed by using the crosslinking agent, which is a compound having high reactivity, to introduce a functional group derived from the crosslinking agent to the binder, and to crosslink the binder.

Crosslinking is generally carried out by coating a coating solution containing a polymer or a mixture of a polymer and a crosslinking agent on a transparent support, and then heating. Since it would be sufficient as long as durability is secured at the final product stage, the crosslinking treatment may be carried out at any stage until the time point of obtaining the final polarizing plate.

For the binder in the polarizing film, polymers capable of crosslinking per se and polymers crosslinked by a crosslinking agent can be all used. Examples of the polymer include polymethyl methacrylate, polyacrylic acid, polymethacrylic acid, polystyrene, gelatin, polyvinyl alcohol, modified polyvinyl alcohol, poly(N-methylolacrylamide), polyvinyltoluene, chlorosulfonated polyethylene, nitrocellulose, chlorinated polyolefin (e.g., polyvinyl chloride, polyester, polyimide, polyvinyl acetate, polyethylene, carboxymethylcellulose, polypropylene, polycarbonate and copolymers thereof (e.g., acrylic acid/methacrylic acid copolymer, styrene/maleimide copolymer, styrene/vinyltoluene copolymer, vinyl acetate/vinyl chloride copolymer, ethylene/vinyl acetate copolymer). Water-soluble polymers (e.g., poly(N-methylolacrylamide), carboxymethylcellulose, gelatin, polyvinyl alcohol and modified polyvinyl alcohol) are preferred; gelatin, polyvinyl alcohol and modified polyvinyl alcohol are more preferred; and polyvinyl alcohol and modified polyvinyl alcohol are most preferred.

The degree of saponification of polyvinyl alcohol and modified polyvinyl alcohol is preferably 70 to 100%, more preferably 80 to 100%, and most preferably 95 to 100%. The degree of polymerization of polyvinyl alcohol is preferably 100 to 5000.

A modified polyvinyl alcohol is obtained by introducing a modifying group to polyvinyl alcohol through copolymerization modification, chain transfer modification or block polymerization modification. In the copolymerization modification, COONa, Si(OH)₃, N(CH₃)₃Cl, C₉H₁₉COO, SO₃Na, and C₁₂H₂₅ can be introduced as the modifying group. In the chain transfer modification, COONa, SH, and SC₁₂H₂₅ can be introduced as the modifying group. The degree of polymerization of the modified polyvinyl alcohol is preferably 100 to 3000. Descriptions on modified polyvinyl alcohol are found in JP-A No. 8-338913, JP-A No. 9-152509 and JP-A No. 9-316127.

Non-modified polyvinyl alcohol and alkylthio-modified polyvinyl alcohol, both having a degree of saponification of 85 to 95%, are particularly preferred.

Two or more species of polyvinyl alcohol and modified polyvinyl alcohol may be used in combination.

When the crosslinking agent for binder is added in large amounts, the moisture and heat resistance of the polarizing film can be improved. However, when the crosslinking agent is added in an amount of 50% by weight or greater with respect to the binder, the orientation of the iodine or dichromatic dye is reduced. The amount of addition of the crosslinking agent is preferably 0.1 to 20% by weight, and more preferably 0.5 to 15% by weight.

The binder contains unreacted crosslinking agent to a certain extent, even after the completion of the crosslinking agent. However, the amount of the residual crosslinking agent is preferably 1.0% by weight or less, and more preferably 0.5% by weight or less, in the binder. When the crosslinking agent is contained in the binder layer in an amount exceeding 1.0% by weight, there may be a durability problem. That is, when a polarizing film having a large amount of residual crosslinking agent is installed in a liquid crystal display and used for long time or left for long time in an atmosphere of high temperature and high humidity, the degree of polarization may be decreased. Descriptions on crosslinking agent are found in the specification of U.S. Reissued Pat. No. 23297. Boron compounds (e.g., boric acid, borax) can be also used as the crosslinking agent.

For the dichromatic dye, azo dyes, stilbene dyes, pyrazolone dyes, triphenylmethane dyes, quinoline dyes, oxazine dyes, thiazine dyes or anthraquinone dyes are used. The dichromatic dye is preferably water-soluble. The dichromatic dye preferably has hydrophilic substituents (e.g., sulfo, amino, hydroxyl). Examples of the dichromatic dye include C.I. Direct·Yellow 12, C.I. Direct·Orange 39, C.I. Direct·Orange 72, C.I. Direct·Red 39, C.I. Direct·Red 79, C.I. Direct·Red 81, C.I. Direct·Red 83, C.I. Direct·Red 89, C.I. Direct·Violet 48, C.I. Direct·Blue 67, C.I. Direct·Blue 90, C.I. Direct·Green 59, and C.I. Acid·Red 37. Description on dichromatic dye are found in JP-A No. 1-161202, JP-A No. 1-172906, JP-A No. 1-172907, JP-A No. 1-183602, JP-A No. 1-248105, JP-A No. 1-265205, and JP-A No. 7-261024. The dichromatic dye is used in the form of free acid, or in the form of alkali metal salt, ammonium salt or amine salt. Polarizing films having a variety of colors can be produced by combining two or more dichromatic dyes. A polarizing film employing a compound (dye) displaying black color when the polarizing axes are crossed, or a polarizing film or polarizing plate having various dichromatic molecules combined to display black color is excellent in both the single plate transmittance and the rate of polarization, thus being desirable.

According to the invention, the single plate transmittance, parallel transmittance and cross transmittance of the polarizing plate were measured using UV3100PC (Shimadzu Corp.). The single plate transmittance, parallel transmittance and perpendicular transmittance were measured in the range of 380 nm to 780 nm under the conditions of 25° C. and 60% RH, and an average value of 10 measurements was used for the three transmittances. The polarizing plate durability test was carried out with two types of samples including (1) a polarizing plate only and (2) a polarizing plate adhered on glass with an adhesive. For the measurement of the sample including polarizing plate only, two identical samples in which an optical compensation film is combined with two polarizers to be interposed therebetween in a crossed manner, were provided and measured. For the measurement of the sample adhered to glass, two samples (about 5 cm×5 cm) in which a polarizing plate is adhered on glass such that the optical compensation film faces the glass, are provided. For the measurement of the single plate transmittance, the film side of the samples was set to face the light source, and the measurement was made. Two samples were separately measured, and an average thereof was taken as the transmittance of a single plate. Preferred ranges for the polarization performance are such that, in an order of the single plate transmittance (TT), parallel transmittance (PT) and cross transmittance (CT), 40.0≦TT≦45.0, 30.0≦PT≦40.0, and CT≦2.0; more preferably 40.2≦TT≦44.8, 32.2≦PT≦39.5, and CT≦1.6; and even more preferably 41.0≦TT≦44.6, 34≦PT≦39.1, and CT≦1.3.

From these transmittances, the degree of polarization P is calculated, and as the degree of polarization P is increased, light leakage is decreased upon cross disposition, thus the performance of the polarizing plate increases. The degree of polarization P is preferably 95.0% or higher, more preferably 96.0% or higher, and even more preferably 97.0% or higher.

The polarizing plate of the invention is preferably such that when the cross transmittance at a wavelength λ is T(λ), T₍₃₈₀₎, T₍₄₁₀₎, and T₍₇₀₀₎ satisfy at least one of the following Formulae (e) to (g):
T₍₃₈₀₎≦2.0 (e)
T₍₄₁₀₎≦1.0 (f)
T₍₇₀₀₎≦0.5; (g)

more preferably T₍₃₈₀₎≦1.95, T₍₄₁₀₎≦0.9, and T₍₇₀₀₎≦0.49; and even more preferably T₍₃₈₀₎≦1.90, T₍₄₁₀₎≦0.8, and T₍₇₀₀₎≦0.48.

The polarizing plate of the invention is preferably such that when left to stand under the conditions of 60° C. and 95% RH for 650 hours, the amount of change in the cross single plate transmittance ΔCT and the amount of change in the degree of polarization ΔP satisfy at least one of the following Formulae (h) and (i):
−0.6≦ΔCT≦0.6 (h)
−0.3≦ΔP≦0.0. (i)

The polarizing plate of the invention is preferably such that when conditioned at 80° C. for 650 hours, the amount of change in the cross single plate transmittance ΔCT and the amount of change in the degree of polarization ΔP satisfy at least one of the following Formulae (l) and (m):
−0.6≦ΔCT≦0.6 (h)
−0.3≦ΔP≦0.0. (i)

Also, in the polarizing plate durability test, the amount of change is preferably smaller.

(Constitution of Liquid Crystal Display)

A liquid crystal display usually has a liquid crystal cell is disposed between two sheets of polarizing plates, and the protective film obtained by applying the cellulose acylate film of the invention may exhibit excellent display properties at any site of disposition. In particular, since the protective film of a polarizing plate at the outermost surface on the display side of a liquid crystal display is provided with a hard coat layer, an antiglare layer, an antireflection layer or the like, it is particularly preferable to use the protective film of the invention for this part.

For the production of the polarizing plate of the invention, in order to use the cellulose acylate film of the invention as a protective film of polarizing film (protective film for polarizing plate), it is necessary to enhance the adhesiveness between the surface of the polarizing film-bonded side, and the polarizing film containing polyvinyl alcohol as the main component. When the adhesiveness is insufficient, the processability of the cellulose acylate film after the production of polarizing plate, to be appropriately used for panels of liquid crystal displays and the like, or the durability of the cellulose acylate film is insufficient, causing problems such as peeling-off during long-term use and the like. An adhesive can be used for the adhesion, and examples of the adhesive component include polyvinyl alcohol-based adhesives such as polyvinyl alcohol, polyvinyl butyral and the like, or vinyl-based latexes such as butyl acrylate and the like. If the adhesiveness is to be considered, the surface energy may be used as an index, and when the surface energy of an adhesive layer comprising polyvinyl alcohol, which is the main component of polarizing film, or an adhesive containing polyvinyl alcohol or a vinyl-based latex as the main component, is closer to the surface energy of the protective film to be bonded, the bondability, processability of the bonded polarizing plate, and durability are further enhanced. From these, when the surface energy on the side bonded to the polarizing film or adhesive is adjusted to a desired range by surface treatment such as hydrophilization treatment or the like, sufficient adhesiveness to a polarizing film containing polyvinyl alcohol as the main component can be imparted.

Since the cellulose acylate film of the invention usually contains a compound reducing optical anisotropy or additives such as wavelength dispersion controlling agent and the like, the film surface is rather hydrophobic. Thus, it is further required to enhance the bondability by hydrophilization treatment, for the impartment of polarizing plate processability and durability.

The surface energy of a film after film formation and before surface treatment such as hydrophilization treatment or the like, is hydrophobized due to the use of above-described additives, and the surface energy is preferably in the range of 30 mN/m to 50 mN/m, and more preferably in the range of 40 mN/m and 48 mN/m, from the viewpoint of feasibility of the above-described treatment for enhancing bondability. When the surface energy before treatment is less that 30 mN/m, large energy is required to obtain good bondability by the hydrophilization treatment to be described later, thus the film properties being deteriorated, or it being difficult to achieve both film properties and productivity. Further, when the surface energy before treatment exceeds 50 mN/m, the hydrophilicity of the film itself increases excessively, and the humidity dependency of the optical performance or dynamic properties of the film is excessively increased, thus causing problems.

In addition, although the surface energy of a polyvinyl alcohol surface varies depending on the additives used in combination, the extent of dryness, or the adhesive used, the surface energy falls within the range of 60 mN/m to 80 mN/m. From this point of view, the surface energy of the surface of the film of the invention on the side bonded to the polarizing film after the below-described surface treatment such as hydrophilization treatment or the like, is preferably in the range of 50 mN/m to 80 mN/m, more preferably in the range of 60 mN/m to 75 mN/m, and even more preferably in the range of 65 mN/m to 75 mN/m.

(Surface Treatment such as Hydrophilization Treatment)

The hydrophilization treatment of the film surface of the invention can be carried out by known methods. Examples thereof include methods for modifying the film surface by corona discharge treatment, glow discharge treatment, ultraviolet irradiation treatment, flame treatment, ozone treatment, acid treatment, alkali treatment and the like. The glow discharge treatment as used herein may be low temperature plasma which occurs under a low pressure gas of 10⁻³ to 20 Torr (0.133 to 2660 Pa), and plasma treatment under atmospheric pressure is also desirable. A plasma excited gas which is plasma-excited under the above-mentioned conditions, may be exemplified by argon, helium, neon, krypton, xenon, nitrogen, carbon dioxide and chlorofluorocarbon such as tetrafluoromethane, mixtures thereof, and the like. Detailed descriptions on these are found in the Technical Report of Japan Institute of Invention and Innovation (Technology No. 2001-1745, published on Mar. 15, 2001 by Japan Institute of Invention and Innovation), pp. 30-32, which can be favorably used for the invention.

(Alkali Saponification Treatment)

Among the treatments, alkali saponification treatment is particularly preferred, and is highly effective for the surface treatment of cellulose acetate film. The following methods may be mentioned as the method of treatment.

(1) Immersion Method

This is a method of immersing a film an alkali solution, and subjecting all of the entire film surfaces having reactivity with alkali to saponification. Since the method does not necessitate special facilities, it is favorable in view of costs. The alkali solution is preferably an aqueous solution of sodium hydroxide. The preferred concentration is 0.5 to 3 mol/l, and particularly preferably 1 to 2 mol/l. The preferred liquid temperature of the alkali solution is 25 to 70° C., and particularly preferably 30 to 60° C.

After the immersion in the alkali solution, the film is sufficiently washed with water or immersed in a dilute acid to neutralize the alkali component, in order to prevent the alkali component from remaining in the film.

The saponification treatment allows hydrophilization of both surfaces of the film. The protective film for polarizing plate is used after the hydrophilized surface is adhered to the polarizing film.

The hydrophilized surface is effective in improving the adhesiveness to the polarizing film containing polyvinyl alcohol as the main component.

On the other hand, when the protective film has an antireflection layer in the immersion method, even the peripheral surfaces are damaged by alkali, and thus it is important to carry out the method under the minimally required reaction conditions. When the contact angle of the support on the opposite side peripheral surface against water is used an index of the damage on the antireflection layer due to alkali, particularly in the case where the support is cellulose triacetate, the contact angle is preferably 20° to 50°, more preferably 30° to 50°, and even more preferably 40° to 50°. Within this range, the adhesiveness to polarizing film can be maintained, without causing any harm to the substantial damage on the antireflective film.

(2) Alkali Solution Coating Method

As a means to avoid damage on an antireflection film in the above-described immersion method, a method of coating an alkali solution to the peripheral surface and the opposite peripheral surface having antireflection films under appropriate conditions, heating, washing with water and drying the coating, is favorably used. The alkali solution and the treatment are described in JP-A No. 2002-82226 and WO 02/46809. However, since the method separately requires equipments and processes for coating an alkali solution, the method is less attractive than the immersion method of (1) in the aspect of costs.

(Plasma Treatment)

The plasma treatment used for the invention may be exemplified by the methods of vacuum glow discharge, atmospheric glow discharge and the like, as well as other methods of flame plasma treatment and the like. For these, the methods described in, for example, JP-A Nos. 6-123062, 11-293011, 11-5857 and the like can be used.

According to the plasma treatment, strong hydrophilicity can be imparted to a plastic film by treating the surface of the plastic film placed under plasma. For example, the surface treatment can be carried out by placing a film to be imparted with hydrophilicity, between two facing electrodes in a plasma generating apparatus using glow discharge, introducing a plasma-excitable gas in the apparatus, and applying a high frequency voltage between the electrodes to plasma-excite the gas to induce glow discharge between the electrodes. Among the plasma treatments, atmospheric glow discharge is preferably used.

(Corona Discharge Treatment)

Among the surface treatments, corona discharge treatment is the best known method, and can be achieved by any conventionally known method, for example, the method disclosed in JP-B Nos. 48-5043,47-51905, JP-A No. 47-28067, 49-83767, 51-41770, 51-131576, and the like. For the corona treating machine used for the corona treatment, various commercially available corona treating machines that are currently used as the means for surface modification of plastic films and the like can be applied. Among hem, the corona treating machine of Softal Electronic GmbH having multi-blade electrodes includes a plurality of electrodes and has a structure of sending air between the electrodes. Thus, this corona treating machine can achieve prevention of film heating, removal of low molecular weight molecules generated from the film surface or the like, thus having very high energy efficiency and being capable of high corona treatment. Therefore, the corona treating machine is a particularly useful corona treating machine for the invention.

In order to use the cellulose acylate film of the invention as a protective film for polarizing plate or the like, it is necessary to adjust the surface energy of at least one surface of the cellulose acylate film to fall within a suitable range, and for this purpose, surface treatments as described above are carried out. On the other hand, when the cellulose acylate film of the invention is surface treated, there is possibility for the occurrence of sublimation/leaching/decomposition of the additives contained in the cellulose acylate film, and there is a risk that the optical performance, film performance or durability of the cellulose acylate film deteriorates. Also, when sublimation or leaching occurs, the treatment system is further contaminated, and the capability for treatment is reduced, thereby not allowing continuous conductance of treatment. Therefore, it is necessary to suppress reduction of the amount of additives. The amount of change in the amount of addition of additives due to surface treatment is preferably 0.2% or less, more preferably 0.1% or less, and even more preferably 0.01% or less, with respect to the total amount of addition of additives before treatment.

(Use (Optical Compensation Film))

cellulose acylate film of the invention can be used for various applications, and can be particularly effectively used as an optical compensation film of liquid crystal displays. The optical compensation film refers to an optical material generally used in liquid crystal displays and compensating for retardation, and can be interchangeably used with retardation plate, optical compensation sheet or the like. The optical compensation film has birefringence and is used for the purpose of removing coloration in the display screen of liquid crystal displays or improving the viewing angle characteristics. The cellulose acylate film of the invention has small optical anisotropy such that Re(630) and Rth(630) are 0≦Re≦10 nm and |Rth(630)|≦25 nm, and preferably has small wavelength dispersion such that |Re(400)−Re(700)|≦10 and |Rth(400)−Rth(700)|≦35 thus not inducing unnecessary anisotropy. Therefore, when an optically anisotropic layer having birefringence is used in combination, only the optical performance of the optically anisotropic layer can be exhibited.

Accordingly, when the cellulose acylate film of the invention is used as the optical compensation film of liquid crystal displays, Re(630) and Rth(630) of the optically anisotropic layer used in combination are preferably such that Re(630)=0 to 200 nm and |Rth(630)|=0 to 400 nm, and any optically anisotropic layer failing within this range may be used. Any optically anisotropic layer required as the optical compensation film can be used in combination, without any restrictions in the optical performance or driving mode of the liquid crystal cell of the liquid crystal display employing the cellulose acylate film of the invention. The optically anisotropic layer used in combination may be formed from a composition containing a liquid crystalline compound, or may be formed from a polymer film having birefringence.

The liquid crystalline compound is preferably a discotic liquid crystalline compound or a rod-shaped liquid crystalline compound.

(Discotic Liquid Crystalline Compound)

Examples of the discotic liquid crystalline compound that can be used for the invention include the compounds described in various literatures (C. Destrade et al., Mol. Cryst. Liq. Cryst., Vol. 71, p. 111 (1981); the Chemical Society of Japan, Ed., Kikan Kagaku Sosetsu, No. 22, Chemistry of Liquid Crystals, Ch. 5, Ch. 10 Sec. 2 (1994); B. Kohne et al., Angew. Chem. Soc. Chem. Comm., p. 1794 (1985); and J. Zhang et al., J. Am. Chem. Soc., Vol. 116, p. 2655 (1994)).

For the optically anisotropic layer, the discotic liquid crystalline molecules are preferably fixed in an aligned state, and are most preferably fixed by polymerization reaction. Polymerization of the discotic liquid crystalline molecules is described in JP-A No. 8-27284. In order to fix the discotic liquid crystalline molecules by polymerization, it is required to bind a polymerizable group to the disc-shaped core of the discotic liquid crystalline molecule as a substituent. However, when a polymerizable group is directly bound to the disc-shaped core, it is difficult to maintain the aligned state during the polymerization reaction. Therefore, a linking group is introduced between the disc-shaped core and the polymerizable group. The discotic liquid crystalline molecules having polymerizable groups are disclosed in JP-A No. 2001-4387.

(Rod-Shaped Liquid Crystalline Compound)

According to the invention, examples of the rod-shaped liquid crystalline compound that can be used include azomethine compounds, azoxy compounds, cyanobiphenyl compounds, cyanophenyl ester compounds, benzoic acid ester compounds, cyclohexanecarboxylic acid phenyl ester compounds, cyanophenylcyclohexane compounds, cyano-substituted phenylpyrimidine compounds, alkoxy-substituted phenylpyrimidine compounds, phenyldioxane compounds, tolane compounds and alkenylcyclohexylbenzonitrile compounds. In addition to these low molecular weight liquid crystalline compounds, polymeric liquid crystalline compounds also can be used.

For the optically anisotropic layer, the rod-shaped liquid crystalline molecules are preferably fixed in an aligned state, and are most preferably fixed by polymerization reaction. Examples of the polymerizable rod-shaped liquid crystalline compounds that can be used for the invention include the compounds described in Makromol. Chem., Vol. 190, p. 2255 (1989); Advanced Materials, Vol. 5, p. 107 (1993); U.S. Pat. Nos. 4,683,327, 5,622,648 and 5,770,107, WO 95/22586, WO 95/24455, WO 97/00600, WO 98/23580, WO 98/52905, JP-A Nos. 1-272551, 6-166167-110469, 11-80081 and 2001-328973, and the like.

(Optically Anisotropic Layer Comprising Polymer Film)

The optically anisotropic layer may be formed from a polymer film. The polymer film is formed from a polymer which is capable of exhibiting optical anisotropy. Examples of such polymer include polyolefins (e.g., polyethylene, polypropylene, norbornene polymer), polycarbonate, polyarylate, polysulfone, polyvinyl alcohol, polymethacrylic acid esters, polyacrylic acid esters and cellulose esters (e.g., cellulose triacetate, cellulose diacetate). Copolymers or polymer mixtures of these polymers may be also used.

Optical anisotropy of the polymer film is preferably obtained by extension treatment such as stretching. The stretching is preferably uniaxial stretching or biaxial stretching. Specifically, longitudinal uniaxial stretching using the difference of circumferential velocity of two or more rollers, tenter stretching in which a polymer film is stretched in the width direction with both sides of the film being gripped, or biaxial stretching combining the foregoing methods, is preferable. Also, from the viewpoint of the productivity of the optical compensation film and polarizing plate to be described later, tenter stretching or biaxial stretching is more preferred. Two or more sheets of polymer film may be also used so that the optical properties of the two or more sheets of film as a whole satisfy the above-described requirements. The polymer film is preferably produced by the solvent casting method in order to reduce non-uniformity in the birefringence. The thickness of the polymer film is preferably 20 to 500 μm, and most preferably 40 to 100 μm.

(Formation of Optically Anisotropic Layer by Polymer Coating)

The formation of an optically anisotropic layer by polymer coating according to the invention can be carried out by subjecting a layered product which is obtained by spreading a liquefied polymer dissolved in a solvent on the cellulose acylate film of the invention and drying, to a treatment of aligning the molecules in plane. Accordingly, an optical compensation film imparted with desired optical properties is obtained. Examples of the molecule aligning treatment include extension treatment, shrinking treatment, or both of them; however, extension treatment is preferred from the viewpoints of productivity and feasibility of control. Here, the cellulose acylate film of the invention has small optical anisotropy, and thus can form a uniform stretched film. Further, there is no influence of the optically anisotropic layer on the optical compensation effect, and thus optical design of the optical compensation film is also facilitated.

The above-mentioned polymers are not particularly limited, and one or two or more species having suitable light transmissibility can be used. Among them, a polymer which is capable of forming a film having a light transmittance of 75% or greater, particularly 85% or greater, and having excellent light transmissibility is preferred. Also, in view of stable mass production of film, solid polymers exhibiting positive birefringence with increasing retardation in the stretching direction can be favorably used.

In addition, examples of the solid polymer include polyamide or polyester (e.g., JP-W No. 10-508048), polyimide (e.g., JP-W No. 2000-511296), polyether ketone or polyarylether ketone in particular (e.g., JP-A No. 2001-49110), polyamideimide (e.g., JP-A No. 61-162512), or polyesterimide (e.g., JP-A No. 64-38472), and the like. For the formation of birefringent film, one or a mixture of two or more species of the solid polymers can be used. The molecular weight of the solid polymer is not particularly limited, but generally from the viewpoint of processability into film, the molecular weight is 2000 to 1,000,000, preferably 1500 to 750,000, and more preferably 1000 to 500,000, based on the mass average molecular weight.

During the formation of polymer film, various additives comprising stabilizer, plasticizer, metals and the like can be blended in, if necessary. Also, for the liquefaction of solid polymer, a suitable method such as a method of heating a thermoplastic solid polymer to melt, a method of dissolving a solid polymer in a solvent to form a solution, or the like can be employed.

Solidification of the polymer spread on the cellulose acylate film (spread layer) can be carried out by cooling the spread layer for the molten liquid of the former method, and by removing the solvent to dry the spread layer for the solution of the latter method. For this drying process, one or two or more of suitable methods selected from a natural drying (air drying) method, a heat drying method, particularly a method of drying by heating at 40 to 200° C., a vacuum drying method and the like, can be employed. In view of the production efficiency or inhibiting generation of optical anisotropy, a method of coating a polymer solution is preferred.

For the solvent, one or two or more species of suitable solvents selected from methylene chloride, cyclohexanone, trichloroethylene, tetrachloroethane, N-methylpyrrolidone, tetrahydrofuran and the like, can be used. The solution preferably contains 2 to 100 parts by weight, more preferably 5 to 50 parts by weight, and particularly preferably 10 to 40 parts by weight of the polymer dissolved in 100 parts by weight of the solvent, in view of obtaining a viscosity appropriate for film formation.

For the spreading of the liquefied polymer, a suitable film forming method such as, for example, spin coating, roll coating, flow coating, printing, dip coating, flow cast film formation, bar coating, casting such as gravure printing, extrusion or the like, can be used. Among these, solution film formation such as casting can be favorably applied, from the viewpoint of mass production of films having less thickness non-uniformity, less alignment distortion and non-uniformity, or the like. In particular, it is preferable to form a film by laminating a polymer which is liquefied by dissolving in a solvent, on the cellulose acylate film by co-flow casting. In this case, polyimides prepared from aromatic dianhydrides and polyaromatic diamines, which are soluble in solvent (See JP-W No. 8-511812), can be favorably used.

The production method of the invention of spreading a liquefied polymer on a cellulose acylate film, and subjecting the polymer film to stretching or shrinking, controls Rth during the process of forming a spread layer on the cellulose acylate film layer, and control Re by stretching or shrinking the layered product and thus aligning the molecules. This role-sharing method can achieve the purpose of the invention with smaller draw ratio compared with the conventional method of simultaneously controlling Rz and Re, such as the biaxial stretching method, and has advantages in the aspects of design and production, such as that a biaxial optical compensation film having excellent characteristics of Rz and Re, and excellent accuracy in the respective optical axes can be easily obtained.

The molecule alignment treatment can be carried out by extension treatment or/and shrinking treatment of the film, and the extension treatment can be carried out by, for example, stretching or the like. For the stretching treatment, one or two or more of suitable methods selected from a biaxial stretching method such as a sequential method or a simultaneous method, a uniaxial stretching method such as a free edge method or a fixed edge method, and the like, can be applied. From the viewpoint of inhibiting the bowing phenomenon, a uniaxial stretching method is preferred.

Here, the temperature for the stretching treatment can be a conventionally used temperature, and for example, it is generally a temperature near the glass transition temperature of the solid polymer, or a temperature above the glass transition temperature. Also, for the purpose of further reducing the retardation of the stretched cellulose acylate film of the invention, the stretching temperature may be near the glass transition temperature Tg of the cellulose acylate film, and it is preferable to perform stretching at a temperature of (Tg −20° C.) or above, more preferably at a temperature of (Tg −10° C.) or above, and even more preferably at a temperature of Tg or above.

In addition, for the preferred range of draw ratio, the ratio of the film length after stretching to the film length before stretching is preferably in the range of 1.03- to 2.50-folds, more preferably in the range of 1.04- to 2.20-folds, and even more preferably 1.05- to 1.80-folds. When the draw ratio is 1.05-folds or less, the draw ratio is insufficient for the purpose of forming the above-described optically anisotropic layer, while when the draw ratio is 2.50-folds or larger, the change in curling or optical properties after the film durability test is increased.

On the other hand, the shrinking treatment can be carried out by, for example, a method of forming a polymer film by coating on a substrate, and applying a shrinking force using a dimensional change accompanied by a change in the substrate temperature, or the like. In this case, a substrate imparted with a capability of shrinking a thermoshrinkable film or the like can be used, and to this end, it is desirable to control the shrinkage rate using a stretching machine or the like.

The birefringent film produced by the above-described method is suitably used as an optical compensation film improving the viewing angle characteristics of liquid crystal displays, and also preferably used in the form of a protective film for polarizing plate directly bonded to a polarizer, for the purpose of miniaturizing liquid crystal displays and enhancing the productivity by reduction of the number of production processes. For this, it is required to provide polarizing plates employing the above-described optical compensation film with good productivity at low costs, and therefore it is desired to operate the production processes to the final production of polarizing plate with better productivity at lower costs. Here, the optical compensation film of the invention is used in the form of being bonded to a polarizer such that the direction of in-plane Re exhibition of the optically anisotropic layer is perpendicular to the absorption axis of the polarizing plate. Also, the polarizing plate having a general constitution comprising iodine and PVA is produced by longitudinal uniaxial stretching, and the absorption axis of the polarizer serves as the longitudinal direction. Further, in order to provide a polarizing plate employing an optical compensation film formed from the above-mentioned birefringent film with good productivity at low costs, it is essentially required to perform the production process consistently in a roll-to-roll mode. Based on these factors, particularly from the viewpoint of productivity, the method of producing an optical compensation film formed from the birefringent film is preferably carried out by laminating a spread layer comprising the above-mentioned polymer on the cellulose acylate film of the invention, and then performing the extension treatment or shrinking treatment so that the polymer in the spread layer is aligned in the width direction, and Re is exhibited in the width direction. Using the roll-shaped optical compensation film thus produced as a protective film for polarizer, a polarizing plate having an effective optical compensation function can be produced directly in the roll-to-roll mode.

Here, the term roll-shaped film according to the invention refers to a film having a length of 1 m or longer in the longitudinal direction and being wound up in 3 or more rounds in the longitudinal direction. Also, the term roll-to-roll means that the roll-shaped film maintains the form of being rolled before and after carrying out any operable treatment such as film formation, lamination/bonding with other roll-shaped film, surface treatment, heating/cooling treatment, extension treatment/shrinking treatment, and the like. In particular, from the viewpoint of productivity, costs or handlability, it is desirable to carry out the treatments in the roll-to-roll mode.

The magnitude of Rth and Re in the obtained birefringent film can be controlled by means of the kind of the solid polymer, the method of forming the spread layer such as the method of coating a liquefied product, the method of solidifying the spread layer such as the drying conditions, the thickness of the formed transparent film, or the like. The general thickness of the transparent film is 0.5 to 100 μm, preferably 1 to 50 μm, and particularly preferably 2 to 20 μm.

Also, the ratio of the direction perpendicular to the conveying direction in film plane/conveying direction, for the values of the properties of the cellulose acylate film of the invention in the birefringent film obtained by the aforementioned method, such as sound velocity, tensile modulus, storage modulus, photoelastic coefficient and the like, falls within the above-mentioned range.

The birefringent film produced by this method may be used without modification, or may be also used after being bonded to another film via an adhesive or the like.

(Constitution of General Liquid Crystal Display)

In the case of using the cellulose acylate film as an optical compensation film, the transmission axis of the polarizing plate and the slow axis of the optical compensation film formed from the cellulose acylate film may be disposed at any angle. A liquid crystal display has a constitution comprising a liquid crystal cell formed by supporting liquid crystals between two sheets of electrode substrates, two sheets of polarizing plates disposed on both sides thereof, and at least one sheet of optical compensation film disposed between the liquid crystal cell and the polarizing plate.

The liquid crystal layer of the liquid crystal cell is usually formed by encapsulating liquid crystals in a space formed by inserting a spacer between two sheets of substrates. The transparent electrode layer is a transparent film comprising a conductive material and is formed on the substrate. The liquid crystal cell may also have a gas barrier layer, a hard coat layer or an undercoat layer (ground coat layer) (that is used for adhesion to the transparent electrode layer) formed thereon. These layers are usually provided on the substrate. The substrate of the liquid crystal cell in general has a thickness of 50 μm to 2 mm.

(Type of Liquid Crystal Display)

The cellulose acylate film of the invention can be used in liquid crystal cells of various display modes. There have been suggested various display modes such as TN (Twisted Nematic), IPS (In-Plane Switching), FLC (Ferroelectric Liquid Crystal), AFLC (Anti-Ferroelectric Liquid Crystal), OCB (Optically Compensatory Bend), STN (Super Twisted Nematic), VA (Vertically Aligned), ECB (Electrically Controlled Birefringence) and HAN (Hybrid Aligned Nematic). Further, display modes having the above-mentioned display modes in an alignment partitioned manner are also suggested. The cellulose acylate film of the invention is effective for liquid crystal displays of any display mode. The cellulose acylate film is also effective for any liquid crystal display among the transmission type, reflection type and semi-transmission type.

(TN Type Liquid Crystal Display)

The cellulose acylate film of the invention may be used as a support for optical compensation film of the TN type liquid crystal display having a TN mode liquid crystal cell. The TN mode liquid crystal cell and the TN type liquid crystal display have been traditionally well known. Descriptions on the optical compensation film used for the TN type liquid crystal display are found in JP-A Nos. 3-9325, 6-148429, 8-50206 and 9-26572. Descriptions are also found in Mori et al., Jpn. J. Appl. Phys., Vol. 36, p. 143 (1997) or Jpn. J. Appl. Phys., Vol. 36, p. 1068 (1997).

(STN Type Liquid Crystal Display)

The cellulose acylate film of the invention may be also used as a support for optical compensation film of the STN type liquid crystal display having a STN type mode liquid crystal cell. Generally, in the STN type liquid crystal display, the rod-shaped liquid crystalline molecules in the liquid crystal cell are twisted in the range of 90 to 360°, and the product (Δnd) of the refractive index anisotropy (Δn) and the cell gap (d) of the rod-shaped liquid crystalline molecules are in the range of 300 to 1500 nm. The optical compensation sheet used for the STN type liquid crystal display is described in JP-A No. 2000-105316.

(VA Type Liquid Crystal Display)

The cellulose acylate film of the invention is particularly advantageously used as a support of optical compensation film of the VA type liquid crystal display having a VA mode liquid crystal cell. For the optical compensation film used for the VA type liquid crystal display, Re(630) is preferably 0 to 150 nm, while Rth(630) is preferably 70 to 400 nm. Re(630) is more preferably 20 to 70 nm. When two sheets of optically anisotropic polymer film are used for the VA type liquid crystal display, Rth(630) of the film is preferably 70 to 250 nm. When one sheet of optically anisotropic polymer film is used for the VA type liquid crystal display, Rth(630) of the film is preferably 150 to 400 nm. The VA type liquid crystal displays may be in an alignment partitioned mode as described in, for example, JP-A No. 10-123576.

(IPS Type Liquid Crystal Display and ECB Type Liquid Crystal Display)

The cellulose acylate film of the invention is particularly advantageously used as a support for optical compensation film of the IPS type liquid crystal display and ECB type liquid crystal display having IPS mode and ECB mode liquid crystal cells, or as a protective film for polarizing plate. These modes are embodiments in which the liquid crystal materials are aligned approximately in parallel during black display, and in a state of zero voltage application, liquid crystal molecules are aligned in parallel to the substrate surface for black display. In these embodiments, the polarizing plate employing the cellulose acylate film of the invention contributes to extension of viewing angle and enhancement of contrast. In these embodiments, the retardation values for the protective film of the polarizing plate and for the optically anisotropic layer disposed between and the protective film and the liquid crystal cell, are preferably set to a value less than or equal to twice of the Δn·d value of the liquid crystal cell. Further, since it is preferable to set the absolute value of Rth(630), |Rth(630)| to 25 nm or less, more preferably to 20 nm or less, and even more preferably to 15 nm or less, the cellulose acylate film of the invention is advantageously used.

(OCB Type Liquid Crystal Display and HAN Type Liquid Crystal Display)

The cellulose acylate film of the invention is advantageously used as a support for optical compensation film of the OCB type liquid crystal display having an OCB mode liquid crystal cell or the HAN type liquid crystal display having a HAN mode liquid crystal cell. For the optical compensation film used for the OCB type liquid crystal display or HAN type liquid crystal display, it is desirable that the direction in which the absolute values of the retardations are minimal does not exist in plane or in the normal direction of the optical compensation film. The optical properties of the optical compensation film used for the OCB type liquid crystal display or HAN type liquid crystal display are also determined by the optical properties of the optically anisotropic layer, optical properties of the support, and the disposition of the optically anisotropic layer and the support. Descriptions on the optical compensation film used for the OCB type liquid crystal display or HAN type liquid crystal display are found in JP-A No. 9-197397, and an article of Mori et al. (Jpn. J. Appl. Phys., Vol. 38, p. 2837 (1999)).

(Reflection Type Liquid Crystal Display)

The cellulose acylate film of the invention is advantageously used as an optical compensation film for reflection type liquid crystal displays of the TN type, STN type, HAN type and GH (Guest-Host) type. These display modes have been traditionally well known. Descriptions on the TN type refection type liquid crystal display are found in JP-A No. 10-123478, WO 98/48320 and JP No. 3022477. Descriptions on the optical compensation sheet used for the reflection type liquid crystal display are found in WO 00/65384.

(Other Liquid Crystal Display)

The cellulose acylate film of the invention is advantageously used as a support for optical compensation film of the ASM (Axially Symmetric Aligned Microcell) type liquid crystal display having an ASM mode liquid crystal cell. The ASM mode liquid crystal cell is characterized in that the cell thickness is maintained by a resin spacer capable of position adjustment. Other properties are the same as those of the TN mode liquid crystal cell. The ASM mode liquid crystal cell and the ASM type liquid crystal display are described in an article by Kume et al. (Kume et al., SID 98 Digest, p. 1089 (1998)).

(Self-Luminous Type Display Device)

The optical compensation film, polarizing plate and the like of the invention can be also used in self-luminous type display devices to attempt an enhancement of display quality and the like. The self-luminous type display device is not particularly limited, and examples thereof include organic EL, PDP, FED and the like. When a birefringent film having an Re value equal to one-quarter of the wavelength is applied to a self-luminous type flat panel display, linear polarization can be converted to radial polarization, thus forming an anti-reflection filter.

For this, the constituting elements of a display device such as a liquid crystal display or the like may be stacked into one body, or may be in a separated state. In addition, upon the formation of a display device, for example, appropriate optical devices such as, for example, prism array sheet, lens array sheet, light diffusion plate, protective plate and the like, can be appropriately disposed. The above-described devices may be supplied for the formation of display devices in the above-described optical element form formed by laminating with the optical compensation film.

(Hard Coat Film, Antiglare Film, Antireflection Film)

The cellulose acylate film of the invention can be also favorably subjected to application of a hard coat film, an antiglare film or an antireflection film. For the purpose of improving visibility of flat panel displays such as LCD, PDP, CRT, EL and the like, any or all of the hard coat layer, antiglare layer and antireflection layer can be provided to one surface or both surfaces of the cellulose acylate film of the invention. A preferred embodiment as such antiglare film or antireflection film is described in detail in the Technical Report of Japan Institute of Invention and Innovation (Technology No. 2001-1745 (published on Mar. 15, 2001 by Japan Institute of Invention and Innovation)), pp. 54-57, and the cellulose acylate film of the invention can be preferably used.

(Photographic Film Support)

The cellulose acylate film of the invention can be also applied as a support for silver halide photographic photosensitive materials. For the relevant technology, detailed description on color negatives is found in JP-A No. 2000-105445, and the cellulose acylate film of the invention is favorably used therefor. Application as a support for color reverse silver halide photographic photosensitive materials is also desirable, and thus various materials or formulations and further treatment methods described in JP-A No. 11-282119 can be applied.

(Transparent Substrate)

The cellulose acylate film of the invention has optical anisotropy close to zero and has excellent transparency, and thus can be used as a substitute of the liquid crystal cell glass substrate, that is, a transparent substrate encapsulating driving liquid crystals, in the liquid crystal displays.

Since the transparent substrate encapsulating liquid crystals needs to have excellent gas barrier property, if necessary, a gas barrier layer may be formed on the surface of the cellulose acylate film of the invention. The form or material of the gas barrier layer is not particularly limited, but a method of depositing SiO₂ or the like on at least one surface of the cellulose acylate film of the invention, or a method of providing a coat layer comprising a polymer having relatively high gas barrier property, such as vinylidene chloride polymers or vinyl alcohol polymers, can be considered, and these methods can be appropriately used.

Also, in order to use the cellulose acylate film as the transparent substrate encapsulating liquid crystals, a transparent electrode for driving liquid crystals by voltage application may be formed. The transparent electrode is not particularly limited, but a transparent electrode can be provided by laminating a metallic film, a metal oxide film or the like on at least one surface of the cellulose acylate film of the invention. Inter alia, from the viewpoint of transparency, conductivity, and mechanical properties, metal oxide films are preferred, and among them, a thin film of indium oxide containing 2 to 15% of mainly tin oxide with zinc oxide can be favorably used. Details of these technologies are described in, for example, JP-A No. 2001-125079, JP-A No. 2000-227603 and the like.

Hereinafter, the present invention will be further described by the following examples which are not to be construed to limit the invention.

### EXAMPLE 1

≦Preparation of Cellulose Acylate Solution>

After a composition disclosed in Tables 1 and 1-2 was put in a pressure-resistant mixing tank and agitated for 1 hour, it was agitated for 6 hours while it was heated to 80° C. to dissolve components, to prepare cellulose acylate solutions T-1 to T-12, T-21 to T-23, and T-31 to T-33. In addition, in a parenthesis of a column of the degree of substitution in Tables 1 and 1-2, a group name of a substituted acyl group is shown.

≦R of Additives to be Used>

Furthermore, an R value of a used main additive was obtained using the method disclosed in the specification, and the results are shown in Tables 2 and 2-2.

TABLE 1
Composition of Cellulose Acylate Solution (unit: parts by weight)

| Cellulose | | | | Cellulose acylate | | | |
|---|---|---|---|---|---|---|---|
| acylate | Methylene | | 1- | Degree of | Amount of | | |
| solution | chloride | Methanol | Butanol | substitution | addition | Additive | |
| T-1 | 300 | 54 | 11 | 2.86 (acetyl) | 100 | TPP/DBP | 7.8/3.9 |
| T-2 | 300 | 54 | 11 | 2.86 (acetyl) | 100 | Comparative | 8.0 |
| | | | | | | compound 1 | |
| T-3 | 300 | 54 | 11 | 2.86 (acetyl) | 100 | Comparative | 8.0 |
| | | | | | | compound 2 | |
| T-4 | 300 | 54 | 11 | 2.86 (acetyl) | 100 | SA-17 | 9.0 |
| T-5 | 300 | 54 | 11 | 2.86 (acetyl) | 100 | SA-17 | 12.0 |
| T-6 | 300 | 54 | 11 | 2.94 (acetyl) | 100 | SC-1 | 12.0 |
| T-7 | 300 | 54 | 11 | 2.86 (acetyl) | 100 | CA-5 | 8.5 |
| T-8 | 300 | 54 | 11 | 2.86 (acetyl) | 100 | CA-5 | 11.7 |
| T-9 | 300 | 54 | 11 | 2.94 (acetyl) | 100 | A-14 | 9.0 |
| T-10 | 300 | 54 | 11 | 2.94 (acetyl) | 100 | A-14 | 12.0 |
| T-11 | 300 | 54 | 11 | 2.90 (acetyl) | 100 | B-1 | 12.0 |

| | | | | | | |
|---|---|---|---|---|---|---|
| T-12 | 342 | Ethanol 23 | 2.92 (acetyl) | 100 | KE-604/KE-85 | 10/10 |

TABLE 1-2
Composition of Cellulose Acylate Solution (unit: parts by weight)

| Cellulose | | | | Cellulose acylate | | | |
|---|---|---|---|---|---|---|---|
| acylate | Methylene | | 1- | Degree of | Amount of | | |
| solution | chloride | Methanol | Butanol | substitution | addition | Additive | |
| T-21 | 300 | 54 | 11 | 2.91 (acetyl) | 100 | TA-1 | 12.0 |
| T-22 | 300 | 54 | 11 | 2.91 (acetyl) | 100 | TA-4 | 12.0 |
| T-23 | 300 | 54 | 11 | 2.91 (acetyl) | 100 | TB-18 | 12.0 |
| T-31 | 311 | 54 | — | 2.38/0.34 | 100 | A-14 | 12.0 |
| | | | | (acetyl/aromatic | | | |
| | | | | acyl gr. No.1) | | | |
| T-32 | 311 | 54 | — | 2.38/0.34 | 100 | B-6 | 12.0 |
| | | | | (acetyl/aromatic | | | |
| | | | | acyl gr. No.1) | | | |
| T-33 | 311 | 54 | — | 2.38/0.34 | 100 | CA-5 | 12.0 |
| | | | | (acetyl/aromatic | | | |
| | | | | acyl gr. No.1) | | | |

TPP: triphenyl phosphate
BDP: biphenyldiphenyl phosphate
KE-604, KE-85: manufactured by Arakawa Chemical Industries, Ltd.

Comparative compound 1:

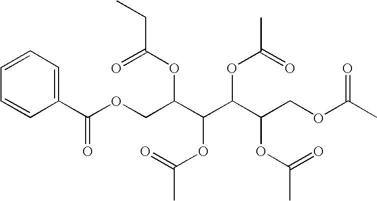

Comparative compound 2: trimethylolpropanetri-2-cyclohexylpropanoate

TABLE 2
R Value of Compound

| Additive | R value |
|---|---|
| TPP/BDP | 0.92/0.94 |
| Comparative compound 1 | 0.91 |
| Comparative compound 2 | 0.95 |
| SA-17 | 0.61 |
| BA-1 | 0.52 |
| CA-5 | 0.64 |
| A-14 | 0.71 |
| B-1 | 0.65 |
| SC-1 | 0.76 |
| KE-604/KE-85 | 0.91/0.92 |

TABLE 2-2
R Value of Compound

| Additive | R value |
|---|---|
| TA-1 | 0.72 |
| TA-4 | 0.71 |
| TB-18 | 0.74 |

≦Preparation of Additive Solution>

A composition disclosed in Table 3 was put in a pressure-resistant mixing tank and agitated at 39° C. to dissolve components, to prepare additive solutions U-1 to U-5.

TABLE 3

| | Prescription | | | |
|---|---|---|---|---|
| | Methylene | | Wavelength dispersion | |
| | chloride | Methanol | controlling agent | |
| Additive | Amount of | Amount of | | Amount of |
| solution | addition | addition | Type | addition |
| U-1 | 80 parts by | 20 parts by | UV-3/UV-7 | 2 parts by |
| | weight | weight | | weight/ |
| | | | | 4 parts |
| | | | | by weight |
| U-2 | 80 parts by | 20 parts by | — | — |
| | weight | weight | | |
| U-3 | 80 parts by | 20 parts by | UV-23 | 15 parts by |
| | weight | weight | | weight |
| U-4 | 80 parts by | 20 parts by | UVA19 | 15 parts by |
| | weight | weight | | weight |
| U-5 | 80 parts by | 20 parts by | Cinubin | 2 parts by |
| | weight | weight | 236/Cinubin 238 | weight/ |
| | | | | 2 parts |
| | | | | by weight |

Cinubin 236, Cinubin 238: Products manufactured by Ciba Specialty Chemicals K.K.

≦Production of Cellulose Acylate Film Sample 001>

44 parts by weight of the additive solution U-1 was added to 477 parts by weight of the cellulose acylate solution T-1 in a pressure-resistant mixing tank, sufficiently agitated at 80° C. for 4 hours, and left at room temperature to be cooled, to prepare a dope. After the controlled dope was flow cast at a dope temperature of 35° C. on a band-shaped support made of stainless steel at 10° C. using a band flow casting machine, drying was conducted using a drying wind at 75° C. on the support, a temperature of which was slowly controlled from 10° C. to 35° C. by blowing a temperature control wind at 35° C. to a rear side of the support, it was detached from the band while the residual solvent amount was 35% by weight, both side edges of the film in the cross direction (the direction was perpendicular to the flow casting direction) were fixed with pin tenters (the pin tenter is disclosed in FIG. 3 of JP-A No. 4-1009), and drying was conducted using a drying wind at 110° C. until the residual solvent amount was 10% or less. Next, the film was conveyed between rolls of a heat treatment machine and thus further dried to produce a cellulose acylate film sample 001 having a thickness of 80 μm which was 100 m long (flow casting direction) and 1 m wide.

≦Production of Cellulose Acylate Film Sample 002>

A film sample 002 was produced in the same manner as in the method for producing the cellulose acylate film sample 001, except that the dope was flow cast on a band-shaped support made of stainless steel at 10° C. while the dope temperature was 55° C.

≦Production of Cellulose Acylate Film Sample 003>

A cellulose acylate film sample 003 having a thickness of 80 μm which was 100 m long (flow casting direction) and 1 m wide was produced in the same manner as in the method for producing the cellulose acylate film sample 001, except that 477 parts by weight of T-2 was used as the cellulose acylate solution and 44 parts by weight of U-2 was used as the additive solution.

≦Production of Cellulose Acylate Film Sample 004>

A cellulose acylate film sample 004 having a thickness of 80 μm which was 100 m long (flow casting direction) and 1 m wide was produced in the same manner as in the method for producing the cellulose acylate film sample 001, except that 477 parts by weight of T-3 was used as the cellulose acylate solution and 44 parts by weight of U-2 was used as the additive solution.

≦Production of Cellulose Acylate Film Sample 005>

A film sample 005 was produced in the same manner as in the method for producing the cellulose acylate film sample 001, except that 477 parts by weight of T-4 was used as the cellulose acylate solution and 44 parts by weight of U-2 was used as the additive solution, and that drying was conducted using a drying wind at 35° C. on the support, a temperature of which was slowly controlled from 10° C. to 35° C. by blowing a temperature control wind at 35° C. to a rear side of the support.

≦Production of Cellulose Acylate Film Sample 006>

A cellulose acylate film sample 006 having a thickness of 80 μm which was 100 m long (flow casting direction) and 1 m wide was produced in the same manner as in the method for producing the cellulose acylate film sample 001, except that 477 parts by weight of T-4 was used as the cellulose acylate solution and 44 parts by weight of U-2 was used as the additive solution, and that drying was conducted using a drying wind at 210° C. on the support, a temperature of which was slowly controlled from 10° C. to 35° C. by blowing a temperature control wind at 35° C. to a rear side of the support.

≦Production of Cellulose Acylate Film Samples 101 to 106, 108 to 109, 121 to 123 and 131 to 133>

Cellulose acylate film samples 101 to 106, 108 to 109, 121 to 123 and 131 to 133 having a thickness of 80 μm which were 100 m long (flow casting direction) and 1 m wide were produced by the method that was the same as the method for producing the cellulose acylate film sample 001, except that the cellulose acylate solution and the additive solution as disclosed in Tables 4 and 4-2 were used.

≦Production of Cellulose Acylate Film Samples 107, and 110 to 111>

Cellulose acylate film samples 107, and 110 to 111 having a thickness of 80 μm which were 100 m long (flow casting direction) and 1 m wide were produced by the method that was the same as the method for producing the cellulose acylate film sample 001, except that the cellulose acylate solution and the additive solution as disclosed in Table 4 were used, and that the temperature of the drying wind on the support was set to 60° C.

≦Production of Cellulose Acylate Film Sample 201>

44 parts by weight of additive solution U-5 was added to 477 parts by weight of the cellulose acylate solution T-13, and the mixture was sufficiently agitated to prepare a dope. A cellulose acylate film sample 201 having a thickness of 80 μm was produced using the prepared dope by the method that was the same as the method for producing the film sample 001, except that drying was conducted using a drying wind at 45° C. on the support, a temperature of which was slowly controlled from 10° C. to 35° C. by blowing a temperature control wind at 35° C. to a rear side of the support.

TABLE 4

| | Cellulose | | | |
|---|---|---|---|---|
| Cellulose | acylate solution | | Additive solution | |
| acylate film | Type | Amount of addition | Type | Amount of addition |
| 001 | T-1 | 477 parts by weight | U-1 | 44 parts by weight |
| 002 | T-1 | 477 parts by weight | U-1 | 44 parts by weight |
| 003 | T-2 | 477 parts by weight | U-2 | 44 parts by weight |
| 004 | T-3 | 477 parts by weight | U-2 | 44 parts by weight |
| 005 | T-4 | 477 parts by weight | U-2 | 44 parts by weight |
| 006 | T-4 | 477 parts by weight | U-2 | 44 parts by weight |
| 101 | T-4 | 477 parts by weight | U-2 | 44 parts by weight |
| 102 | T-5 | 477 parts by weight | U-3 | 44 parts by weight |
| 103 | T-6 | 477 parts by weight | U-2 | 44 parts by weight |
| 104 | T-7 | 477 parts by weight | U-2 | 44 parts by weight |
| 105 | T-8 | 477 parts by weight | U-3 | 44 parts by weight |
| 106 | T-8 | 477 parts by weight | U-4 | 44 parts by weight |
| 107 | T-7 | 477 parts by weight | U-2 | 44 parts by weight |
| 108 | T-9 | 477 parts by weight | U-2 | 44 parts by weight |
| 109 | T-10 | 477 parts by weight | U-3 | 44 parts by weight |
| 110 | T-10 | 477 parts by weight | U-4 | 44 parts by weight |
| 111 | T-11 | 477 parts by weight | U-2 | 44 parts by weight |
| 201 | T-12 | 477 parts by weight | U-5 | 44 parts by weight |

TABLE 4-2

| | Cellulose | | | |
|---|---|---|---|---|
| Cellulose | acylate solution | | Additive solution | |
| acylate film | Type | Amount of addition | Type | Amount of addition |
| 121 | T-21 | 477 parts by weight | U-1 | 44 parts by weight |
| 122 | T-22 | 477 parts by weight | U-1 | 44 parts by weight |
| 123 | T-23 | 477 parts by weight | U-2 | 44 parts by weight |
| 131 | T-31 | 477 parts by weight | U-2 | 44 parts by weight |
| 132 | T-32 | 477 parts by weight | U-2 | 44 parts by weight |
| 133 | T-33 | 477 parts by weight | U-2 | 44 parts by weight |

<Evaluation of Optical Performance>

For each of the produced samples, optical performances, such as Re(630), Rth(630), ΔRe=|Re(400)−Re(700)|, and ΔRth=|Rth(400)−Rth(700)|, were evaluated according to the method specification.

<Evaluation of Humidity Dependency of Optical Performance>

For each of the produced samples, Re(X %) and Rth(X %) were measured under all conditions using the samples which were humidified for 6 hours or more in a measurement atmosphere of 25° C./10% RH or 25° C./80% RH.

<Evaluation of Equilibrium Water Content of Film>

For each of the produced samples, equilibrium water contents were obtained using the samples which were humidified for 6 hours or more under the conditions of 25° C. and 10% RH and 25° C. and 80% RH by the method disclosed in the specification under all conditions.

<A of the Film>

Furthermore, A was determined by the method disclosed in the specification using the above-mentioned humidity dependency of the optical performance and the equilibrium water content of the film.

Evaluation results of each of the produced samples are shown in Tables 5 and 5-2. In addition in Table 5, Re(λ) denotes Re(630), Rth(λ) denotes Rth(630), ΔRe(λ) denotes |Re(400)−Re(700)|, ΔRth(λ) denotes |Rth(400)−Rth(700)|.

TABLE 5

| | | | | | | | | | | Equilibrium | | |
|---|---|---|---|---|---|---|---|---|---|---|---|---|
| | | Optical performance | | | | | | | | water | | Equation of |
| | | Re | | | Rth | | | Wavelength | | content | | humidity |
| | | 25° C. | 25° C. | 25° C. | 25° C. | 25° C. | 25° C. | dispersion | | 25° C. | 25° C. | dependency |
| | | 60% | 10% | 80% | 60% | 10% | 80% | ΔRe | ΔRth | 10% | 80% | A value |
| Comp. | 001 | 2.1 | 1.4 | 2.5 | 43.7 | 67.4 | 34.2 | 2.2 | 22.5 | 0.26 | 2.81 | 13.02 |
| Ex. | | | | | | | | | | | | |
| Comp. | 002 | 2.1 | 1.1 | 2.8 | 48.5 | 75.5 | 37.7 | 1.5 | 19.8 | 0.29 | 2.62 | 16.22 |
| Ex. | | | | | | | | | | | | |
| Comp. | 003 | 1.2 | 2.1 | 0.6 | 1.8 | 29.0 | −9.1 | 2.1 | 28.1 | 0.31 | 3.14 | 13.46 |
| Ex. | | | | | | | | | | | | |
| Comp. | 004 | 1.5 | 2.3 | 1.1 | 16.5 | 41.6 | 6.5 | 2.4 | 27.5 | 0.29 | 2.85 | 13.71 |
| Ex. | | | | | | | | | | | | |
| Comp. | 005 | 0.9 | 1.3 | 0.7 | 2.1 | 26.5 | −7.7 | 2.3 | 22.1 | 0.31 | 2.72 | 14.19 |
| Ex. | | | | | | | | | | | | |
| Comp. | 006 | 1.5 | 2.5 | 0.8 | 6.5 | 30.5 | −3.1 | 2.3 | 22.1 | 0.34 | 2.95 | 12.87 |
| Ex. | | | | | | | | | | | | |
| Ex. | 101 | 0.6 | 0.7 | 0.5 | −3.2 | 15.2 | −10.6 | 1.7 | 21.5 | 0.26 | 2.73 | 10.45 |
| Ex. | 102 | 0.8 | 1.2 | 0.6 | −1.5 | 17.9 | −9.2 | 1.4 | 12.3 | 0.26 | 2.73 | 10.97 |
| Ex. | 103 | 0.9 | 1.1 | 0.8 | −4.1 | 14.6 | −11.6 | 1.6 | 20.4 | 0.28 | 2.82 | 10.31 |
| Ex. | 104 | 1.5 | 2.5 | 1.2 | −3.8 | 14.3 | −11.0 | 2.3 | 26.6 | 0.38 | 3.85 | 7.29 |
| Ex. | 105 | 1.9 | 2.5 | 1.7 | −4.1 | 13.5 | −11.1 | 1.5 | 8.5 | 0.38 | 3.41 | 8.12 |
| Ex. | 106 | 2 | 2.6 | 1.8 | −2.5 | 14.7 | −9.4 | 1.4 | 10.4 | 0.38 | 3.31 | 8.23 |
| Ex. | 107 | 1.7 | 2.3 | 1.5 | −2.4 | 17.0 | −10.1 | 2.3 | 26.1 | 0.38 | 3.64 | 8.31 |
| Ex. | 108 | 1.5 | 2.1 | 1.3 | −3.1 | 14.6 | −10.2 | 1.8 | 19.5 | 0.36 | 3.72 | 7.38 |
| Ex. | 109 | 1.7 | 2.1 | 1.5 | −4.1 | 13.4 | −11.1 | 1.4 | 8.1 | 0.36 | 3.31 | 8.31 |
| Ex. | 110 | 1.7 | 2.1 | 1.5 | −3.2 | 13.8 | −10.0 | 1.4 | 7.3 | 0.36 | 3.25 | 8.24 |
| Ex. | 111 | 1.5 | 2.2 | 1.2 | −3.2 | 16.2 | −10.9 | 2.1 | 26.2 | 0.36 | 3.55 | 8.50 |
| Comp. | 201 | 3.2 | 5.3 | 2.7 | 5.2 | 31.5 | −5.3 | 2.3 | 20.5 | 0.31 | 3.03 | 13.53 |
| Ex. | | | | | | | | | | | | |

TABLE 5-2

| | | | | | | | | | | Equilibrium | | |
|---|---|---|---|---|---|---|---|---|---|---|---|---|
| | | Optical performance | | | | | | | | water | | Equation of |
| | | Re | | | Rth | | | Wavelength | | content | | humidity |
| | | 25° C. | 25° C. | 25° C. | 25° C. | 25° C. | 25° C. | dispersion | | 25° C. | 25° C. | dependency |
| | | 60% | 10% | 80% | 60% | 10% | 80% | ΔRe | ΔRth | 10% | 80% | A value |
| Ex. | 121 | 1.2 | 1.5 | 2.1 | −5.3 | 12.5 | −13.9 | 2.1 | 22.1 | 0.28 | 3.21 | 9.01 |
| Ex. | 122 | 1 | 1.4 | 2 | 3.5 | 19.6 | −5.9 | 1.8 | 21.3 | 0.31 | 3.29 | 8.56 |
| Ex. | 123 | 1.3 | 1.7 | 2.3 | −2.2 | 14.4 | −10.5 | 1.6 | 19.2 | 0.27 | 3.14 | 8.68 |
| Ex. | 131 | 3.1 | 4.5 | 2.2 | −3.5 | 8.5 | −6.1 | 2.5 | 14.6 | 0.25 | 1.91 | 8.68 |
| Ex. | 132 | 3.6 | 4.6 | 2.3 | 1.2 | 11.5 | −2.6 | 3.1 | 14.1 | 0.27 | 1.87 | 8.81 |
| Ex. | 133 | 2.8 | 4.1 | 1.9 | −4.1 | 6.1 | −7.3 | 2.5 | 13.4 | 0.23 | 1.75 | 8.82 |

### EXAMPLE 2

17% by weight of the cyclohexanone solution of polyimide (weight average molecular weight (Mw) was 60,000), which was synthesized from 2,2′-bis(3,4-dicarboxyphenyl)hexafluoropropane and 2,2′-bis(trifluoromethyl)-4,4′-diaminobiphenyl, was applied on the cellulose acylate film sample 001 produced above, and dried at 95° C. for 12 minutes to obtain a transparent film in which a residual solvent amount was 6% by weight, a thickness was 6 μm, |Rth(630)| was 233 nm, and Re(630) was 0 nm. While it was layered on the film sample 001, unidirectional drawing treatment was horizontally conducted by 18% so that a glass transition temperature (Tg) of the polymer film was −5° C. to obtain an optical compensation film 001E having an optically anisotropic layer in which Re(630) was 55 nm and |Rth(630)| was 238 nm.

(Production of Optical Compensation Films of Samples 002 to 006, 101 to 112, 201, 121 to 123 and 131 to 133)

In addition, for the cellulose acylate film samples 002 to 006, 101 to 112, 201, 121 to 123 and 131 to 133, optical compensation film samples were produced through the same manner.

≦Alkali Saponification Treatment>

Next, for the optical compensation film sample 001, the following surface treatment was conducted.

The produced optical compensation film sample 001 was dipped in a 1.5 N aqueous sodium hydroxide solution at 55° C. for 2 minutes. It was washed with water in a bath at room temperature, and neutralized using a 0.1 N sulfuric acid at 30° C. In addition, it was washed with water in the bath at room temperature, and dried with a warm wind at 100° C. Thereby, a sample in which a surface of the cellulose acylate film was subjected to alkali saponification was produced.

Furthermore, for the optical compensation film samples 002 to 006, 101 to 112, 201, 121 to 123 and 131 to 133, the optical compensation film samples 002 to 006, 101 to 112, 201, 121 to 123 and 131 to 133 which were completely surface treated through the same manner were produced.

≦Production of Polarizing Plate>

A rolled polyvinyl alcohol film of a thickness of 80 μm was continuously stretched 5 times in an aqueous iodine solution and dried to obtain a polarizing film of a thickness of 30 μm. A surface (surface-treated surface) of each of the aforementioned surface-treated optical compensation film samples Nos. 001, 004, 007, 101-112, 201, 121-123 and 131-133 and, on the other side, a commercial cellulose acetate film (Fujitac TD80UF, manufactured by Fuji Photo Film Co., Re(630)=3 nm, |Rth(630)|=50 nm), subjected to an alkaline saponification in a similar manner as explained above, were prepared, and the prepared polarizing film was sandwiched between these films, which were placed with the treated surfaces thereof toward the polarizing film and adhered with a polyvinyl alcohol-type adhesive thereto, thereby obtaining a polarizing plate with an optical compensation film.

Furthermore, alkali saponification treatment, the application of the adhesive layer, and bonding of commercial cellulose acetate films (Fuji tuck TD80UF manufactured by Fuji Photo Film Co., Ltd., Re was 3 nm, and Rth was 50 nm) to both sides of the polarizing film were conducted through the same manner to produce a polarizing plate 301.

(Mounting Evaluation for VA Type Liquid Crystal Display)

≦Production of a Vertically Aligned Liquid Crystal Cell>

1 mass % of octadecyldimethylammonium chloride (a coupling agent) was added to 3% by weight of an aqueous polyvinyl alcohol solution. A glass substrate having an ITO electrode was spin coated with the resulting mixture, heat treated at 160° C., and then subjected to rubbing treatment to form a vertically aligned film. Two glass substrates were subjected to the rubbing treatment in opposite directions. The two glass substrates were set to face each other so that a cell gap (d) was about 4.3 μm. A liquid crystal compound including esters and ethanes as main components (Δn: 0.06) was injected into the cell gap to produce a vertically aligned liquid crystal cell. Δn times d was 260 nm.

An optically anisotropic layer side of the polarizing plate sample 001 having the optical compensation film was bonded to the liquid crystal cell using an adhesive, and the polarizing plate 301 was bonded to the liquid crystal cell using the adhesive so that the polarizing plate facing a side of the liquid crystal cell was perpendicular to an absorption axis to produce a VA type liquid crystal display.

In addition, a VA type liquid crystal display was produced using the polarizing plate samples 002 to 006, 101 to 112, 201, 121 to 123 and 131 to 133 having the optical compensation film.

≦Evaluation Test>

(Evaluation of Panel)

≦Evaluation of Humidity Dependency of Display Performance and Durability of Liquid Crystal Display>

Viewing angle dependency of transmittance of the produced liquid crystal display was measured. An elevation angle was measured moving from a front side to 80° in an inclined direction every 10°, and an angle of direction was measured moving from a horizontal right direction (0°) as a basis to 360° every 10°. It can be seen that brightness at a black display is increased by leaked light as the elevation angle rises from the front side direction, and that brightness reaches the maximum value at the elevation angle of around 70°. In addition, it can be seen that, since brightness at the black display is increased, contrast is poor. Accordingly, a difference between brightness of the front side at the black display and the maximum value of brightness at the elevation angle of 60° at an angle of direction ranging from 0 to 360° was used as a light leakage amount to evaluate a contrast change of the viewing angle. With respect to the display performances, humidification was conducted in atmospheres of 25° C. and 60% RH and 25° C. and 10% RH for 6 hours, and measurement was then conducted to evaluate humidity dependency of the display performance.
Light leakage=(maximum value of brightness at elevation angle of 60°)−(brightness of front side)

The obtained results are shown in Tables 6 and 6-2.

TABLE 6

| | | | | | | | | | | | | | | Light leakage | |
|---|---|---|---|---|---|---|---|---|---|---|---|---|---|---|---|
| | | | | | | | | | | | | | | during panel | |
| | | | | | | | | | | | | | | black display | |
| | | Optical performance | | | | | | | | Equilibrium | | Equation of | | 25° C. | 25° C. |
| | | Re | | | Rth | | | Wavelength | | water content | | humidity | Film | 60% | 10% |
| | | 25° C. | 25° C. | 25° C. | 25° C. | 25° C. | 25° C. | dispersion | | 25° C. | 25° C. | dependency | sam- | Light | Light |
| | | 60% | 10% | 80% | 60% | 10% | 80% | ΔRe | ΔRth | 10% | 80% | A value | ple | leakage | leakage |
| Comp. Ex. | 001 | 2.1 | 1.4 | 2.5 | 43.7 | 67.4 | 34.2 | 2.2 | 22.5 | 0.26 | 2.81 | 13.02 | 001 | 0.48 | 0.67 |
| Comp. Ex. | 002 | 2.1 | 1.1 | 2.8 | 48.5 | 75.5 | 37.7 | 1.5 | 19.8 | 0.29 | 2.62 | 16.22 | 002 | 0.52 | 0.81 |
| Comp. Ex. | 003 | 1.2 | 2.1 | 0.6 | 1.8 | 29.0 | −9.1 | 2.1 | 28.1 | 0.31 | 3.14 | 13.46 | 003 | 0.09 | 0.41 |
| Comp. Ex. | 004 | 1.5 | 2.3 | 1.1 | 16.5 | 41.6 | 6.5 | 2.4 | 27.5 | 0.29 | 2.85 | 13.71 | 004 | 0.21 | 0.35 |
| Comp. Ex. | 005 | 0.9 | 1.3 | 0.7 | 2.1 | 26.5 | −7.7 | 2.3 | 22.1 | 0.31 | 2.72 | 14.19 | 005 | 0.11 | 0.36 |
| Comp. Ex. | 006 | 1.5 | 2.5 | 0.8 | 6.5 | 30.5 | −3.1 | 2.3 | 22.1 | 0.34 | 2.95 | 12.87 | 006 | 0.12 | 0.38 |
| Ex. | 101 | 0.6 | 0.7 | 0.5 | −3.2 | 15.2 | −10.6 | 1.7 | 21.5 | 0.26 | 2.73 | 10.45 | 101 | 0.07 | 0.16 |
| Ex. | 102 | 0.8 | 1.2 | 0.6 | −1.5 | 17.9 | −9.2 | 1.4 | 12.3 | 0.26 | 2.73 | 10.97 | 102 | 0.03 | 0.19 |
| Ex. | 103 | 0.9 | 1.1 | 0.8 | −4.1 | 14.6 | −11.6 | 1.6 | 20.4 | 0.28 | 2.82 | 10.31 | 103 | 0.07 | 0.16 |
| Ex. | 104 | 1.5 | 2.5 | 1.2 | −3.8 | 14.3 | −11.0 | 2.3 | 26.6 | 0.38 | 3.85 | 7.29 | 104 | 0.08 | 0.16 |
| Ex. | 105 | 1.9 | 2.5 | 1.7 | −4.1 | 13.5 | −11.1 | 1.5 | 8.5 | 0.38 | 3.41 | 8.12 | 105 | 0.03 | 0.14 |
| Ex. | 106 | 2 | 2.6 | 1.8 | −2.5 | 14.7 | −9.4 | 1.4 | 10.4 | 0.38 | 3.31 | 8.23 | 106 | 0.03 | 0.14 |
| Ex. | 107 | 1.7 | 2.3 | 1.5 | −2.4 | 17.0 | −10.1 | 2.3 | 26.1 | 0.38 | 3.64 | 8.31 | 107 | 0.08 | 0.21 |
| Ex. | 108 | 1.5 | 2.1 | 1.3 | −3.1 | 14.6 | −10.2 | 1.8 | 19.5 | 0.36 | 3.72 | 7.38 | 108 | 0.07 | 0.16 |
| Ex. | 109 | 1.7 | 2.1 | 1.5 | −4.1 | 13.4 | −11.1 | 1.4 | 8.1 | 0.36 | 3.31 | 8.31 | 109 | 0.03 | 0.13 |
| Ex. | 110 | 1.7 | 2.1 | 1.5 | −3.2 | 13.8 | −10.0 | 1.4 | 7.3 | 0.36 | 3.25 | 8.24 | 110 | 0.03 | 0.13 |
| Ex. | 111 | 1.5 | 2.2 | 1.2 | −3.2 | 16.2 | −10.9 | 2.1 | 26.2 | 0.36 | 3.55 | 8.50 | 111 | 0.04 | 0.15 |
| Comp. Ex. | 201 | 3.2 | 5.3 | 2.7 | 5.2 | 31.5 | −5.3 | 2.3 | 20.5 | 0.31 | 3.03 | 13.53 | 201 | 0.11 | 0.38 |

TABLE 6-2

| | | | | | | | | | | | | | | Light leakage | |
|---|---|---|---|---|---|---|---|---|---|---|---|---|---|---|---|
| | | | | | | | | | | | | | | during panel | |
| | | | | | | | | | | | | | | black display | |
| | | Optical performance | | | | | | | | Equilibrium | | Equation of | | 25° C. | 25° C. |
| | | Re | | | Rth | | | Wavelength | | water content | | humidity | Film | 60% | 10% |
| | | 25° C. | 25° C. | 25° C. | 25° C. | 25° C. | 25° C. | dispersion | | 25° C. | 25° C. | dependency | sam- | Light | Light |
| | | 60% | 10% | 80% | 60% | 10% | 80% | ΔRe | ΔRth | 10% | 80% | A value | ple | leakage | leakage |
| Example | 121 | 1.2 | 1.5 | 2.1 | −5.3 | 12.5 | −13.9 | 2.1 | 22.1 | 0.28 | 3.21 | 9.01 | 121 | 0.04 | 0.20 |
| Example | 122 | 1 | 1.4 | 2 | 3.5 | 19.6 | −5.9 | 1.8 | 21.3 | 0.31 | 3.29 | 8.56 | 122 | 0.12 | 0.24 |
| Example | 123 | 1.3 | 1.7 | 2.3 | −2.2 | 14.4 | −10.5 | 1.6 | 19.2 | 0.27 | 3.14 | 8.68 | 123 | 0.07 | 0.21 |
| Example | 131 | 3.1 | 4.5 | 2.2 | −3.5 | 8.5 | −6.1 | 2.5 | 14.6 | 0.25 | 1.91 | 8.80 | 131 | 0.06 | 0.16 |
| Example | 132 | 3.6 | 4.6 | 2.3 | 1.2 | 11.5 | −2.6 | 3.1 | 14.1 | 0.27 | 1.87 | 8.81 | 132 | 0.10 | 0.19 |
| Example | 133 | 2.8 | 4.1 | 1.9 | −4.1 | 6.1 | −7.3 | 2.5 | 13.4 | 0.23 | 1.75 | 8.82 | 133 | 0.06 | 0.14 |

From the results of Table 6, it can be seen that a viewing angle property of the liquid crystal display using the sample of the invention is fair.

From the above-mentioned results, it was confirmed that a cellulose acylate film of the invention had low humidity dependency of optical performance, and as a result, humidity dependency of a viewing angle property was low when it was used as a protective film of a polarizing plate for a liquid crystal display, thereby environmental dependency thereof was reduced. Meanwhile, it was confirmed that, if a production method did not satisfy conditions of the invention, humidity dependency of optical performance was poor or a surface shape was undesired, and as a result, performance of the polarizing plate, or a quality of display performance, particularly humidity dependency was reduced, when the liquid crystal display was used as the polarizing plate.

### EXAMPLE 3

(Mounting Evaluation for IPS Type Liquid Crystal Display)

Mounting evaluation for a liquid crystal display was conducted using the cellulose acylate film sample produced in Example 1 to confirm whether optical performance thereof was desired. Furthermore, an IPS-type liquid crystal cell was used in the present Example, and VA and OCB type liquid crystal cells were used in other examples. The purpose of the polarizing plate or the optical compensation film using the cellulose acylate film of the invention is not limited to an operation mode of the liquid crystal display.

An optical compensation film in which an ARTON film (manufactured by JSR Corp.) was unidirectionally drawn was bonded to a polarizing plate sample 001, which was produced in the same manner as in Example 2, except that the film of the invention was used before the optically anisotropic layer was layered using the cellulose acylate film sample 001 produced in Example 1, to provide an optical compensation function thereto. In connection with this, a slow axis of a front side retardation of the optical compensation film was set to be perpendicular to a transmission axis of the polarizing plate sample 001, thus it was possible to improve a vision characteristic while a front characteristic was not changed at all. The optical compensation film in which front side retardation Re(630) was 270 nm, retardation Rth(630) of a film thickness direction was 0 nm, and an Nz factor was 0.5, was used.

Two sets of layered products of the polarizing plate 001 and the produced optical compensation film were produced, and “a layered product of the polarizing plate 001 and the optical compensation film, an IPS-type liquid crystal cell, and a layered product of the polarizing plate 001 and the optical compensation film” were sequentially layered so that the optical compensation film faced the liquid crystal cell to produce a display device including them. In connection with this, transmission axes of upper and lower polarizing plates were set to be perpendicular to each other to parallelize the transmission axis of the upper polarizing plate 001 and a molecular longitudinal axis direction of the liquid crystal cell (that is, the slow axis of the optical compensation layer was perpendicular to the molecular longitudinal axis direction of the liquid crystal cell). Typically used liquid crystal cells, or electrodes-substrates may be used as IPS. Alignment of the liquid crystal cell was a horizontal alignment, and the liquid crystal, which have positive (+) dielectric anisotropy and has been developed for an IPS liquid crystal and sold at a market, may be used. Physical properties of the liquid crystal cell were set so that Δn of the liquid crystal was 0.099, the cell gap of the liquid crystal layer was 3.0 μm, a pretilt angle was 5°, and rubbing directions of the upper and lower substrates were all 75°.

Similarly, for the cellulose acylate film samples 002 to 006, 101 to 112, 201, 121 to 123 and 131 to 133 produced in Example 1, after a polarizing plate was produced through the same manner as the polarizing plate 001, two sets of layered products having the optical compensation film bonded thereto were prepared to produce an IPS liquid crystal cell and a display device having it.

Viewing angle dependency of brightness of the produced liquid crystal display was measured through the same method as in Example 2. As a result, the film samples of the invention all had low light leakage, a small contrast change, a small color change of the display, and low humidity dependencies of the various performances. This is caused by the fact that Re and Rth of the cellulose acylate film sample of the present invention are low, wavelength dispersibility is excellent (wavelength dependency is low), and humidity dependencies of the optical performances are low. From these, it was confirmed that the cellulose acylate films produced by the preparation method of the invention all had fair display performance as in Example 2.

In addition, with respect to a durability test, treatment was conducted at 65° C. and 95% for 150 hours, and then display nonuniformity was observed. The nonuiformity mostly occurred at four corners of a panel. The panel including each of the produced film samples was evaluated through the same manner as in Example 2, and it was confirmed that, in the sample of the invention, nonuniformity of the panel over time after a durability test is low like in Example 2.

### EXAMPLE 4

(Mounting Evaluation for VA and OCB Type Liquid Crystal Displays)

A liquid crystal display disclosed in Example 1 of JP-A No. 10-48420, an optically anisotropic layer including a discotic liquid crystal molecule and an alignment film having polyvinyl alcohol applied thereon disclosed in Example 1 of JP-A No. 9-26572, a VA type liquid crystal display disclosed in FIGS. 2 to 9 of JP-A No. 2000-154261, and an OCB type liquid crystal display disclosed in FIGS. 10 to 15 of JP-A No. 2000-154261 were evaluated using the cellulose acylate film sample of the invention obtained in Example 1. In all Examples of the invention, a contrast viewing angle and a color viewing angle were fair, humidity dependencies of the display performances were fair, and fair performance was obtained for nonuniformity after the durability test.

### EXAMPLE 5

(Performance of Optical Compensation Film)

An optical compensation film sample was produced using the cellulose acylate film sample of the invention obtained in Example 1 by the method disclosed in Example 1 of JP-A No. 7-333433. The resulting filter film had excellent left, right, upper, and lower viewing angles. Accordingly, it was confirmed that the cellulose acylate film of the invention was excellent in view of the optical purpose.

In the present Examples, a compound in which an R value denoting interaction to cellulose acylate was within a predetermined range was used as additives, and the cellulose acylate film which was designed so that a production condition of the cellulose acylate film was within a specific condition range was used to reduce the humidity dependency of the optical performance of the film, and as a result, it was possible to improve the humidity dependency of the display performance when it was used as a protective film of a polarizing plate of a liquid crystal display or a support of an optical compensation film. Meanwhile, if the R value of the compound or a production condition of the film deviated from a predetermined range, the humidity dependency of the optical performance of the film or the surface shape of the film was not within a desired range, thus objects of the invention were insufficiently achieved. Furthermore, it was confirmed that, in a compound which was used to reduce the water content of the film and was considered to have high hydrophobicity, R was not within a predetermined range and compatibility to cellulose acylate was undesired, and thus cloudiness occurred on the produced film.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-115984 filed Apr. 13, 2005, the contents of which are incorporated herein by reference.

What is claimed is:

1. A cellulose acylate film having an equilibrium water content and a humidity dependency of a retardation Rth in a thickness direction of the cellulose acylate film, wherein a relationship between the equilibrium water content and the humidity dependency satisfies conditional expression (1):
0≦A≦12
wherein A represents a value indicated by {−(Rth(80%)−Rth(10%))/(equilibrium water content (80%)−equilibrium water content (10%))}; Rth(X %) is a Rth value under an ambience of 25° C. and X % RH, the Rth value being normalized to a Rth value of a cellulose acylate film having a thickness of 80 μm; and the equilibrium water content (X %) is a equilibrium water content under an ambience of 25° C. and X % RH.

2. The cellulose acylate film according to claim 1, which comprises cellulose acylate having an acyl group, wherein the acyl group is an acetyl group.

3. The cellulose acylate film according to claim 1, which comprises cellulose acylate having an acyl group comprising an aromatic acyl group.

4. The cellulose acylate film according to claim 1, which has retardations satisfying conditional expressions (2) and (3):
0 nm≦Re(λ)≦10 nm Conditional Expression (2)
−25 nm≦Rth(λ)≦25 μm Conditional Expression (3)
wherein Re(λ) represents an in-plane retardation Re at wavelength λ nm; Rth(λ) represents a retardation Rth in a thickness direction of the cellulose acylate film at wavelength λ nm; and λ is a wavelength of 400 nm to 700 nm.

5. A method of producing a cellulose acylate film, comprising:
casting a cellulose acylate solution on a support at a temperature of −10° C. to 39° C., the cellulose acylate solution comprising: a compound satisfying conditional expression (4); and cellulose acylate;
drying the cellulose acylate solution on the support by blowing dry air at a temperature of 55° C. to 180° C. to provide a flow cast film;
peeling off the flow cast film from the support; and
drying the flow cast film to produce a cellulose acylate film:
0≦R≦0.9 Conditional Expression (4)
wherein R represents an index for a degree of influence of the cellulose acylate on a self-diffusion coefficient of the compound satisfying conditional expression (4) in the cellulose acylate solution, and R is expressed as RD (subject compound)/RD (comparison compound), wherein RD is Db/Da; Da represents a ratio of a self-diffusion coefficient of one of the subject compound and the comparison compound as a single solute when only the single solute is dissolved in a solution; Db represents a self-diffusion coefficient of the single solute when cellulose acylate is co-present in the solution; the subject compound is the compound satisfying conditional expression (4); and the comparison compound is adamantine.

6. The method of producing a cellulose acylate film according to claim 5, wherein the compound satisfying formula (4) is represented by one of formulae (1) to (6a): 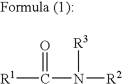
wherein R¹ is an aryl group; R² and R³ each independently are an alkyl group or an aryl group, each of which may be substituted; and at least one of R² and R³ is an aryl group, 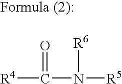
wherein R⁴, R⁵ and R⁶ each independently are an alkyl group, which may be substituted, 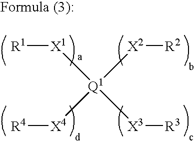
wherein R¹, R², R³ and R⁴ each independently are a hydrogen atom, a substituted or unsubstituted aliphatic group, or a substituted or unsubstituted aromatic group; X¹, X², X³ and X⁴ each independently are a divalent linking group comprising at least one group selected from the group consisting of a single bond, —CO— and —NR⁵—, wherein R⁵ is a substituted or unsubstituted aliphatic group, or a substituted or unsubstituted aromatic group; a, b, c and d each independently are an integer of 0 or greater; a+b+c+d is 2 or greater; and Q¹ is an organic group having a valency of (a+b+c+d), 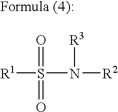
wherein R¹ is an alkyl group or an aryl group; R² and R³ each independently are a hydrogen atom, an alkyl group or an aryl group; and the total sum of carbon numbers of R¹, R² and R³ is 10 or greater, 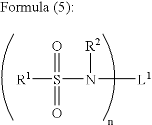
wherein R¹ is a substituted or unsubstituted aliphatic group, or a substituted or unsubstituted aromatic group; R¹ is a hydrogen atom, a substituted or unsubstituted aliphatic group, or a substituted or unsubstituted aromatic group; L¹ is a divalent to hexavalent linking group; and n is an integer of 2 to 6 in accordance with the valency of L¹, and 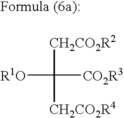
wherein R¹ is a hydrogen atom, an aliphatic acyl group or an aromatic acyl group; and R², R³ and R⁴ each independently are a hydrogen atom, an aliphatic group or an aromatic group.

7. The method of producing a cellulose acylate film according to claim 5, further comprising heating the cellulose acylate solution at a heating temperature satisfying conditional expression (5) during preparing of the cellulose acylate solution or during the time after the preparing and before the casting:
BP(° C.)+5 (° C.)≦heating temperature (° C.)≦BP(° C.)+70 (° C.) Conditional Expression (5)
wherein BP (° C.) is a boiling point of a solvent having the lowest boiling point among solvents in the cellulose acylate solution.

8. A cellulose acylate film having an equilibrium water content and a humidity dependency of a retardation Rth in a thickness direction of the cellulose acylate film, wherein a relationship between the equilibrium water content and the humidity dependency satisfies conditional expression (1):
0≦A≦12
wherein A represents a value indicated by {−(Rth(80%)−Rth(10%))/(equilibrium water content (80%)−equilibrium water content (10%))}; Rth(X %) is a Rth value under an ambience of 25° C. and X % RH, the Rth value being normalized to a Rth value of a cellulose acylate film having a thickness of 80 μm; and the equilibrium water content (X %) is a equilibrium water content under an ambience of 25° C. and X % RH, and
wherein the cellulose acylate film is produced by a method according to claim 5.

9. An optical compensation film comprising:
a cellulose acylate film according to claim 1; and
an optically anisotropic layer having retardations satisfying conditional expressions (6) and (7):
0≦Re₍₆₃₀₎≦200 nm Conditional Expression (6)
0≦|Rth₍₆₃₀₎|≦400 nm Conditional Expression (7)
wherein Re_{(λ)} represents an in-plane retardation at a wavelength of λ nm; and Rth_{(λ)} represent a retardation in a thickness direction of the optically anisotropic layer at a wavelength of λ nm.

10. The optical compensation film according to claim 9, wherein the optically anisotropic layer comprises a polymer film.

11. The optical compensation film according to claim 10, which is produced by:
dissolving a polymer in a solvent to obtain a liquid phase;
spreading and drying the liquid phase on a cellulose acylate film to provide a dried film, wherein the cellulose acylate film has an equilibrium water content and a humidity dependency of a retardation Rth in a thickness direction of the cellulose acylate film, and a relationship between the equilibrium water content and the humidity dependency satisfies conditional expression (1):
0≦A≦12
wherein A represents a value indicated by {−(Rth(80%)−Rth(10%))/(equilibrium water content (80%)−equilibrium water content (10%))}; Rth(X %) is a Rth value under an ambience of 25° C. and X % RH, the Rth value being normalized to a Rth value of a cellulose acylate film having a thickness of 80 μm; and the equilibrium water content (X %) is a equilibrium water content under an ambience of 25° C. and X % RH.; and
subjecting the dried film to at least one of stretch treatment and shrinking treatment so as to align molecules of the polymer in plane.

12. The optical compensation film according to claim 10, wherein the polymer film comprises at least one polymer selected from the group consisting of polyamide, polyimide, polyester, polyether ketone, polyarylether ketone, polyamideimide and polyester imide.

13. A polarizing plate comprising: a polarizer; and a protective film, wherein the protective film comprises a cellulose acylate film according to claim 1.

14. A liquid crystal display comprising a cellulose acylate film according to claim 1.

15. The liquid crystal display according to claim 13, which is of VA mode or IPS mode.
